(19) United States
(12) Patent Application Publication
(10) Pub. No.: US 2024/0419906 A1
(43) Pub. Date: Dec. 19, 2024

(54) GENERATING HIGHER RESOLUTION MAP DATA USING LANGUAGE MODELS

(71) Applicant: Nvidia Corporation, Santa Clara, CA (US)

(72) Inventors: Denis Laprise, Palo Alto, CA (US); Shuang Wu, Fremont, CA (US); Mark Wheeler, Saratoga, CA (US)

(21) Appl. No.: 18/500,426

(22) Filed: Nov. 2, 2023

Related U.S. Application Data
(60) Provisional application No. 63/521,627, filed on Jun. 16, 2023.

(51) Int. Cl. G06F 40/284; G01C 21/32; G06F 40/40

(52) U.S. Cl. CPC G06F 40/284; G01C 21/32; G06F 40/40

(57) ABSTRACT

Approaches presented herein provide for the generation of a realistic, higher resolution representation of an environment using a trained language model. In at least one embodiment, map data representative of at least a portion of the environment can be obtained. This map data can be processed using a language model to generate a first tokenized description of the environment based on the input map data. This first tokenized description, which may be in a domain-specific language, can be passed as input to a language model, such as the same language model, which can generate a second tokenized description of the environment that is also in the domain-specific language, but includes additional detail and thus provides a higher resolution representation. This additional detail may include filling in of gaps or accounting for omissions, but may also include inferring aspects such as continuous lanes or complex intersection topography not identified in the input map data. The additional detail may also include additional objects inferred to be appropriate for the environment.

### CROSS-REFERENCE TO RELATED APPLICATIONS

This application claims priority to and the benefit of U.S. Provisional Patent Application No. 63/521,627, filed Jun. 16, 2023, entitled “USING LANGUAGE MODELS FOR MAPPING IN AUTONOMOUS SYSTEMS AND APPLICATIONS,” the full disclosure of which is hereby incorporated in its entirety for all purposes.

### BACKGROUND

There are various operations—such as may relate to autonomous or semi-autonomous sensing, navigation, or control, as well as robotic simulation—where it can be desirable to generate or reconstruct a realistic digital and/or virtual representation of an environment that complies with real-world rules, patterns, and constraints. As an example, maps—such as high definition (HD) maps—are widely relied upon for semi-autonomous and autonomous navigation operations. Autonomous and semi-autonomous vehicles and machines may rely on these maps for navigation, localization, path or route planning, and/or other operations. Building, updating, and maintaining these maps (or other such representations) is a time-intensive and compute-heavy task that relies heavily on domain expertise and manually designed logic or rules. As a result, existing map systems suffer from brittleness, difficulty of improvement, and require extensive manual effort to moderate results and account for errors. The improvements to these existing systems are often costly and offer only minimal gains in performance when compared against the effort and time spent implementing them. In addition, prior solutions generally include task-specific designs that do not always hold up in real-world situations, and do not take advantage of available data and human input. Further still, conventional HD map building consists of a pipeline of multiple distinctive stages, including data collection, data processing, element extraction, additional manual labeling, and final human review and release, and it often requires multiple iterations through stages of this pipeline to obtain satisfactory results.

### BRIEF DESCRIPTION OF THE DRAWINGS

Various embodiments in accordance with the present disclosure will be described with reference to the drawings, in which:

FIG. 1 illustrates example data produced at stages of an environment reconstruction process, according to at least one embodiment;

FIG. 2A illustrates an example map generation pipeline, according to at least one embodiment;

FIG. 2B illustrates another example map generation pipeline, according to at least one embodiment;

FIG. 2C illustrates an example tokenized representation of a first portion of an environment, according to at least one embodiment;

FIG. 2D illustrates an example map view of the first portion of the environment, according to at least one embodiment;

FIG. 2E illustrates an example map view of a second portion of the environment, according to at least one embodiment;

FIG. 2F illustrates an example tokenized representation of the second portion of an environment, according to at least one embodiment;

FIGS. 3A and 3B illustrate example maps with different levels of detail or “resolution,” according to at least one embodiment;

FIG. 4A illustrates an example process to generate a higher resolution representation of an environment, according to at least one embodiment;

FIG. 4B illustrates an example process to use a lower resolution representation of an environment to generate a higher resolution representation of that environment, according to at least one embodiment;

FIG. 5A illustrates an example map graph, according to at least one embodiment;

FIG. 5B illustrates an example landmark analysis system, according to at least one embodiment;

FIG. 5C illustrates an example tokenized text string, according to at least one embodiment;

FIG. 5D illustrates an example lane graph, according to at least one embodiment;

FIG. 5E illustrates an example architecture for determining an output state, according to at least one embodiment;

FIG. 5F illustrates an example image of an intersection in an example map, according to at least one embodiment;

FIG. 6 illustrates components of a distributed system that can be used to generate a text-based representation of an environment, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment;

FIGS. 15A and 15B illustrate a data flow diagram for a process to train a machine learning model, as well as client-server architecture to enhance annotation tools with pre-trained annotation models, in accordance with at least one embodiment;

FIG. 16A illustrates an example of an autonomous vehicle, according to at least one embodiment;

FIG. 16B illustrates an example of camera locations and fields of view for the autonomous vehicle of FIG. 16A, according to at least one embodiment;

FIG. 16C is a block diagram illustrating an example system architecture for the autonomous vehicle of FIG. 16A, according to at least one embodiment;

FIG. 16D is a diagram illustrating a system for communication between cloud-based server(s) and the autonomous vehicle of FIG. 16A, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, map building, updating and generation, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), generative AI applications, collaborative content creation for 3D assets, cloud computing, and/or any other suitable applications.

Disclosed embodiments may be comprised in a variety of different systems such as automotive systems (e.g., an in-vehicle infotainment system for an autonomous or semi-autonomous machine, a mapping system associated with an autonomous or semi-autonomous system, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), systems for performing generative AI operations (e.g., using one or more language models), systems for performing light transport simulation, systems for performing collaborative content creation for 3D assets, systems implemented at least partially using cloud computing resources, and/or other types of systems.

In at least one embodiment, at least one language model (or other generative or transformer model that is based at least partially on text or language) can be used to generate a tokenized description of an environment. The tokenized description can include at least a target level or amount of detail, and can comply with (or otherwise correspond to) real-world rules and relationships. In at least one embodiment, map data in any of a number of possible forms can be obtained for at least a portion of an environment. The map data may contain information having less than the target level of detail, and in some instances significantly less, but in at least one embodiment should include sufficient information to determine the general location and configuration of one or more roadways (or other navigable pathways or features) through the environment. Additional input data may be provided as well, as may relate to geo-location or contextual data, among other such options. In some embodiments, the inputs may include images or other representations of the environment, such as aerial photos of roadways, screenshots, or snippets of lower definition (e.g., standard definition (SD) or navigational) maps, and/or the like. At least the map data (and/or other data) can be processed, such to extract a set of representative features, which can be used by a first language model to generate a first tokenized description of the portion of the environment. The first tokenized description can include a level of detail that is similar to that of the input map data, although the first language model will have at least some ability to fill gaps or omissions in the map data, as well as to infer (or identify) additional information such as semantic, topology, or geometry data for the environment.

This initial tokenized description, generated by a first language model using the input map data, can be provided as input to a second language model, which may be the same (or a different) type of model trained using a different set of training data. The second language model can perform a type of translation operation on the first tokenized representation, generating a second tokenized description that includes an additional level of detail or amount of information, for example, which can be referred to as being of a higher “resolution”—similar to a standard definition (SD) map that corresponds to a high resolution (HD) map with a higher level of detail. The second language model can be trained to infer this additional information from the first tokenized description and any other input data, where the additional information may relate to object or features such as continuous lane markers and complex intersection topology, among other such options. The second language model can also identify gaps or omissions in the data of the first tokenized description, as may be based in part on the determined lanes and complex intersection information. The second language model can also provide a higher level of precision in values, locations, or other metrics, as may involve adjustments to the locations of lane boundaries, traffic signals, and the like. The second language model can also add data for additional objects or features that are relevant for the type of location, as may include street signs, warning lights, and so on. The generation of these “higher resolution” descriptions with higher levels of detail need not be deterministic, and may result in somewhat different versions each time, but these higher resolution descriptions should be consistent with the lower level description in at least some embodiments. The higher resolution descriptions can then be used for various purposes where realistic, detailed representations of an environment are used, such as for vehicle navigation or three-dimensional (3D) environment simulation, among other such operations. In embodiments, the first and second language model may both correspond to a single language model, or separate instances of the same language model. In embodiments, the first and second language model may also make up two or more different sets of layers of the language model—e.g., a first set to process the input to generate the tokenized representation in a domain specific language (such as RTL) and a second set of layers to process the output of the first set of layers to fill in detail, extrapolate information, etc., to generate a higher definition or more detailed representation of the initial input(s).

In at least one embodiment, a language model can generate an output tokenized description of an environment that can be in a structured language, such as a road topology language (RTL) or other domain specific language (DSL), where the tokens for individual objects in the environment can include semantic, topology, and geometry data, among other such information. The generated tokenized description of the environment can function as an object graph that can be used to generate a high-quality map, such as an HD map, a standard definition (SD) map, and/or a navigational map of the environment. In at least one embodiment, a generic representation of map information—such as a document in a structured language such as a Road Topology Language (RTL)—can be shared among stages of such a map building pipeline, if more than one stage is used, allowing for a flexible exchange of information that can help to avoid bottlenecks between stages. An LLM, or other language model, can formulate various tasks along such a pipeline as document or language manipulation tasks to be performed using these tokenized descriptions or other text-based representations.

Approaches in accordance with various illustrative embodiments can provide for the generation of a text- or language-based representation of an environment that may have static and/or dynamic objects or aspects. In particular, various embodiments can use a language model, or other generative artificial intelligence (AI)-based approach, to generate a tokenized text string representation of an environment, as may include stationary or mobile objects within that environment. A language model can be trained to represent an environment based on not only low-level primitives, for example, but also the kinematics, semantics, topology, and geometry related to those primitives, as well as the relationships among objects determinable using those primitives. Such learning allows a language model to generate environments that comply with real-world rules and constructs, and that can recognize and account for omissions or errors in the input data to be used to generate a representation of an environment. These learnings can also be used to correct or augment existing representations, such as previously-generated maps. Objects in an environment can be represented using sequences of tokens, providing semantics and other information related to these objects. A text-based representation can be a one-dimensional sequence of these tokens, which can encapsulate the important spatial and other types of information of an environment. An advantage of such a text-based description is that it can be discrete and compact, allowing for quick processing, search, updating, and/or other such operations. A generated text-based representation of an environment can be used to generate several other types of representations useful for various operations or tasks, such as may include birds-eye view maps, high definition (HD) maps, or 3D virtual environments, among other such options.

In at least one embodiment, generative AI can be used to provide a semantic understanding of an environment based at least in part on sensor data captured for an environment. This sensor data can be processed and fed to a trained generative AI model (such as a large language model or “LLM”), for example, which can output a textual description of an environment in a structured textual format (or a domain specific language (DSL)), such as in RTL. A text string in RTL can provide a tokenized language representation of a static or dynamic environment. The generative AI can be trained in such a way as to be able to fill in gaps or correct errors in the data based on a semantic understanding of the objects or elements in the environment. The language model can receive input including kinematic, semantic, topological, and/or geometric information determined for an environment, and can update the representation of a scene as the environment changes due to movement or other such occurrences. The language model may also take other inputs as well, such as prior maps or context information (indicating things like weather, time of day, season, road conditions, urban/rural region, geographic location, etc.). The input data can be represented by embeddings, feature vectors, or points in a latent space, which allows for relatively simple searching for similar environments. In this way, quick determinations of actions to be taken in an environment can be made by determining which actions were taken in similar environments, particularly when there may be insufficient data available for a current environment or situation to make a high confidence decision as to an action to be taken. The ability to determine what others have done in similar environments can help a system to function in a way similar to how a human uses “intuition” in a given situation even when there may be data missing, such as where snow may have obscured the lines along a road but the human can infer where to drive based on other information available in the environment. Such an approach can be used for a wide variety of geospatial information processing and autonomous driving tasks (such as map building, map editing, map-based navigation, planning and driving) by representing those tasks as document manipulation tasks.

A generative AI, once trained, can also be used to generate realistic simulation environments that comply with real-world rules, such as may be useful for testing autonomous or semi-autonomous vehicles, machines, or robots. Such an approach can also be used to correct or update noisy or partial environment graphs or maps. The generative AI model might take the sensor data directly as input or might receive input that is generated from the sensor data in one or more stages of a pipeline, such as stages to extract features and generate embeddings of those features in a latent space that can be provided as input to the generative model.

Approaches in accordance with various illustrative embodiments can provide for the use of language models for various functionalities in autonomous or semi-autonomous systems and applications. Systems and methods are disclosed that use one or more language models (e.g., LLMs) to perform various mapping operations—such as map building, map editing, map-based navigation, routing, planning, and perception, error checking, data cleaning, and data validation, among others. For example, a deep learning model—such as an LLM—may encapsulate domain knowledge about how road networks and/or objects are structured. By training an LLM to predict structure and attributes of a graph described in a domain specific language (DSL)—such as RTL—the LLM learns to establish correct relationships among objects on the road. The RTL may express road, object, and/or other map-related information (e.g., by modeling relationships among lane elements and other map features) using language, such that the LLM learns to interpret the RTL—in addition to natural or conversational language—to generate outputs. An automated process may be implemented to convert existing map information to the RTL, and to convert outputs of the LLM from RTL to a suitable map format (e.g., a format for an HD map deployed in a production vehicle). Such an LLM may be used to solve various challenging problems related to mapping—such as identifying or correcting mistakes or gaps in maps, creating maps from a photo or video stream of road data, creating maps from aerial or satellite images, and/or creating maps from text descriptions. Once created, the maps can be used for various tasks, such as for autonomous vehicles (AV) or autonomous systems, semi-autonomous vehicles or systems (e.g., for advanced driver assistance systems (ADAS)), simulation systems (e.g., for developing or testing/validating AV/ADAS algorithms or for creating training data for AV/ADAS perception), robotics systems, aerial systems, boating or watercraft systems, and/or the like.

In contrast to conventional systems, the systems and methods of the present disclosure can adopt a language model-based approach that allows for model training on large-scale maps—making data driven performance improvements easier and more scalable with respect to domain expertise. For example, a language model may be trained to identify a next token in a graph using an underlying knowledge of how road objects and networks are connected in addition to road graph data that has already been presented to the language model. This language model-based approach also naturally extends to support training with human input or feedback, and automatic or interactive application of trained models in geospatial information processing with or without human collaboration. For example, models can be trained or fine-tuned with question-answer pairs to gain the capability of responding to human query or guidance regarding some map, environment represented with RTL. Various tasks may be unified in geospatial information processing using a shared formulation such that the same algorithmic models can be reused without extra engineering effort. Processing efficiency can also be improved by replacing manual labor with machine learning model-based automation.

Variations of this and other such functionality can be used as well within the scope of the various embodiments as would be apparent to one of ordinary skill in the art considering the teachings and suggestions contained herein.

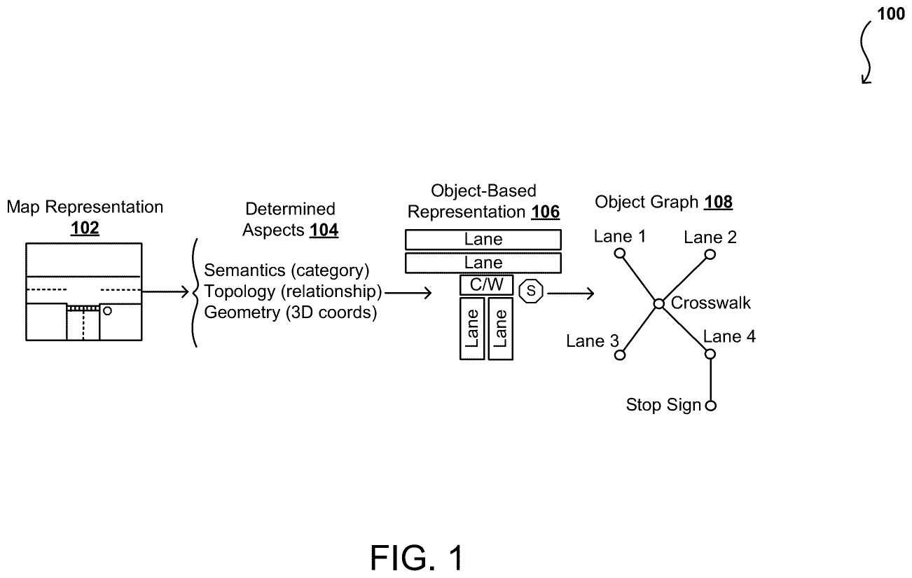

In at least one embodiment, a system for generating, manipulating, enhancing, or otherwise managing map data, or other such environmental representations, can take advantage of tokenized descriptions or other text string-based representations including those discussed herein. FIG. 1 illustrates an example data processing flow 100 that can be implemented in an environment representation and/or reconstruction system in accordance with at least one embodiment. In this example, a map representation 102 can be obtained that corresponds to at least a portion of an environment, which may be an actual environment or a virtual environment in various embodiments. The map representation 102 may include any of a number of different types of representations in a variety of different possible formats, as may include top-down two-dimensional map images, standard definition (SD) map data, point-cloud data, and the like. The map data can have been generated automatically or manually, such as may be based at least in part upon sensor data (or other raw data captured or representative of an environment) is obtained with respect to a specific environment 102. The environment can be any appropriate physical environment, such as an indoor or outdoor environment that may include any number of different types of objects or elements. The sensor data can include data captured or obtained using any of a number of different types of sensors, as may include cameras, LIDAR systems, RADAR systems, sonic sensors, distance sensors, and/or the like. Additional data may be obtained that relates to the environment as well in various embodiments, as may relate to basic map data, contextual data, motion data, or other such data, which may also be obtained for virtual, augmented, or enhanced environments. In this example, the sensor data (and any other available and useful data) can be used to generate an initial map representation of the environment.

The map representation 102 can be analyzed to determine aspects 104 of the environment, at least to the extent not already provided with the map representation or used to generate the map representation. For example, the map representation 102 can be analyzed to determine the categories (or types) of objects represented in the environment, as may relate to roadways, traffic signs, sidewalks, buildings, and the like. The map representation 102 can also be analyzed to determine the locations of these objects in the environment, as may be defined using a set of 3D coordinates relative to a chosen origin location. The map representation 102 can be analyzed to determine various relationships among these objects, such as where a crosswalk crosses specific lanes or where a stop sign is associated with a specific lane and indicates an expected behavior. Once these determined aspects 102 are obtained, these aspects can be used to generate an object-based representation 106 of the environment. Various other types of representations can be generated as well within the scope of various embodiments. As illustrated, the object-based representation 106 will not be a comprehensive description of the environment in this example but will instead focus on the types of objects or features of the environment that are potentially relevant to a particular task. For autonomous driving, for example, the object-based representation 106 may include objects such as road lanes, crosswalks, intersections, and the like, but may not include objects that may not be directly relevant to driving, as may include buildings, billboards, mailboxes, and other such objects, except to the extent those objects may be relevant to a specific operation or task. In this example, the object-based representation 106 also does not include vehicles, pedestrians, or other movable or dynamic objects that will only be in specific locations in the environment at specific times, but any or all of these and other such objects could be included in the representation as well within the scope of various embodiments.

From this object-based representation 106, an object graph 108 can be generated that provides a different representation of the environment. An advantage of object graph 108 is that it is relatively lightweight and can be used to compactly describe aspects of the environment that are important for a particular task or operation. For example, such an object graph 108 could be provided to a map generator to generate an HD map (or other such map or representation) that can be provided to an autonomous vehicle to make navigation decisions. Such an object graph 108 can also be provided as input to an environment generator or simulator that can generate a realistic 3D virtual environment that can be used for tasks such as robotic simulation or digital world recreation. Many object graphs can be stored to represent different environments, which can require significantly less memory or storage capacity than sensor data or a large number of high-resolution images. Such object graphs can also be analyzed quickly to allow for real-time (or near real-time operations), such as autonomous or semi-autonomous navigation or control.

A challenge with existing approaches to generating such representations is that there is a limited ability to perform automated geospatial information processing, particularly using an algorithm framework that is sufficiently generic to support a wide variety of use cases. Existing solutions typically have task-specific designs that cannot easily adapt to new task requirements, contain built-in assumptions that might not always hold in real-world situations, and do not make effective use of available data and human input. Existing approaches are also limited in their ability to learn from large amounts of diverse data that can be relevant to these different tasks or use cases. Many existing solutions depend heavily on domain expertise and manually designed logic or rules in various steps of the processing pipeline. These attempted solutions are difficult to accurately complete and improve, requiring manual effort to moderate the results and make them correct. Improvements to these systems are costly and generally offer smaller and smaller performance gains for the effort spent.

Approaches in accordance with at least one embodiment can provide a versatile approach to processing map-based (or map-inclusive) information about such an environment, as may include geospatial and semantic information. In at least one embodiment, a deep learning model can be used that encapsulates domain-specific (and/or agnostic) knowledge about how objects in an environment are structured and related. An example deep learning model is a large language model (LLM) that can be trained to generate a textual and/or tokenized description of an environment that retains semantic understanding of an environment in addition to providing information about the categories and locations of objects in the environment. In at least one embodiment, an LLM (or other language-based generative model, for example) can generate a tokenized text string as a representation of an environment, where objects in the environment are represented using tokens in the string that provide semantic and/or relationship information with respect to the various tokens of the string. In addition to generating a compact yet thorough representation of an environment, for example, an advantage of using a model such as an LLM is that the LLM can fill in gaps in the initial map representation 102 or otherwise make corrections where needed to provide a more accurate representation of the environment. For example, training an LLM to predict the next token in the text string (corresponding to a next object in an object graph, for example) can help the LLM to learn to establish correct relationships between objects in the environment. This can include, for example, identifying or correcting mistakes or gaps in environment representations, creating environment representations (e.g., maps or object graphs) from a photo or video stream of environment data, creating environment representations from aerial or satellite images, creating environment representations from screenshots or crops of navigational maps, SD maps, building plans, engineering plans, inventors layouts, etc., and creating environment descriptions from textual descriptions, among other such tasks. For example, where map data may provide an incomplete or limited representation of the environment, the LLM may be used to fill in various information—e.g., lane lines, road boundaries, stop lines, wait conditions, safety zones in a warehouse, hallways in a building, and the like, that may not be properly and/or completely represented in the initial map representation 102.

In at least one embodiment, a language model-based approach can be used that can allow model training on large-scale existing environment representations, such as maps, making data-driven performance improvements easier and more scalable with respect to domain expertise. A training approach can be used that can specifically teach the LLM to identify the next token in the graph. In at least one embodiment, an LLM can generate a deep underlying representation of how objects in the environment are connected or related, as well as a model of the graph data already presented as input to the LLM. In at least one embodiment, various tasks in geospatial information processing can be unified under a shared formulation, such that the same algorithmic models can be re-used without extra engineering effort. Processing efficiency can be further improved through replacing manual labor with machine learning model-based automation. A large language model can be trained on vast amounts of environment data so that it can automate various tasks such as missing element detection, inaccurate element correction, and inference of relationships among elements, among other such tasks. Each of these can be achieved without heavily depending on human expertise to explicitly design for and can be improved continuously with additional training data. Such a model can leverage existing environment (e.g., map) data without requiring additional data curation and labeling cost. The model can be trained in a task-agnostic way so that the model can be extended to other use cases without significant additional effort. These representations can include, or be used to generate, high quality maps useful for tasks such as those related to an advanced driver assistance system (ADAS), autonomous vehicle (AV), unmanned aerial vehicle (UAV) or simulation system, such as may be useful for developing or testing/validating AV/ADAS/UAV algorithms or creating training data for AV/ADAS/UAV perception.

Approaches in accordance with at least one embodiment attempt to improve, optimize, enhance, or at least control the way in which an environment is perceived or represented. In various existing systems, perception of an environment is relatively primitive and based around rules for detected objects. For example, an existing system might analyze a map image to identify the location of roadway lanes and lane markers, but does not have any concept of what the lines on the roadways mean, or how those lines relate to nearby road signs or traffic lights. An existing system might recognize the objects and use the locations of those objects to generate and/or update a map to reflect those objects. The system might attempt to determine relationships and apply rules to these objects to ensure the placement makes sense and determine any relationships, but this is typically done during post-processing when most other data has already been discarded. Applying rules based on detected objects means that it can be difficult to detect gaps, errors, or omissions that might otherwise be detected if the relationships and semantic meanings of various objects in a scene were known and used in the process of generating the representation of the environment. Further, a rules-based approach is harder to scale in many instances, and requires a human understanding of rules as they change from location to location, town to town, city to city, state to state, country to country, warehouse to warehouse, etc.

An approach in accordance with at least one embodiment can obtain and apply such knowledge earlier in the process. As mentioned, a large language model can take input relating to the semantics, location, and relationship between various objects in an environment, and can use this information to determine, based in part on its learning, how to generate a realistic and/or more detailed or precise environment representation that can make up for the fact that the input data may be somewhat incomplete or lacking in certain detail, if not at least somewhat erroneous. By representing the environment through a textual- or language-based representation, a language model can apply its learnings to determine how to structure the representation to ensure realism and completeness, and to fill in gaps in the input data based on what it has learned from similar situations. A language model has the advantage of taking text as input, rather than (or in addition to) images or other large instances of sensor data, which can be processed relatively quickly during training. This allows a generative model to be trained using millions or even billions of such documents, with self-supervision, which provides for better understanding of behavior and relationships, as well as which behavior and/or relationships apply to a given environment or situation. By converting an image-, object-, or feature-based representation into a language-based representation, for example, this language-based representation can be used to train a language model to understand the various correlations between categories of objects and their relative locations, including ways that may be difficult to enumerate comprehensively. Attempting to capture all the relevant real-world correlations, relationships, and other semantic aspects would be extremely difficult to do using only explicit rules as would be required for various existing systems.

In at least one embodiment, a language model could take as input an object-based representation 108 and generate what is essentially a tokenized text string representation of the object graph. In other embodiments, the language model might be able to take other inputs that would allow for at least some steps in this generation pipeline to be eliminated as separate steps performed by separate processes or components. For example, an LLM could be trained to take in a set of determined aspects 104 (e.g., semantics, topology, or geometry information for an environment or objects in that environment) in text format and generate a tokenized text string representative of the object graph 108 without ever having to generate an object-based representation. Similarly, in some embodiments an LLM can take as input the initial representation 102, or even the sensor data used to generate the map data, without the need for separate intermediate representations. For example, a model (as part of the LLM or a separate model) can analyze sensor data and/or map data for the environment and encode features of the into a latent space (or other embedding). The LLM can then take a feature vector as input that is a function of these individual latent space encodings and can directly generate the tokenized text string representation of the environment. The features extracted can include kinematics, semantics, relationship, and geometry features, among other such options. Encoding such features in a latent space can prevent this information from being discarded early in the generation process and allow for more accurate representations or reconstructions to be generated.

In at least one embodiment, the tokenized text string can include a sequence of tokens, representing objects in the environment. The tokens can also be in a specific sequence, which not only can be useful in generating an object graph from the text string, but also allows semantic learning to be applied to the sequence of tokens as an LLM might typically do for the words of a sentence. Several languages can be used to represent such an environment, as long as the language is able to provide the representation as a sequential notation of discrete tokens. In at least one embodiment, a custom language might be used that includes specific tokens that can accurately and compactly represent a specific type of environment. For example, a road topology language (RTL) might be used that includes terminology and syntax useful for representing map data for environments including roadways. A unified, sequential, tokenized text representation can be used to model a graph, and a graph can be quickly generated from such a sequential tokenized text string in a way that is consistently repeatable. A language model can be trained to understand and “speak” in at least one specific language, such as RTL. As a trained LLM will know how to manipulate or fill in a sentence in natural language, so can an LLM learn to fill in a text string in a structured representation language. The LLM can also infer relationships between objects based on its understanding of the language. The LLM can then generate a unified text representation of an environment that can include information that was not present or determinable from the input alone but that allows the environment to be more realistic and to comply with real-world rules and/or constraints. These may include, for example, local traffic rules or ordinances, customs, and abilities of objects in the environment, among other such options. The language model can be trained to learn the semantics and syntax of the language, as well as the reasoning behind the semantics and syntax, including the physical concepts behind various object relationships. Instead of considering lane boundaries as lines in space, an LLM can consider the boundaries as associated with lanes of a roadway that come with various requirements, traffic rule or behaviors, and associated objects.

Although RTL, or other driving/navigation environment type language representations, are primarily described herein, this is not intended to be limiting. In some embodiments, one or more LLMs may be trained on languages for robotics environments (e.g., warehouses, factories, facilities, labs, buildings, etc.), languages for aerial vehicle environments, languages for circuit board, chip, semiconductor, and/or other hardware layout or design structures or environments (e.g., for evaluating a chip layout or structure, designing optimized chip layouts, etc.), and/or other use cases/environments.

A language model trained to generate a representation using such a language can be used in at least one embodiment to describe the physical layout of an environment, such as may be useful for generating high quality and/or HD maps. A model can generate text to describe other aspects of an environment as well, as may include characters, animals, dynamic actors, static objects, vehicles, and/or other objects and elements that might move or change position or pose over time, and that might only be in an environment for a limited period of time. For example, a text string might be generated that provides a representation including a map view that illustrates where a vehicle can navigate, and including representations of pedestrians, other vehicles, buildings, or other types of objects or entities that may be important for navigation or other such tasks. If a language model is able to generate a presentation that accurately describes aspects of the environment including nearby vehicles and pedestrians, for example, then navigation decisions may be able to be made using this representation without a separate need to identify such objects using perception (or in combination with perception) and provide that as additional input to a navigation or control system. An example perception map or representation can be generated that may include anything or everything in an environment that can be perceived using the available sensor data (or other such data) along with understanding of the physical rules or relationships for such an environment.

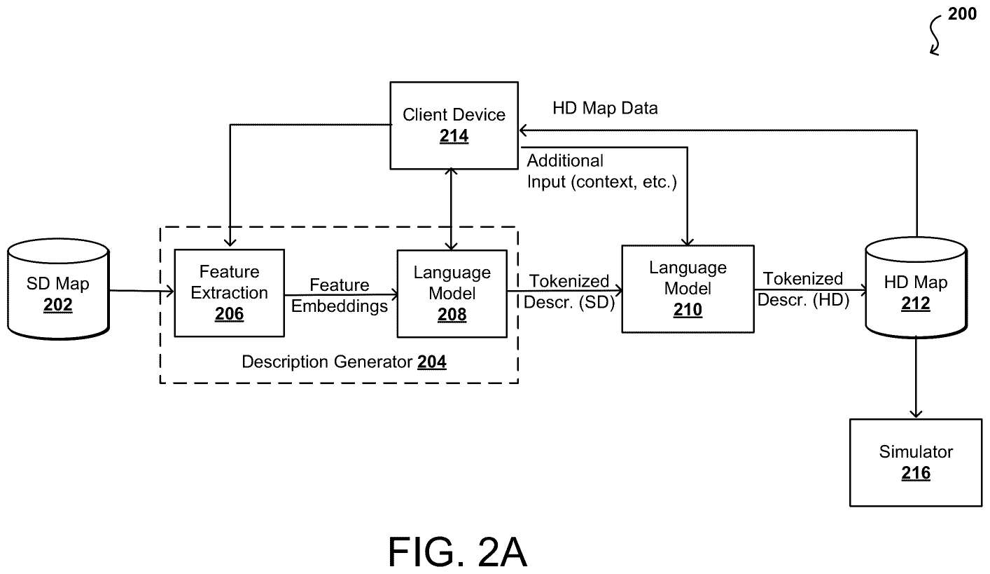

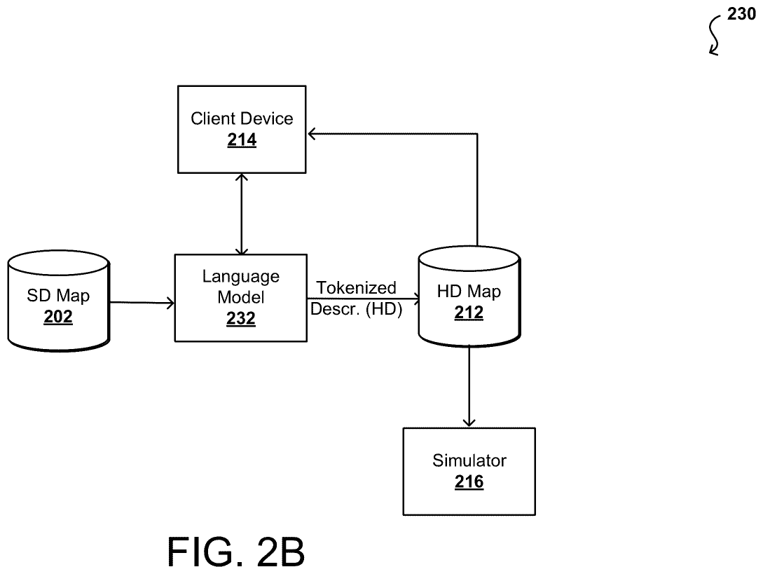

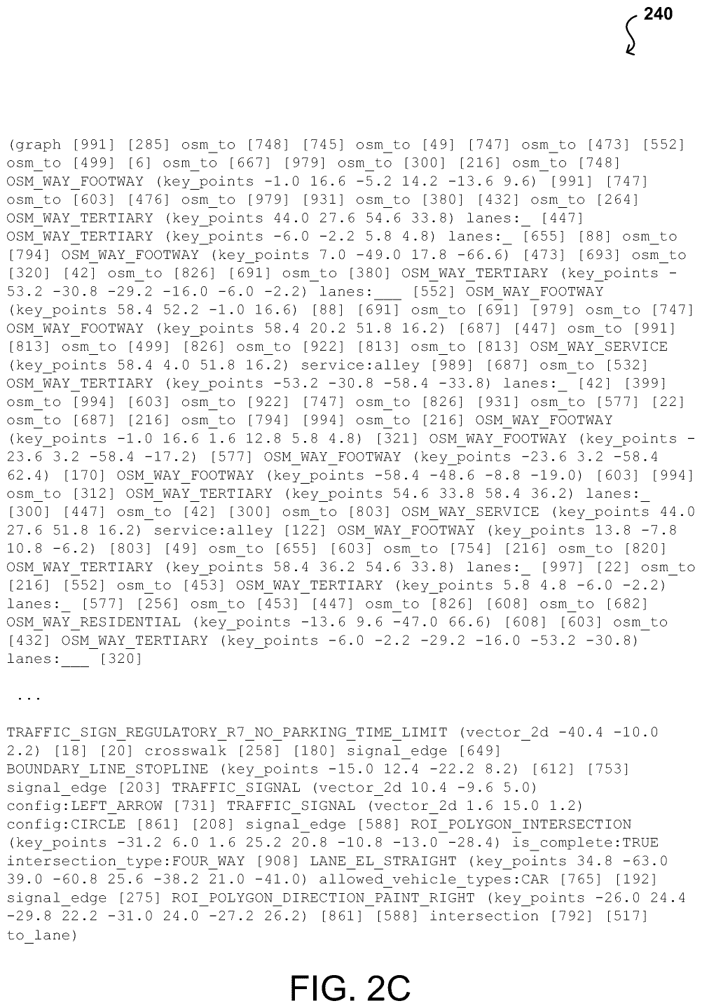

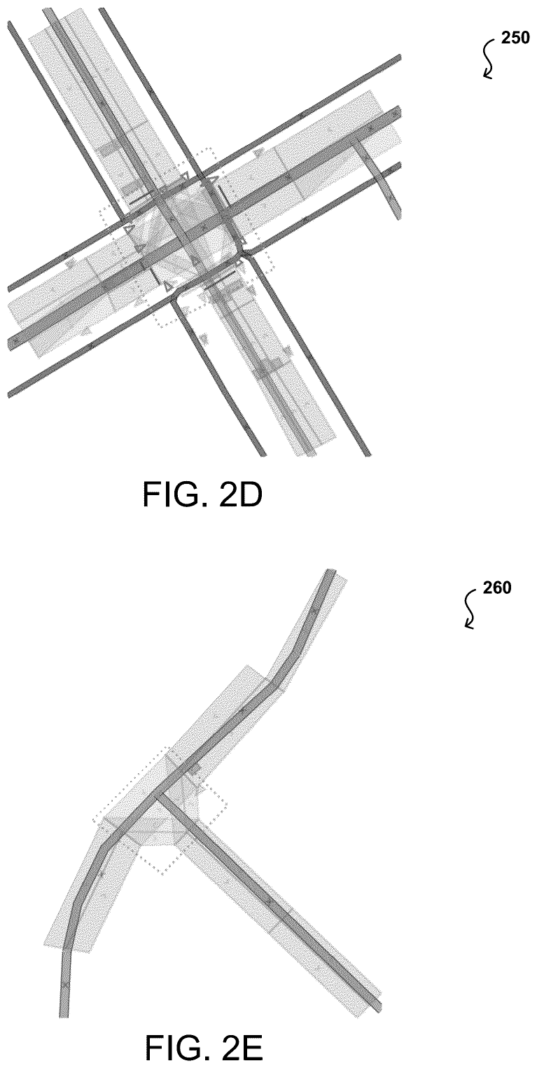

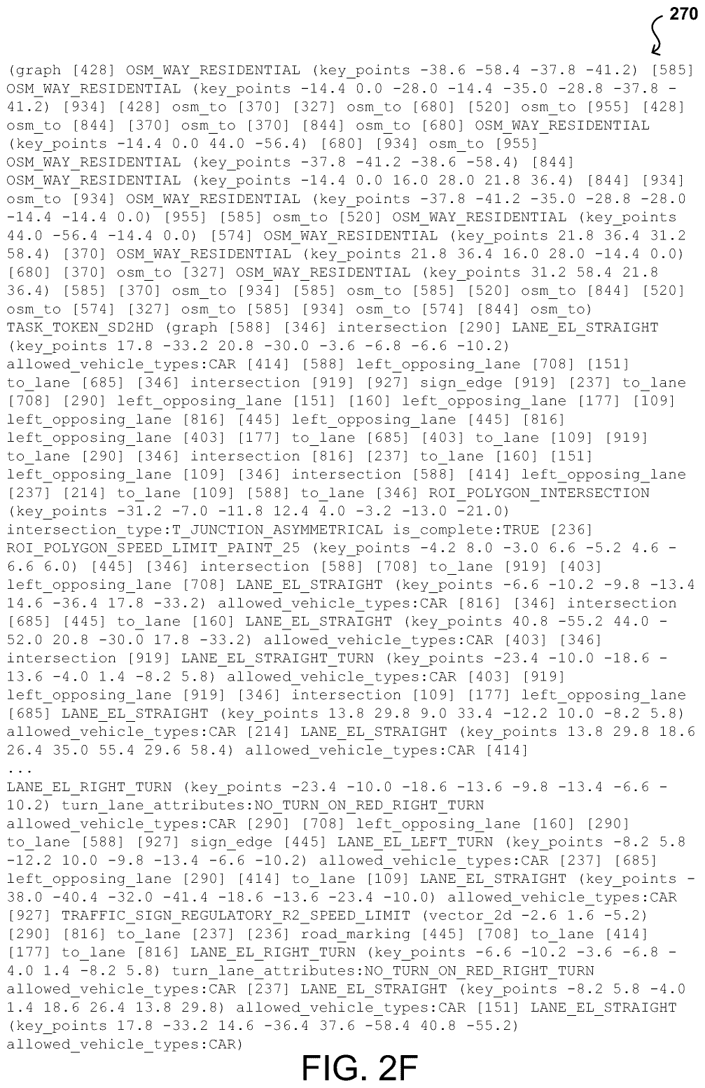

FIG. 2A illustrates an example pipeline 200 that can be used to generate a high quality, text-based representation of an environment in accordance with at least one embodiment. Rather than requiring at least some manual interaction, such an approach can automatically generate a representation from a variety of different types of input data. In some embodiments, there may be the option to receive at least some amount of manual input or guidance as well. In this example, there may be one or more existing maps of a location, as may be stored to a map data 202 or other such location. While SD maps are provided as an example, it should be understood that there may be various types of environmental representations used with various levels of detail, and that in at least one embodiment the map data or representation need only have enough detail or accuracy that a trained language model can generate a tokenized description representative of the environment corresponding to the map data. The map data may include map images, point clouds, SD maps, manually created and/or drawn environment layouts, schematics, and/or the like.

In this example, the map data 202 can be provided to a description generator 204 which can attempt to generate a tokenized description of the map data 202. In at least one embodiment, the map data 202 can be analyzed by a feature extraction module 206 of the description generator 204. As mentioned, feature extraction can be performed as part of a large language model (LLM) 208 or by using a separate model or algorithm, among other such options. In this example, the feature extraction module 206 can include an encoder that extracts features from the map data (and any other relevant input) and encodes those features as, for example, feature vectors, embeddings, or points in a latent space. The latent space may be an n-dimensional latent space, where each environment, portion of an environment, or state of an environment can correspond to a point (or vector) in the n-dimensional latent space.

In this example, at least one feature vector representing the point in the n-dimensional space can be provided as input to a large language model 208. Various other types of embeddings or representations can be used as well within the scope of various embodiments. In at least one embodiment, each object in the environment can be represented by a token in a text string to be generated, as well as an embedding, feature vector, or point in an n-dimensional latent space, as discussed previously. Such a feature vector or embedding can specify not only the type of object but can also represent various features of that object that can help to encode, for example, semantic, geographic, and/or topological information for that object.

The first language model 208 can use this input to generate a tokenized description (e.g., a tokenized text string) that is representative of the environment as indicated by the initial map data 202. In this example, the first language model 208 might receive other input as well that may help to generate a more accurate representation. For example, the language might receive an additional map or environment representation, or prior tokenized text string (e.g., for a prior time point or nearby location) to which the language model can refer, and which can help with consistency of representations over time, such as where the environment is being reconstructed for a vehicle moving through an environment and comparing the inferences for each time point can help to improve accuracy by reducing noise or removing false positives (or at least flagging inferences that do not make sense based on a prior determination, such as where an object type has changed or suddenly appeared out of nowhere). Various other types of input can be provided as well. For example, a user might use a client device 214, such as a desktop computer or notebook computer, to provide input that can guide the generation of the tokenized (e.g., text) description. For example, the client device might provide contextual information that can help to guide the generation. The client device might include an editor that can access an appropriate API or other interface of the description generator 204 or language model manager (not illustrated) of the system. Contextual information might include, for example, a type of environment, such as indication of an urban or rural setting, side streets or highways, etc., which can help the model to apply the appropriate set of rules. As an example, some of the relationships between road objects may be quite different in downtown Manhattan than they are in rural Montana, although various other relationships may be quite similar. The contextual information might indicate the state or country for which the map data was generated, as different states or countries often have different traffic or behavior rules, such as which lanes vehicles are allowed to turn into at an intersection. If applicable, the contextual information might include information about the weather or time of day. Further, different behavior or rules might be appropriate at night or other situations where visibility may be limited. As discussed later herein, where a simulation environment is to be generated based upon embeddings in a latent space, for example, the additional input from a client device 214 can help to determine aspects of the simulation environment to be generated.

In this example, the tokenized description generated by the first language model 208 is a text string representative of the initial map data 202 used as input. As mentioned, this initial map data 202 may be in any of a number of formats, and may include varying levels of detail. A system as illustrated in FIG. 2A can attempt to generate another version of this map data, or tokenized representation of this map data, that includes additional information or detail that may be useful—or even required—for certain downstream operations or applications. For example, an autonomous vehicle navigation system may require certain information to be available for use in safe autonomous operation. Similarly, a certain level of information may be needed to generate realistic 3D or 4D simulations of an environment for purposes such as robotic device testing or virtual/augmented/enhanced reality applications.

In at least one embodiment, this map data generation operation can be treated as a type of language translation and/or enhancement task. A second language model 210 can take as input a first tokenized description at a first level of detail (or resolution) and generate a second tokenized description at a second, higher level of detail. As discussed in more detail elsewhere herein, the second language model 210 can apply the various language rules and relationships to not only infer additional information about an environment represented by the first, lower resolution tokenized description, but can also fill in any gaps, identify additional relationships, or otherwise infer additional information for the environment, which may include semantic, topological, or geometric information, for example, in addition to the types of map data that may have been included in the initial map data. While the first language model 208 may have also performed gap filling and other operations, the second language model 210 can produce a tokenized representation that has additional detail or information, and can identify gaps or omissions in at least that higher level of detail. The higher level of detail may include more precise object placement, for example, based on where the second language model 210 has learned those types of objects are typically placed based on the relevant training data. The higher level of detail may also include additional types of information, such as information about continuous lanes and proper navigation paths through complex intersections, which may be based upon individual lane segments or even rough lane boundaries in the initial lower-resolution map data 202. Various other types of information can be inferred and/or included in the higher resolution tokenized description as well. In at least one embodiment, the lower-resolution tokenized description received as input to the second language model 210, as well as the higher-resolution tokenized description received as output from the second language model 210, can be in the same language, such as RTL or other domain-specific language. In at least one embodiment, the language translation operation performed by the second language model can also translate to one or more other domain-specific languages. For example, a 2D map of an environment might received that is used by the first language model 208 to generate a first tokenized representation of that map data in a first language. There may be more than one application that might utilize this data, but may benefit from a higher level of detail and require the representation to be in a specific language. For example, an autonomous vehicle navigation application might require the higher-resolution representation to be in a language such as RTL, which is specific to a road domain, while a 3D visual simulation application might require the higher-resolution representation to be in a language that is specific to a simulation domain. These representations, once generated, can be stored to a location such as a higher-resolution map repository 212 and/or provided to recipients, such as a simulation system 216, for use in performing one or more operations. In at least one embodiment, the second language model 210 (or a third language model) can also take stored higher-resolution representations from the repository 212 and translate those representations to one or more other domain-specific languages.

A client device 214 can have access to the tokenized representations in the repository as well, which allows for tasks such as review and selection. Before, during, or after generation of a higher resolution representation, the client device may provide information or instructions that can be used to generate, update, and/or modify a given representation. For example, a user of the client device 214 can provide contextual information to be used in generating the representation. For example, the client device might provide information about a location of the input map data representation, such as information that the input map data, representative of an intersection, corresponds to an intersection in Asia or Europe, or in a specific town or location. The additional information to be added by the second language model can then depend at least in part upon this information, as information relating to paths through an intersection or placement of traffic signals may vary by location. The client device 214 can also provide additional information or instructions, such as an indication of a specific language to use for generation of a representation, a type of token to include or exclude from a representation, or other such information that can help to guide the generation of the higher-resolution tokenized description. The client device 214 can also be used to modify the initial map data 202 before processing, indicate the types of features to be extracted, or provide contextual information to be used by the first language model 208 in generating the first tokenized description, among other such options.

FIG. 2B illustrates another example system 230 that can be used to generate a detailed, tokenized description of at least a portion of an environment, according to at least one embodiment. In this example system 230 a single language model 232 is used. Such a trained model can take in map data 202 as input and generate a tokenized description of that map data that can include additional level of detail or other additional information. The language model 232 may be able to take in the map data in one or more input formats, and may include an encoder that can extract features from the map data to be used to generate a tokenized description. In other embodiments, such a system might include a separate encoder (not shown) or feature extractor to extract features from the input map data and provide extracted features, embeddings, or representative vectors as input to the language model 232. Such an approach does not require generation of a first, lower resolution tokenized description of an input map, which then undergoes a type of language translation operation, but can instead generate such a tokenized description directly from the extracted features or embeddings, etc. As with the previously-described system of FIG. 2A, additional or other types of representations of an environment can be provided as additional or alternative input, and a client device can provide additional instructions, context, or other data useful in generating tokenized descriptions with at least a target level of detail. These tokenized descriptions can be stored to at least one repository 212 or provided to a recipient such as a simulator 216, among other such options. There may be additional, fewer, or alternative components used as well in other embodiments, as may include multiple models trained to generate tokenized descriptions for specific domains.

As mentioned, tokenized descriptions—as may include one or more text strings with tokens representing various aspects of an environment—generated by a language model can be provided to various components for various tasks. In some embodiments, a reconstruction of environment might be performed by a reconstruction module or system, such as to generate a high-definition (HD) map or 3D digital model of the environment. In some embodiments, a text string and/or reconstruction might be provided to a control or navigation system for an autonomous vehicle or robot to allow decisions to be made about how to move or interact with respect to objects in the environment. In this example, an initial capture device used to generate the input map data, at a potentially lower resolution or level of detail—might be on or part of a vehicle or may in some embodiments be the vehicle (or robot, etc.) itself. The reconstruction of the environment can be provided back to the capture device for use in performing specific tasks. For example, if the capture device is an autonomous vehicle or driver assistance system, the reconstruction (or in some embodiments the tokenized text string) can be provided back to the capture device—which captured the initial sensor data using associated sensors—to perform operations such as to make navigation or operation decisions based in part on the reconstruction.

In at least one embodiment, the reconstruction can be provided to a client device 214 for presentation or analysis, which may be the same client device that instructed the reconstruction. The client device 214 can analyze the reconstructed environment for accuracy and completeness in some embodiments or can perform various operations or simulations with respect to the environment.

Referring to the description of FIGS. 2A and 2B, a language model can be trained to take input from any of various stages of a representation generation pipeline. For example, a language model can take raw sensor data as input or can take as input an initial representation (e.g., a point cloud or initial map) generated by analyzing that sensor data using a separate module, system, component, model, algorithm, or process. Similarly, the model might take in determined aspects or information as may relate to the kinematics, semantics, topology, or geometry of an environment, or might take as input an object-based representation generated for the environment, among other such options. In at least some embodiments, the type of input to be used may depend at least in part upon the system in which the language model is to be used, as different systems may already provide specific outputs to be used. In at least one embodiment, a language model might take the raw sensor data and such an intermediate representation as input, in order to attempt to provide more accurate or consistent representations. In some embodiments, multiple language models may be used. For example, a language model might be used to determine the semantics, topology, and geometry of an environment that are then to be fed as input to another language model.

In some instances, a lower resolution map or representation for an environment may be incomplete for any of a number of reasons. For example, it might be snowing and some of the lane markers may not be visible or accurately represented in the sensor data used to generate the map. In other instances, certain types of objects may have been omitted from a generated map image. In such situations, it may be difficult for an operation or task to be completed accurately or successfully based on the lack of complete information. Using a system such as that illustrated in FIG. 2A or 2B, however, decisions can be made based on information for similar situations and environments. For example, during a feature extraction and encoding stage, a point can have been determined in an n-dimensional latent space that represents the extracted features. While the set of features will not be complete due to the initial data being incomplete, a search can be performed in the latent space for nearby points, which would represent very similar environments. This could include, for example, similar intersections in different locations, or even previously generated embeddings for the same general environment. Other types of feature- or embedding-based searches can be performed as well within the scope of various embodiments. Such an approach can help to further fill in gaps or omissions in the input data.

In at least one embodiment, a tokenized text string can be used to represent an object graph for at least a region or portion of an environment. This can allow such an approach to be used with existing systems or processes that expect such a graph as input. Approaches presented herein can provide accurate object graph representations in the form of tokenized text strings, for example, which can be generated quickly, accurately, and automatically without human intervention in most cases. As mentioned, such a process can also help to fill in gaps or make corrections in the object graph that might not have been determinable from the sensor data or related input. In at least one embodiment, particularly where a language model undergoes continued learning, the model may learn new relationships or object types that may help to build more robust object graph representations and can infer additional semantics or relationships which can help these object graph representations to become more accurate over time. The syntax of the relevant description language can be updated over time to more accurately capture or reflect these additional learnings. In at least some embodiments, a tokenized text string can be equivalent to an object graph, just in different form. In other embodiments, a tokenized text string may include additional information that provides more context, understanding, or insight than might be available using a conventional object graph, and may include relationships that might not be indicated using such an object graph, including relationships that might not be easily explainable using natural human language.

As mentioned, a language model can apply learned rules to an environment, such as how a language model would have applied language rules to natural language text. Similar to how a model learns correct sentence structure, the model can learn correct environment structure, such as how lanes and roadways interrelate and are permitted to be designed. This can prevent the language model from generating a text string that indicates that lanes cross each other outside intersections, that certain intersections can be free of traffic signals or stop signs, that onramps can end short of the connecting highway lane, and so forth. The semantic understanding of these relationships can help to fill in this information even where the sensor data did not include sufficient data to otherwise provide this information or was otherwise unclear as to how it should be interpreted. The language model can use its learning and semantic understanding to properly interpret the data that is available and can refer to data for similar environments in at least some embodiments when it is appropriate or necessary. In some situations, there may be an object observed that cannot be identified with a sufficient level of confidence—such as where the object is partially obscured or damaged or is of a type or style that has not been previously encountered. The language model can rely upon its learnings to make a more accurate and/or confident determination of the type of object based on, for example, the other objects in that environment and the types of objects which typically have relationships to those objects. For example, an intersection will typically have a stop sign or traffic signal, while a highway will not and may be more likely to have an express lane or a mile marker. The ability to know what type of objects to expect for a given environment and/or context, as well as where those types of objects would typically be in that context, a language model can improve aspects such as object recognition even for objects that were not previously encountered or are at least partially obscured.

In some embodiments, such as where an environment is to be generated for simulation that complies with real-world rules, a user might augment map data to include additional (or alternative) objects in the reconstruction. For example, a user might use a client device 214 to submit information about a pedestrian bridge that is to be added to a representation of an environment. Appropriate embeddings for the bridge can be determined and encoded into the latent space for the environment. In some embodiments, the user might view the reconstruction on the client device 214 and make modifications, which can be provided as updated input to the relevant language model to provide an updated tokenized text string and environment reconstruction.

In some embodiments, a user can be allowed to generate a new environment reconstruction independent of a specific instance of map data, but based upon learnings from previously-generated lower-resolution maps. A user might provide input (e.g., speech or text) describing an environment, and this input (after any appropriate reformatting or analysis) can be used to select an appropriate point in a latent space, for example, which can then be provided as input to the language model to generate an appropriate tokenized text string. In some embodiments, the user input may be able to be provided directly to the language model as input, without the need for separate feature extraction or embedding generation. The language model can then generate a tokenized description that is at a higher level of detail than any of these previously-generated maps. Such an approach can be useful for simulation environment generation, where a large amount of environment data can be generated synthetically without extensive cost or manual effort, which can be beneficial for training machine learning models or other artificial intelligence systems to operate in these various simulated environments. An environment generation process can then generate environments automatically, in response to human prompts, or through a combination of both. Modifications to the environment can be made relatively quickly and without significant processing through updating of the tokenized text string.

In at least one embodiment, an environment generation and/or reconstruction system can work with various data formats and can perform reformatting or restricting as appropriate. For example, data might be received in map, object, or graph format and can be converted to tokenized text string in a structured language. Similarly, such a text string can be used to generate any of these or other such representations of an environment. The text can also be regenerated to correspond to a different human language, as the same language (e.g., RTL) may have different terms or descriptors in different human languages (e.g., French or Spanish) for similar types of objects or relationships. When specifying the context such as the country or region, a language model can also learn to speak a language in which it may not have been initially trained and can learn to use the terminology that is appropriate for a given location or context. It may be the case that components of a system all speak in a structured token-based language internally but may accept input or generate output in any of a number of different formats. Using structured language to communicate internally can help to ensure that no data regarding semantics, relationships, or other such aspects are lost during processing and analysis due to the type of format being used.

As mentioned, a language-based representation can be very compact and discrete. Such aspects make language representations beneficial for use in real-(or near real-) time, real-world environments as the representations can be updated quickly and accurately and can be updated to include only that information that is relevant at the current time. For example, a language model might be used with a navigation system of an autonomous vehicle to make real-time navigation determinations. The ability to make these decisions is critical for many such applications. As the vehicle moves, the language representation can be updated to include portions of the environment that are now visible to the sensors ahead of the vehicle, for example, and can remove or delete portions that are no longer visible or are otherwise determined to not be important to navigation and the current location given the current direction and rate of motion, or other such aspects. Similarly, as another vehicle enters the roadway near the current (e.g., ego) vehicle, a representation of that other vehicle can be added to the language representation, while vehicles exiting the roadway or being more than a threshold distance away from the ego vehicle may be removed. Such an approach can allow the language representation to be easily right sized, such that it can contain all the information determined to be important and an exclude any information that is determined to be irrelevant, or at least no longer relevant based upon the current position, speed, direction, etc. Keeping a dynamic language representation current but compact can help to make better, faster decisions by only including the information needed to make decisions at a current (or near future) point or period in time.

As mentioned, a language model in at least one embodiment can be self-supervised. A language model can be trained to understand the structures, patterns, syntax, relationships, and other aspects of the language(s) on which it is trained. The trained model can then take in text (or other language input) for a new environment and generate or reconstruct that environment based on its learnings or can take in an incomplete or inaccurate representation of an environment and can generate a corrected or more complete representation. And this can be an end-to-end automated process with no need for human intervention, as opposed to prior systems that required human intervention at some if not all stages of map generation. When a model learns that it made a mistake and/or is able to correct a mistake or omission, the model can learn from that in order to make better future decisions. Such an approach can help to generate far more accurate representations that would be possible, or at least practical, with human-generated systems, as there can be many more rules or relationships for an environment such as an intersection or parking lot than may be practical for a human to attempt to accurately code, particularly when many of these rules or relationships might be implicit such that a human may not consciously even be aware they exist. A language model can learn these and other such rules and relationships without coding or supervision, which provides a significant advantage over prior mapping or reconstruction systems.

In one example, a language model can be used to generate or correct a representation such as a high definition (HD) map. An HD map generally is a type of map used for tasks such as autonomous driving, which may contain details or information that are not typically included in, or associated with, a conventional map. In an example HD map, individual sections of a roadway are encoded separately. These encodings can differentiate regions corrupting to different lanes in an intersection, for example, as well as potentially options for navigating on those lanes. Such information can be helpful in an intersection where there may not be painted or explicit lane markers for each available lane in each direction. This information helps a navigation system to function more like a human would, having the ability to understand implicit information based on context, but using previous systems these aspects needed to be hard coded and were thus limited in scope and difficult to scale. Each feature in the road can be represented by a node in a graph associated with the HD map. A language model can take this information and can make corrections or additions based on its understanding of the relationships and semantics of the environment, which can account for implicit inferences typically performed by human beings that can otherwise be difficult to design or instruct an automated process to perform. While aspects such as critical road boundaries may be relatively straightforward to code using a manual approach, for at least some environments, coding more implicit operations such as how to maneuver relative to a crosswalk in a complex urban environment (where the options can differ based upon the number and locations of people in that crosswalk at any given time, the state of crossing signals which may not all be visible, and decisions of people to not follow the rules and cross against the light or jaywalk, etc.) or to navigate through a detour or unique construction region can be much more difficult for a traditional system, and can benefit from the inferences and similarity determinations able to be performed using a language model as presented herein.

A language used with such a model will be somewhat lossy in many instances, so it can be important in at least one embodiment to attempt to encode features in that language in such a way as to retain as much important information as possible. For example, an image can contain many details about a person or vehicle, and many of these details will be lost in a compact language description. For many aspects this will be acceptable, as information about the general appearance or clothing of a person will typically not impact the decisions made by a vehicle with respect to this person, such as to avoid coming within more than three feet of that person at any time. A type of object may thus be used as a primary type of token, but there can be additional details or information stored on the token in a token-based text string. In at least one embodiment, geo-coordinates are stored as well so all nodes or tokens have well-defined places in space in addition to information about connectedness or relationships. The nodes thus store information about geometry in addition to information about semantics and topology. The information can also be general enough to support multiple domains or tasks that may involve similar types of objects.

In at least one embodiment, this additional information can be generated using conventional algorithms or machine learning, among other such options. For example, one or more machine learning models can be trained and used to provide information about the semantics, topology, and geometry (or other such aspects) of an object or environment. This can include the use of one or more language models that can take in various types of input and output a textual description of, or textual content for, any of these aspects. In some embodiments, the raw sensor data can be provided as input, while in other embodiments there may be at least some amount of pre-processing, such as to determine bounding boxes around objects and extract the relevant image data or perform basic object classification based on operations such as computer vision-based analysis, among other such options.

FIG. 2C illustrates an example tokenized text string 240 that can be generated for a first portion of an environment in accordance with at least one embodiment. FIG. 2D illustrates a bird's-eye map view 250 of the first portion, illustrating some of the objects represented in the example tokenized text string 240 of FIG. 2C. As illustrated in FIG. 2C, the string is a tokenized description composed of a sequential text string that represents individual objects as tokens, like nodes of a map graph. In this example, there are objects of types such as signs, lanes, and vehicles that are represented by tokens in the text string. Other information is encoded as well, as may relate to key points or geometry for the various tokens with respect to the environment. The key points may be used to indicate geometric coordinates or bounds of a lane, or section of a lane, for example. Although the example text string is rather long (as may include thousands of tokens for a single environment), the text string provides the necessary information to perform tasks such as navigation or driver assistance in a much more compact form than if the data were a set of high-resolution images or a high-density point cloud representation of the environment. Although a single text string is illustrated, it should be understood that in at least one embodiment there may be multiple text strings generated to represent different portions or features of an environment. Also, different types of information can be used with a text string as is appropriate for a given environment in a specific embodiment. In this example, the text string is generated using a specific language, such as RTL. The language is structured so that the text string will be both discreet and sequential in its tokenized (one-dimensional) representation. In at least one embodiment, a generated text string can be auto-regressive in that an individual token in the string will depend in part upon the previous token(s) in the string. As mentioned, a language model can be trained using an unsupervised (or self-supervised) approach in order to be able to cover the wide variety of concepts needed, without the need for a very large and varied corpus of annotated training data. In at least one embodiment, even though the text string is tokenized and sequential, there can be few other structural limitations placed on the generation of the string in order to prevent those limitations from becoming a bottleneck that can negatively impact performance due in part to the large amount of input data that may need to be processed. The structure may be flexible, similar to how there can be many valid ways to flatten a map graph or object graph that are all equally valid. There may also be many different valid object graphs to represent the same environment, and the generation of a tokenized text string can have similar flexibility. This flexibility also helps the text string generation to be able to better update over time, as well as to scale to include larger or smaller numbers of tokens based at least in part upon changes in the relevant environment.

For comparison, FIG. 2E illustrates a bird's-eye map view 260 of a second portion of the environment, here relating to a different intersection including different identified objects with different aspects, which may be represented by textual tokens in a tokenized description, which may be written in the same domain-specific language. FIG. 2F illustrates an example portion of a tokenized text string 270 that can be used to describe the important (or at least domain-relevant) objects and features represented in the map data. As mentioned, the tokenized description can include additional semantic, relationship, and other information that may not be stored with, or immediately determinable from, the map data alone.

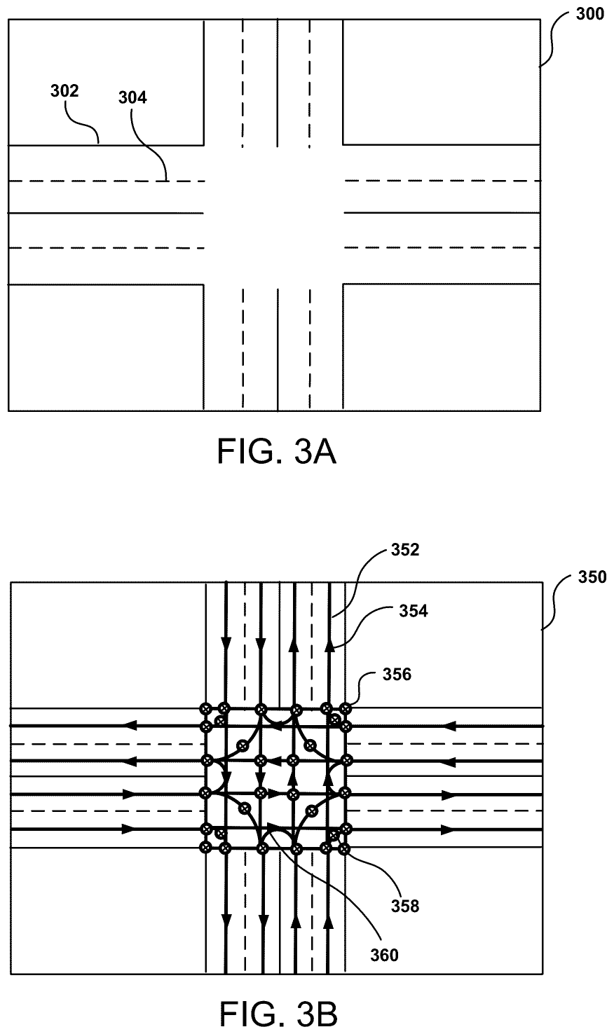

FIGS. 3A and 3B illustrate examples of maps corresponding to lower and higher levels of detail, or different “resolutions,” for the same portion of an environment. As discussed previously, “resolution” as used herein does not refer specifically to a number of data points or similar values as used in the context of images or other such data, but refers to a level of detail, type(s) of information, and/or amount of specificity contained in a representation. For example, a higher resolution map may include additional information—such as lane indicators—that were not indicated in the initial lower resolution map, but the higher resolution map may in fact be smaller in size or number of data values, such as where a lane line can be represented by a small number of coordinates (as few as two) instead of a large number of pixel values from a map that correspond to the position of that lane line.

As mentioned, an input map 300 such as that illustrated in FIG. 3A may include varying amounts of information. In at least one embodiment, the map should include at least a general indication of the locations of one or more roads or other features that are to represent the portion of the environment that is of interest. This may include at least a general indication of the outer boundaries 302 of the roadway(s), and in at least some embodiments may also provide an indication of the lane boundaries 304 within those roadways. Other information may be included as well, as may include traffic signals, crosswalks, lane segment indicators, offramps, railroad crossings, bodies of water, parks, buildings, and the like. In at least one embodiment, there may be no minimum data requirement, other than at least some indication of the roadway(s) to be represented in the environment. Information for the map 300 can be provided as input to a language model, which can generate a tokenized description of the environment. As mentioned, the language model may generate a first tokenized description that already includes a higher level of detail than the initial map 300, due to gap filling and other applied learnings as discussed and suggested herein.

This initial tokenized description can be provided as input to a language model that can generate a higher resolution tokenized description that includes additional information, such as that illustrated in FIG. 3B. In this example, a map image 350 has been generated using the higher resolution tokenized description. As illustrated, the higher resolution description includes additional information, in this instance including continuous lane markers 352 for individual lanes in this portion of the environment, as well as indicators 354 of the direction of traffic flow in each of the lanes. This information was not included in the initial map 300, but could be inferred by the language model. The language model can use information inferred from the map data, at least some type of location data for the map, or additional contextual information for these determinations, as in different locations vehicles operate on different sides of the road (such as in the US versus the UK) and it may be necessary in at least some embodiments to determine or infer the appropriate location in order to ensure correct traffic flow directions. In at least some embodiments, a language model may be able to infer the direction from the directions of signs, placement of traffic signals, or other such aspects, if those aspects are reflected in the lower-resolution representation.

Also illustrated in FIG. 3B is additional information inferred for an intersection. This includes indications 356 where each lane crosses or intersects another lane, as well as directions of traffic flow through the intersection. For example, each lane is illustrated to pass directly through the intersection. There are additional path indicators 358 illustrating how an individual lane can turn into one or more other lanes (with not all possible turns being illustrated in the figure for simplicity and clarity). There are also indicators 360 for specific lanes that are able to make U-turns into other lanes, which may not be possible for all lanes. This additional information can be used for a variety of purposes, such as to provide a greater level of detail that can assist with more accurate routing decisions, which can include detail about specific lanes to use at specific locations. Such information can also help to simulate traffic in such an environment, as the traffic can be caused to follow the appropriate traffic flows. As illustrated, even the addition of this lane and intersection information would take a significant amount of time to manually indicate, and would require expert knowledge of the rules of the road for different locations. As mentioned, there may be may other types of information that can be included that would require further effort. It would also take significant effort to attempt to manually verify and/or improve the position of any of the relevant objects or indicators—such as roadway boundaries—that may not have been precisely indicated in the initial map 300. The ability to infer this information using a trained language model, using a lightweight language-based representation that can be translated relatively quickly, can provide for significant performance improvement and reduction in resource requirements, in addition to improving the overall quality of the final, higher-resolution map representations. Prior approaches to generating HD maps that used tools operated by human experts are also not scalable to large datasets including many such representations. In some prior systems, these tools rely on data from various sensors, such as camera, LiDAR, RADAR, ultrasonic, and GPS systems or sensors, and allow a human expert to overlay an SD map and enhance the map with HD map-type detail, as may include lane lines, road boundaries, traffic lights, signs, and the like. In some systems, computer vision can be used to attempt to extract features from these sensors and augment the underlying SD Map using heuristics, but these heuristics are generally manually coded and are not particularly flexible or scalable.

Scalability of approaches can be important for operations such as simulation and training, for example, where it may be desirable to generate a large dataset that includes many variations of a same general layout. For example, there may be many different variations of the same general type of intersection. This may include variations for different countries, urban versus rural locations, and so on. The generation of higher resolution representations from lower resolution representations is not deterministic in at least one embodiment, the same lower-resolution input map data can be used to quickly generate—through language translation using a trained language model—a number of variations of the same input map data, all with the additional level of detail. While these variations may be at least somewhat random based on the inferencing process used, additional information can be provided for individual versions as well, to help guide the generation of variants. For example, a system might be instructed to generate right- and left-driving variants, as well as variants for North America, Europe, and Asia, among various other such options. In this way, a large number of higher-resolution map representations can be generated from a single, lower-resolution input, where the higher resolution map representations can all be physically realistic, include higher levels of detail, and can include additional information such as semantic, topology, and geometry data, among other types of information including those discussed and suggested herein. In some embodiments, a higher definition map can be used to generate a lower generation map, and then that lower generation map can be used to generate variations of the higher resolution map.

A language model (such as an LLM or other language-based generative model, network, or process) in at least one embodiment can be trained using pairs of map-related data for the same location or region of an environment. For example, the tokenized descriptions at both a lower level of detail and a higher level of detail for a given region can be used as training data for the model. The representation with the higher level of detail can have been verified to include the relevant or required information, correct position information, and the like, and then can be used as ground truth data for the tokenized description with the lower level of detail. Since generation of a lower-resolution representation would be deterministic in at least one embodiment, a higher-resolution representation can be used to generate a lower-resolution representation for training purposes. Such training data can help a language model to learn patterns and relationships between, for example, SD (or navigational, or lower-resolution, etc.) and HD maps (or between aerial photos of roadways, drawings or sketches or roadways, building schematics, etc. and HD maps or other higher definition representations of environments). In at least one embodiment additional input training data may be provided as well, such as the sensor data that was used to generate the input SD map, which can help the model to learn why certain relationships or patterns should be identified, etc. Once trained, the language model can take as input a tokenized representation of an SD map, for example, and can generate—through language generation and translation—a tokenized description for the corresponding HD map representation, including the additional detail or information appropriate for the HD map. Such an approach can also be used to infer missing details in HD maps to improve the overall quality. In at least one embodiment, as mentioned, the generation of higher resolution maps is not deterministic, so there can be many valid HD maps that correspond to an input SD maps. In at least one embodiment, the only requirement for a generated HD map is that it is realistic and complies with real-world rules, particularly where the HD maps are to be used for simulation. This includes, but is not limited to, realistic locations of landmarks, traffic signals, and the like. The HD maps generated from an SD map also have to be consistent with the underlying SD maps, such that if a set of SD map tiles are used to generate HD map tiles, the HD map tiles should still fit together consistently as would the SD map tiles. Such an approach can be used advantageously for domains such as incomplete intersection representations, where a road in at least one direction with respect to the intersection has not yet been driven. A trained model as described herein can help to identify and/or complete these intersections and/or other incomplete domains. As another example, SD map tiles might include road topology and segment information that fit together at the edges of those tiles, and the lane indicators and connectors present in the generated HD map equivalent should also fit together seamlessly at the edges of the tiles. In at least one embodiment, tokenized descriptions for adjacent tiles may also be provided as input to a trained language model in order to ensure consistency and continuity of the inferences across adjacent tiles. Other types of conditioning can be used as well within the scope of various embodiments. The HD maps can also provide more precise geometry than was indicated in the SD map, including geometry in three dimensions. In one embodiment, an input map might be provided that illustrates a curve with higher than acceptable curvature, and the language model can generate the closest, most physically accurate representation of that curve that complies with relevant curvature limits or regulations.

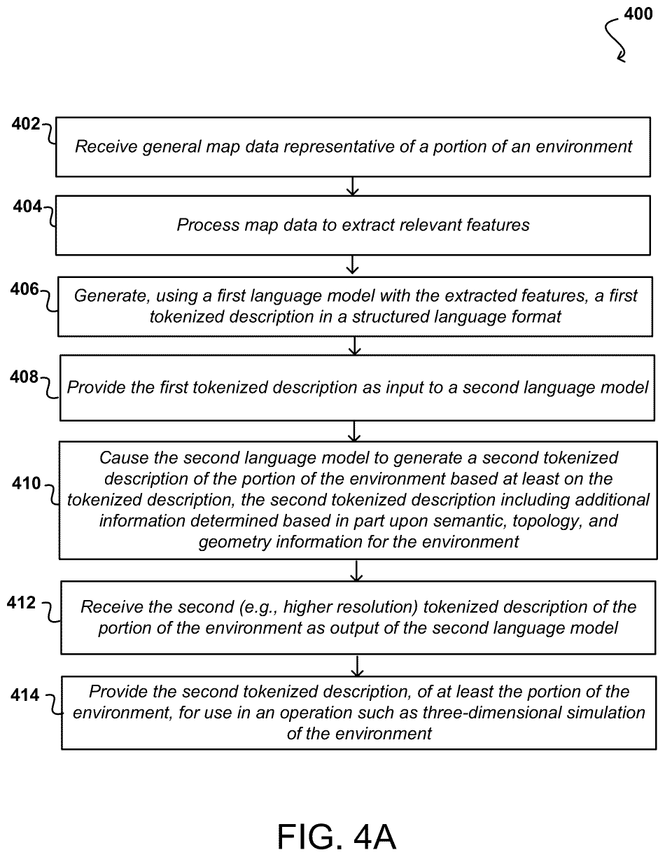

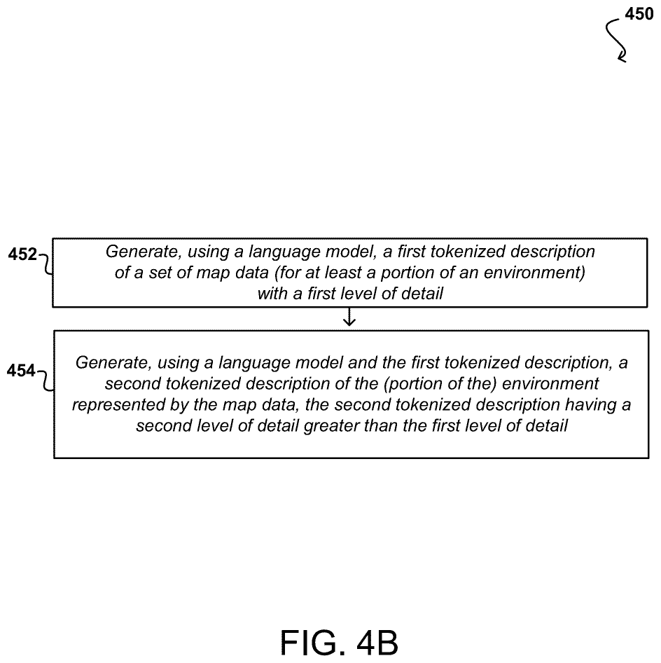

FIG. 4A illustrates an example process 400 to generate a tokenized representation of a portion of an environment that can be performed in accordance with at least one embodiment. It should be understood that for this and other processes described herein that there can be additional, fewer, or alternative steps performed in similar or alternative orders, or at least partially in parallel, within the scope of the various embodiments unless otherwise specifically stated. Further, although discussed with respect to high quality maps, such as HD maps, it should be understood that aspects of tokenized descriptions can be used advantageously for other types of environments, use cases, or domains as well. In this example, map data is received 402 that is representative of a portion of an environment. The map data is referred to here as “general” map data as it may include any appropriate level of detail, or type(s) of information, as long as the detail or information is sufficient to generate a reasonable tokenized description of the environment—that is, the data has at least enough information to be able to determine or infer at least the general placement and form of roadways or other objects or relevant features of the environment. This may include, for example, a 2D bird's-eye view map image, an SD map, or a hand drawn sketch of a portion of an environment, among other such options. General map data may correspond to initial or “lower resolution” maps including lower levels of detail as discussed elsewhere herein. The map data in this example can be processed 404 to extract relevant features, unless those features were already extracted or identified in the received map data. The extraction can be performed using any appropriate encoder, feature extractors, or other such component, process, or technique, as may be performed as part of the functionality of a trained neural network. A first language model can then use these extracted features, along with potentially other relevant data, to generate 406 a first tokenized description of at least the portion of the environment. This tokenized description can include a string or sequence of text-based tokens in a domain-specific language in at least one embodiment, where the tokenized description can include semantic, topology, geometry, and additional data as discussed elsewhere herein that was inferred from at least the extracted features of the map data.

In this example, this first tokenized description (generated from the input general map data) can be provided 408 as input to a second trained language model. The second language model can be caused 410 to generate—based in part upon this first tokenized description—a second tokenized description of the portion of the environment, which includes additional information or detail that was not present in the first tokenized description. This additional information can be determined based at least in part upon the semantic, topology, and geometry information provided and/or inferred for the environment. This may include, for example, relationship or semantic information that was not present for objects in the input general map. Such information essentially fills in information that was not present in the input map, filling in gaps or omissions in the input data. In at least one embodiment, the additional information can also include objects or information that were not present in the initial map, but that might be expected in that environment. This may include, for example, the presence of speed limit signs, warning lights, buildings, and other such objects. In at least one embodiment, information such as lane indicators and complex topology can be added to the second tokenized description, as may relate to complex intersections, highway onramps, and the like. Various other types of information can be included in the second, higher “resolution” tokenized representation as well, such as those discussed elsewhere herein. In at least one embodiment, additional information can be provided for use in guiding the generation of the second tokenized description, where the additional information may include contextual information, a style or appearance code, specific objects or tokens to include or exclude, or other such information. Once generated, this second tokenized description of the portion of the environment can be received 412 as output of the second language model. The second, higher resolution description can then be provided 414 for use in an operation, such as three-dimensional simulation or real-time navigation in the environment. In at least one embodiment, dynamic object may be added to an environment and/or represented in the tokenized description as well, as may relate to bridges that may be opened or closed, railway crossings that may restrict traffic at certain times, and so on. The ability to perform simulations for variations of a location using these higher resolution descriptions can also be used in a roadway design and optimization process, based on simulations performed for these consistent yet variable representations. In some embodiments, a client device might also instruct to ignore or remove a portion of an input map representation, in order to determine how the language model might fill in the gap, in order to attempt to quickly identify an improved or potentially optimal solution or alternative.

FIG. 4B illustrates another example process 450 to use a language model to generate a more detailed tokenized representation of a set of map data in accordance with at least one embodiment. In this example process 450, a language model can be used to generate 452 a first tokenized presentation of a set of map data with a first level of detail. The level of detail may be based at least in part upon the level of detail contained in the set of map data, including additional detail generated by filling in gaps or omissions in the map data inferred by the language model. A language model—either the same model or a separate model—can then generate 454 a second tokenized description of the map data that has a second level of detail that is greater than the first level of detail in the first tokenized description. As discussed, this can be performed as a type of language translation task performed by the trained language model, where the translation can include the addition (or alteration) of information or detail based in part upon the learnings of the model that are inferred to be appropriate for the portion of the environment represented by the map data. This may include, for example, the presence of continuous lanes or information about paths through a complex intersection, among other such options. The model may also add information that may not have been present in the first tokenized representation, but can be inferred based in part on that representation, as may relate to traffic signals, warning lights, toll booths, and the like. As mentioned, in some embodiments a single language model can be used, or a first tokenized representation at a lower level of detail may not need to be generated, among other such options.

An end-to-end map generation pipeline in accordance with at least one embodiment can thus use one or more language models to generate at least a tokenized representation of a map or environment, based at least in part on map data obtained for at least a portion of the environment. In at least one embodiment, this may include a pipeline with multiple stages, as discussed above, or may include as few as a single stage where a language model can take in map data and generate a tokenized description of a map corresponding to at least the portion of the environment from which the sensor data was captured. Such a system may not perform a sequential process involving multiple stages with distinctive functionality and input/output data formats, which would typically require detailed design, implementation, and maintenance for each individual stage to work properly, even when changes are constantly occurring. An end-to-end framework can use a shared data representation and unified algorithm structure, which can help to simplify tasks such as to rearrange processing steps, accumulate and share data for training and testing purposes, and reuse code and compute infrastructure to improve performance of different tasks, among other such options. In at least one embodiment, a tokenized representation of map information (such as an RTL document) can be shared among various stages of a map generation or modification pipeline. Such an approach allows for the flexible exchange of information between any two stages, and can significantly reduce the information bottleneck and need for customized data conversions. At least one neural-network-based language model can be used to unify various stages of the map building pipeline as similar document manipulation tasks that may use different input and output data. Using such a language model with these tokenized representations can allow any existing map data or conventional algorithms to be used as sources of information to be integrated into such an end-to-end framework, whether as training data and/or as additional information to be included in a generated map or map representation.

Approaches in accordance with at least one embodiment can formulate a wide range of geospatial information processing and related tasks—such as map building, map editing, map-based navigation, planning, and driving—as document manipulation tasks that leverage one or more LLMs to solve them in a unified and joint fashion. In at least one embodiment, an LLM is built using one or more deep neural networks (DNNs) that are trained using textual information-such as in a domain specific language (DSL) like RTL—using textual representations of geospatial information (such as maps). The DSL described herein may be referred to as, without limitation, the RTL. The RTL may rely on both the existence of a rich feature database and a graph describing relationships of these or other such features within a map or other such representation. Using one or more automated processes or operations, a set of map features/landmarks (e.g., those encoded in an HD map using a data format suitable for HD maps) may be deterministically converted to the RTL, and vice versa. In some embodiments, the graph can be represented as a knowledge graph that expresses road objects, road object relationships, and road network topology, rather than generic knowledge.

In some embodiments, an LLM (or other language model type(s)) may retrieve and/or access map data or other information determined to be necessary to generate an output using one or more application programming interfaces (APIs) and/or plug-ins (e.g., third-party plug-ins). For example, in order to retrieve additional contextual information, additional map information, additional feature information, and/or other information not directly included in a prompt to the model, the system—using the LLM, in some embodiments—may generate one or more prompts or queries for one or more data sources (e.g., open street maps (OSM), wolfram alpha, a local map database, etc.), via one or more APIs or plug-ins, in order to obtain the additional information required (or deemed necessary) for responding to the initial query or prompt. Such an approach to querying additional resources may be recursive, in at least some embodiments, in that the system may continue to access one or more data sources via the API(s) and/or plug-ins until it is determined the necessary information has been obtained, or until no additional information is available. In some embodiments, an initial prompt for the model may be generated using one or more APIs or plug-ins, such as an API for retrieving an RTL description of a selected section of a map. For example, a user may, via an API, select a portion of a map to be processed or analyzed using the LLM, and the API may return a textual or tokenized description of the portion of the map in the DSL (such as RTL).

The RTL may use an S-expression syntax as one way to represent map information. In S-expressions, information can be grouped—such as in sets of parentheses—where each set includes one or more items that can be either simple pieces of information like numbers or text, or another set of S-expressions. This allows for representing maps in a hierarchical and compositional way that can be relatively simple to parse. Other graph representations may also be adopted and used in some stages of the system to facilitate specific data manipulation when appropriate.

One of the use cases of the RTL is to interface with an LLM (or other language model type), where the grammatical validity of the output of the LLM can be ensured. Formally expressing data using a grammar can make it easier to assert its validity compared to managing an arbitrary bag of strings or relying on generic formats like JavaScript Object Notation (JSON) or Yet Another Markup Language (YAML)—which can result in loss of semantic information. As such, using a formal grammar to represent the input/output of a language model can improve the robustness and reliability of the system, and can help to ensure that the processed data has proper semantic meaning and is well-formed.

In at least one embodiment, one main entity in an RTL document is a directed graph describing a portion of a road network—such as an intersection. There are multiple possible approaches to encode map coordinates and—in order to accommodate a small, fixed-size vocabulary—a grid-based tokenization as the decimal notation may be implemented. However, alternative approaches may be used, such as using a geo-hashing representation, which provides another technique to encode geospatial locations. However, geo-hashing often relies on a global reference system and supports precision at various levels, which result in the need for a very large vocabulary.

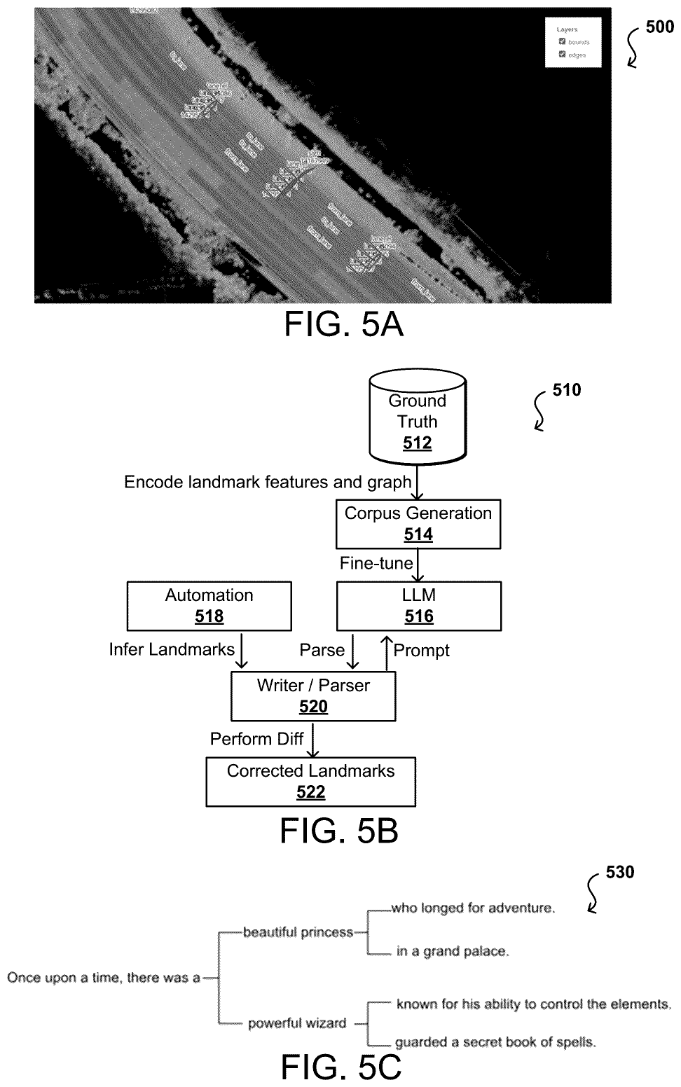

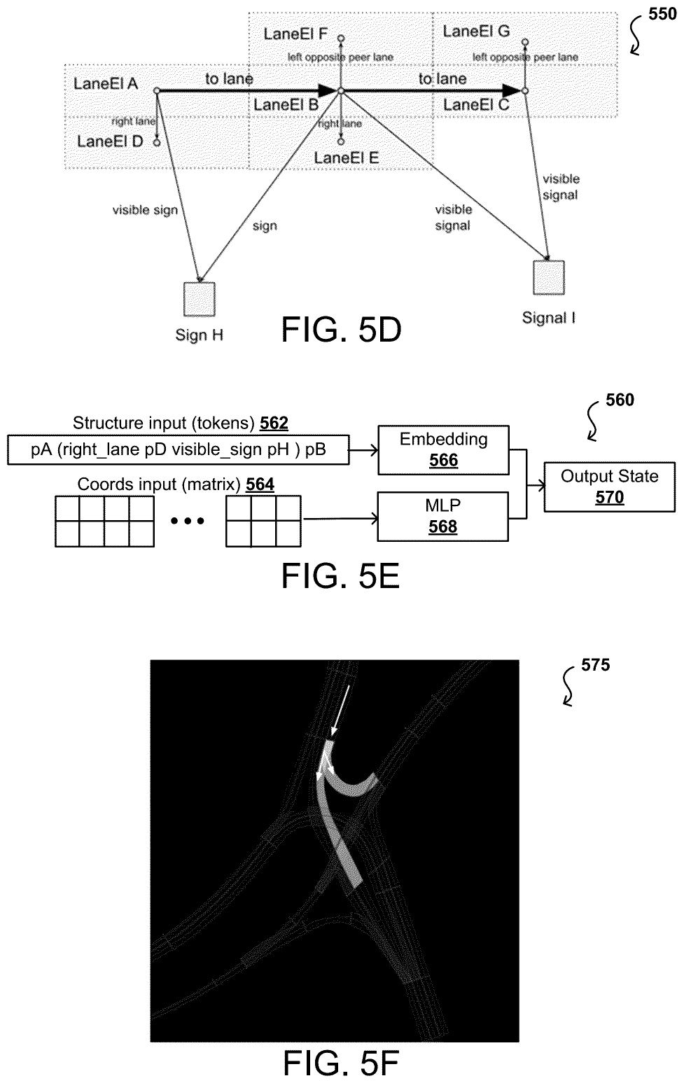

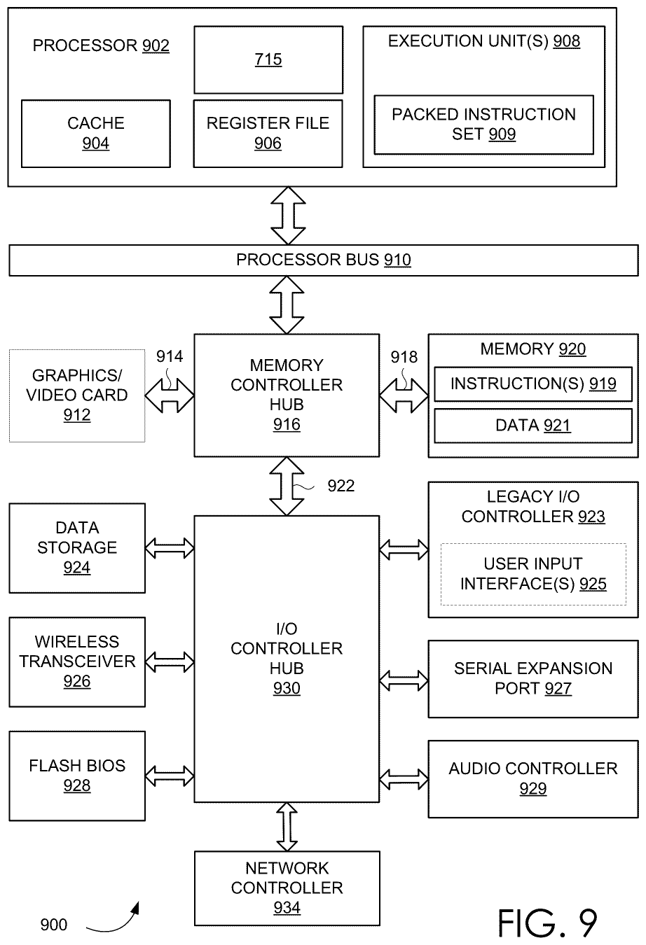

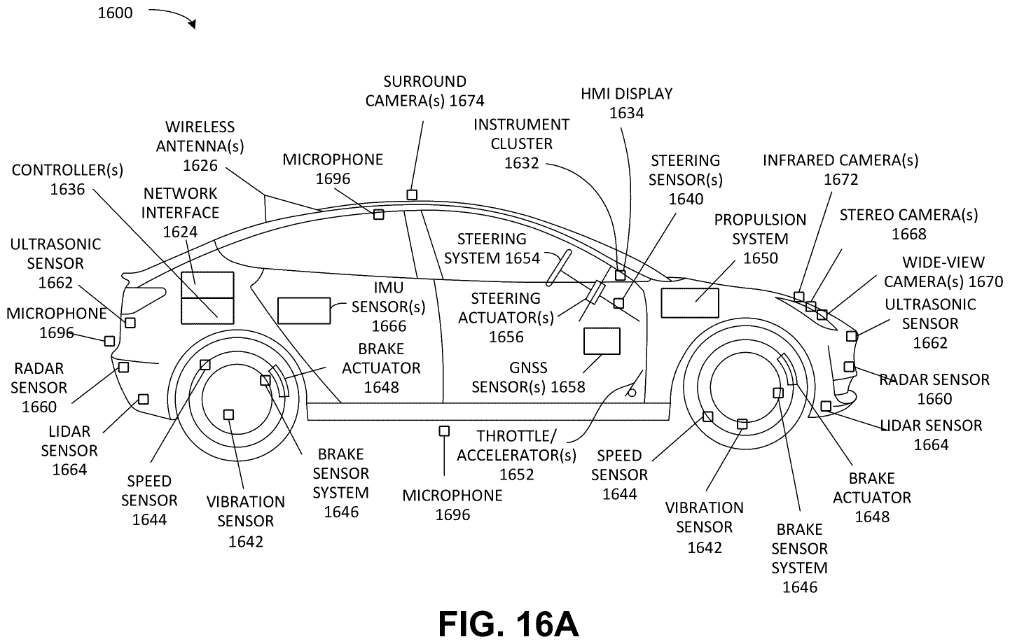

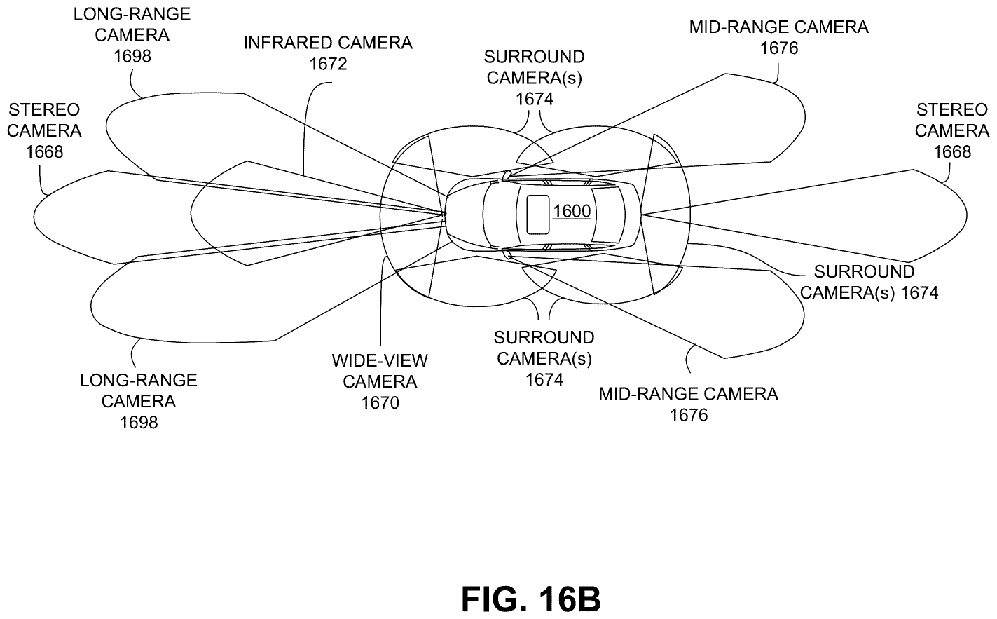

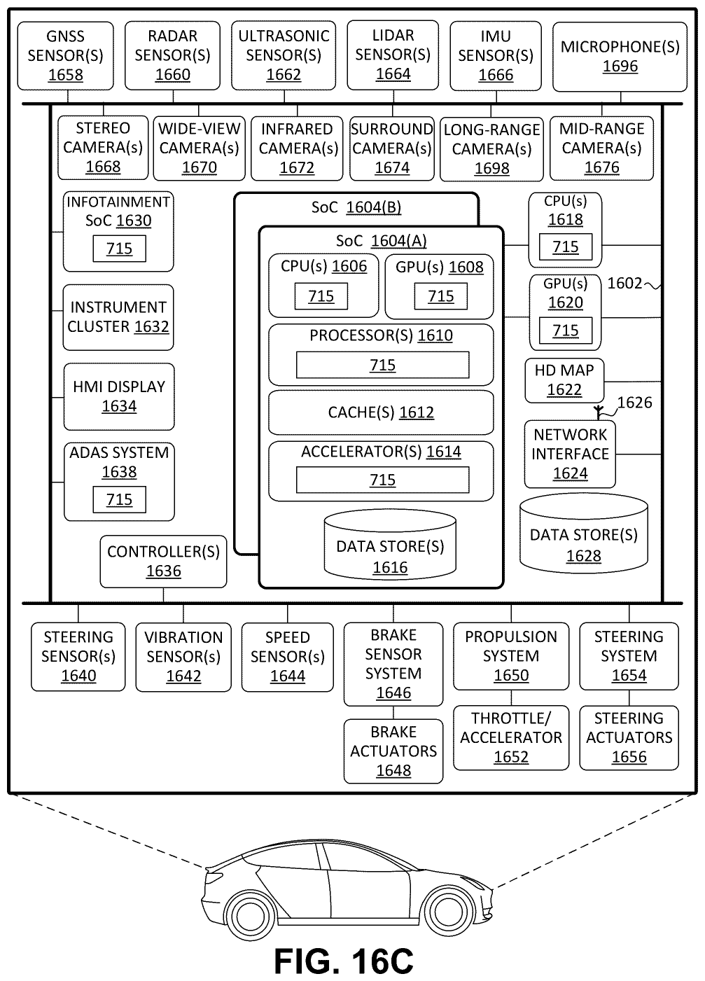

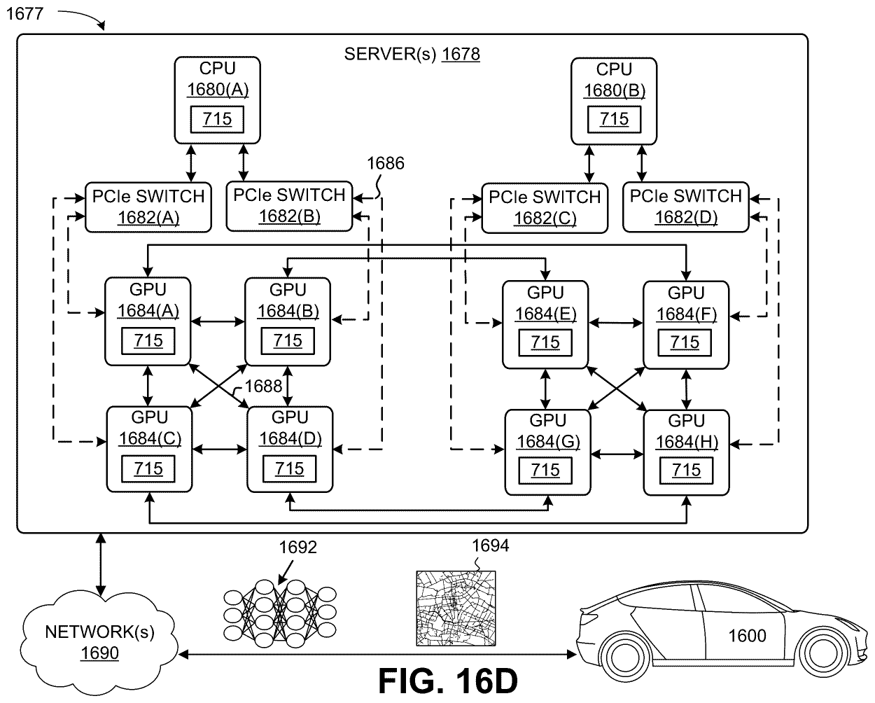

FIG. 5A illustrates an example graph view 500 of an environment corresponding to a portion of a multiple-lane roadways in accordance with at least one embodiment. To express a map for such an environment using a language such as RTL, semantic data about the map may be used. FIG. 5B illustrates an example architecture 510 for the training and deployment of an LLM, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1600 of FIGS. 16A-16D, example computing device 900 of FIG. 9, and/or data center.

As illustrated in the example architecture 510 of FIG. 5B, semantic information may be available—e.g., encoded in one or more maps from a database 512 or repository of ground truth data—and may be used to describe the map in the relevant language. In some embodiments, existing map data may be used to perform tasks such as to encode landmark features and other aspects of a map or graph. For example, an HD map (which may be represented using an occupancy map generated from any type of sensor data, such as image data, LiDAR data, RADAR data, etc., in embodiments) may have various layers—such as planning layers, semantic data layers, sensor-specific layers (e.g., RADAR layers, LiDAR layers, camera layers, etc.), and/or other layer types. To convert the map representation to a language-based representation, such as a sequential, tokenized text string, one or more of these layers may be used. An automated conversion tool can be used to read the map data in a map format and convert the data to the RTL, or otherwise generate a language-based representation of the map data, such that an LLM can understand and process the data. In at least one embodiment, this can include using a corpus generation component 514 that can generate a text-based representation based on the encodings or embeddings from the map data, and perform training before providing the text representation to an LLM 516. As such, the RTL may include or comprise a language that can express a topology of a road network (and/or other network, such as those associated with warehouses, buildings, outdoor spaces, waterways, etc.) that is derived from, for example, an HD map. The RTL may then serve as an interface between an LLM 416 and the HD map such that the LLM(s) can learn the underlying structure of the road network (and/or other network(s)).

In some embodiments, the RTL may be encoded into an HD map—e.g., into one or more layers, such as a semantic layer, of an HD map. The LLM 516 may then be trained using this encoded information as a training corpus. In some embodiments, the features that are included or represented in the RTL can include, without limitation, traffic signs, traffic signals, poles, lane dividers, road boundaries, road markings, stop lines, wait elements, lane elements, and/or the like. For each landmark or feature, various types of data may be represented—such as a landmark ID (e.g., global unique IDs), a landmark number (e.g., total number of current landmark types), spatial information (e.g., 3D latitude and longitude, size, orientation, pose, etc.), and/or semantic information. The spatial information in some embodiments may include 2D coordinates (which may be derived from 3D coordinates), 3D coordinates (which may be determined from 2D coordinates), 4D coordinates (that may change over time or have a temporal component), bounding shape locations, and/or curve locations. Bounding shapes may be represented using float [3] for location, float [3] for sizes, and float [3] or [4] for orientation or pose. Landmarks that are curves may be represented using a list of key points and their 2D or 3D locations, or may be represented using parameters of curves based on a parametric form. Semantic information may include, for example and without limitation, a landmark type, a landmark association (e.g., a traffic light's associated lane IDs, lane boundary segment locations), and/or textual information (e.g., text displayed on signs).

An LLM 516 trained with an RTL (or other DSL) corpus built from a database 512 of map ground truth data can be queried to correct features output from a machine learning (ML) automation pipeline. The output of an LLM 516—such as by using a writer and/or parser component or module 520—can be mapped back to the extracted features. A difference (e.g., diff) operation can then be performed with respect to inferred landmarks from an automation component 518, for example, to perform any appropriate corrections to generate a map graph 522. An example use case is to infer the road topology (e.g., edges) from an incomplete set of nodes (e.g., landmarks) with potential applications in, for example and without limitation, tooling, quality assurance (QA), and automation. In some embodiments, document embeddings may be indexed in a vector database, or n-dimensional latent space (where n can represent a number of extracted features or feature types), and the index can then be used to cluster similar intersections—thus allowing the unsupervised labeling and retrieval of operation design domains (ODDs) (e.g., features or landmarks).

In at least one embodiment, a structured language such as RTL can rely on both the existence of a rich feature database and a graph describing the relationships of these features within the map. Approaches described herein allow for deterministically converting from a set of landmark features to an RTL representation, and vice-versa. A graph in this example can be thought of as a knowledge graph, but instead of generic knowledge, the graph expresses the road network topology or other aspects of the relevant environment. In one or more embodiments, there may be strong constraints around how to encode coordinates so that they can be understood by language models (LMs). Location-related aspects such as coordinates, latitude, longitude, and altitude coordinate tuples can be represented using coded values or representations, such as sets of two characters from the permutations of the alphabet: “ab ac ad . . . ” up to size 256, for a non-limiting example.

To tokenize or encode a coordinate, for example, one, some, or all landmark features in a document can be considered, and a values such as their centroid may be used as the origin in an east, north, up (ENU) coordinate system (or another coordinate system), with altitude set to the average altitude of coordinates in the document. A radius R can be considered, such as, for example, 350 meters around that origin that is split into a grid (e.g., a 65536×65536 grid). The tokenization precision can be a function of this width, as a cell in the grid can be the smallest addressable (or indexable) unit which equals, for example, 0.0107 m with the proposed range. Such a fixed-size grid can allow for the coordinates to be represented at the same scale across documents (versus being normalized against the bounding shape of each document, for example).

In at least one embodiment, an important entity in a language-based representation—such as an RTL document—may be implemented as a directed graph describing a portion of an environment such as a road network. Such a graph can be used to express the connectivity between road features (topology) and may be similar to a knowledge graph. The graph nodes can then correspond to landmark features and may be typed or classified with their landmark type. The edges of the graph can correspond to the relationships between road features. In some embodiments, all source nodes may include lane elements. An individual lane element (laneEl) can be converted into a small graph, and a document can contain all nodes related to a given laneEl. A road graph can be represented by listing the entirety of its nodes and edges. The ordering of the nodes and edges may be arbitrary; however, edges can reference nodes by their index in the document.

In a graph traversal representation, an edge sequence can be used to express the path on the underlying graph of the map. Such a path can include the list of the laneEl nodes visited and their attributes. The attributes of a laneEl node may include its intrinsic properties (such as the laneEl's drivable direction), as well as the attributes of the nodes it can reach (such as signals this laneEl can see, and its neighboring laneEl). In this way, the RTL document may not capture the full graph of the map, but rather possible paths on the map. A sentence of a natural language can also be thought of as a path on the underlying graph of the natural language. At each word, there can be many different possibilities of what the next would be, and those possibilities can form a graph, with a particular sentence consisting of a sequence of choices of different edges at the nodes of the graph. FIG. 5C illustrates an example simple graph 530, similar to a sentence diagram, which can break out objects or tokens, and can associate additional information with the appropriate tokens or objects.

In at least one embodiment, a language model can analyze a number of sentences, and determine the next word such that it is consistent with the words that came before. Essentially, the LLM has learned the underlying graph structure such that it can walk on the graph to produce reasonable sentences. By providing a sufficient number of potential paths, the map LLM can learn the graph of the map and can generate plausible paths on a map. For example, when seeing a turn signal light in the input sequence, the LLM may predict a turn lane for the next token in the sequence.

Using a form of edge sequences can allow for a more compact representation of the RTL documents. Moreover, integer IDs used to refer to the features can be eliminated completely. Since there can be a linear path in the structure, the nodes and properties around that path can be expressed in an appropriate fashion. FIG. 5D illustrates an example of a sub-graph 550 around such a sequence in accordance with at least one embodiment. Here, the sub-graph corresponds to sequence laneEl A--->laneEl B--->laneEl C. In such an example, the traversal may use a number (e.g., 19) tokens in total to specify the structure of the path, which is a fairly compact representation. In one example, a path can be expressed in the following tasks:
Task 1: Specify a node by its type and attribute/property. For example, node laneEl A is specified as LaneEl pA, where pA are the properties of A (e.g., traffic_direction straight, allowed_vehicle_type car, etc.)
Task 2: Specify the main path by listing the nodes it goes through: LaneEl pA LaneEl pB LaneEl Pc.
Task 3: For each node on the main path, specify the non-navigable nodes it can connect to in the format (edge_type node). For example, for laneEl A, the non-navigable nodes are (right_lane laneEl pD visible_sign Sign pH).
Task 4: When referring to a node that is identified before, use its index directly. For instance, if sign H is listed as a non-navigable node for A, when it is observed again for B, it would be (sign 0) since it is the first sign in the sequence.

Various approaches may be used to encode map coordinates. For example, decimal notation, grid-based tokenization, geo-hashing, and/or other approaches may be used in various embodiments. In order to ensure a small fixed-sized vocabulary, some embodiments use a grid-based tokenization method—as decimal notation and geo-hashing may require larger vocabularies. As an LLM can work well with sequences, a delta-based encoding can be used to express coordinates. As an alternative, a global coordinate system may be implemented; however, a global coordinate system—while easier to parse and encode—may result in sparse tokens and make the topology learning less effective. As a note, cumulative absolute error is not considered problematic at this point as the length of the traversals is short and approximate relative positions may be suitable.

With each node having at least four key points, the first key point can be used as the anchor point for the subsequent points in the node. As a non-limiting example, a 263×263 grid may then be laid out, and centered at the anchor point, which may allow for an indexable area of 878 m×878 m at 5 cm precision. FIG. 5E illustrates an example architecture 560 that can be used to determine an output state 570. To tokenize a coordinate, such as coordinates received as input in a matrix 564, all landmark features in a document may be considered, such as may be received as a set of tokens or other structure input 562. A value such as a centroid may be used as the origin in an ENU coordinate system, for example, with the altitude set to the average altitude of coordinates in the document. The tokens can be processed to determine appropriate embeddings using an embedding module 566, and the coordinate input processed using an MLP 568, for example in order to generate the appropriate output state 570. In at least one embodiment, graph traversals can be generated using random-walking on the laneEl graph. The connections of the laneEls (e.g., from_laneEl and to_laneEl fields) may define all possible ways of navigating on the map. To generate a traversal, one approach is to start from a laneEl and recursively follow the successor laneEls to generate a path. When a branch point is encountered where multiple successors exist, the approach can be to randomly take one of the successors and follow the path until, for example, a max token limit is reached.

FIG. 5F illustrates an example image 575 of an intersection in an example map. As depicted, white arrows indicate the possible directions of traffic and the two highlighted lanes are the two successor laneEls of the laneEl above them. When generating the traversal, one approach is to start from the top laneEls, and one of the successor laneEls may be picked to add to the path and follow one of its successors, and so on. To generate graph traversal, a random walk on the laneEl graph can be performed. In practice, graph traversals can be generated with tasks such as the following:
Task 1: Extract all laneEls in the map and put their ids into a vector.
Task 2: Randomly choose a start laneEl from the vector, where the to_laneEl fields are the possible successor laneEls that this laneEl can go to. Randomly choose one successor laneEl and follow its successor, and so on.
Task 3: While at a laneEl in the path, extract the landmark features that are reachable by this laneEl and add them to the traversal results. Stop the path once the traversal reaches the max token limit.

In this example, nodes correspond to landmarks. A common node type in this example is the lane_el, but also includes road_boundary, lane_divider, signal, sign, stop_line, etc. Edges can represent relationships between landmarks, with each edge having a type, such as from_lane, to_lane, visible_sign, sign_edge, etc.

According to one or more embodiments, the grammar may include a simple directed graph data structure with an arbitrary number of edges. Node attributes can be specified in the node entity and depend on the node type, which is the same as the landmark feature type. An RTL document can be produced by using logic such as the following: the features are within a predefined area (e.g., 700 m×700 m) as defined with respect to coordinates encoding herein; a document is written for every laneEl that includes the related features as nodes and their relationships encoded as edges; and the edges of the node are included as well. The language can be compiled using a command line tool. Such a tool can validate (lint), for example, check that all nodes referred to are present in the document, and compile to other targets such as keyhole markup language (KML) or an image, which can be useful for debugging. An RTL API can provide a public interface that lets developers generate structured language documents, and also allows users to query a trained model. As described herein, a schema can be provided to tokenize the edge sequence path, where attributes of the node are represented by a single token for illustration purposes. While in reality all the node attributes may not fit into a single token, there is still room to compress them into as few tokens as possible.

In some embodiments, high level contextual information may be added to prefix an RTL document. The generative part of a language model can learn to manufacture RTL graphs from contextual information. Using such an approach can allow for converting from natural language descriptions, other simpler map representations, or images (camera or BEV) to a language such as RTL. For example, the LLM may be prefixed with natural language descriptions such as “a 2 lane road,” “a 4 way intersection with 2 lanes in each direction,” or “a large intersection with traffic lights,” or using a more structured language that captures the same information, such as “DESCRIPTION 2 lanes 4 way intersection GEN (graph (lane el . . . ” Such high-level contextual descriptions may be derived from HD and/or SD map information. In some embodiments, an image may be processed using a model (e.g., a DNN) and a description of the image—or road topology or contextual information represented in the image—may be output by the model. This contextual information or semantic information may also be used to generate RTL, which may allow for fitting the RTL to an image (using an overlay capability). Such a process can be performed with top-down or bird's eye view (BEV) images. Such a process can also provide the ability for processing an image (in camera or BEV) into RTL (or another DSL).

As such, contextual information—in a format different than the DSL or RTL—may be provided or prepended to a query or prompt for the LLM in order to direct the generation of the output from the LLM. For example, an LLM configured for maps and an LLM for natural language—or a combined LLM trained to process both types of language—may be used in order to understand both natural language and the DSL. The context, as described herein, may include a higher-level description of the scene “a two lane road,” “a 4 way intersection with two lanes in each direction,” or “a large intersection with traffic lights.” In some embodiments, an encoded representation of a standard or lower definition map (relative to an HD map)—such as a navigational map—may be generated and used as a prefix or a prepended portion of a prompt of the LLM. For example, this map information may be encoded in natural language, or may be encoded in another format that is digestible by the LLM. This type of information, with more or less detail, in embodiments, may be processed by the one or more LLMs to generate a representation of the described scenario or scene in the RTL, for example. In some embodiments, observed geometry or image features may also be included or prepended to the prompt. Some of this information may be retrieved or generated using a map. For example, a map may include information encoded therein such as “type: intersection asymmetrical t junction {incomplete} (NE=>SW),” and this information may be used as part of the prompt. In some embodiments, information or descriptions such as (num lanes, num lanes in/out of intersection, num turn lanes, etc.) may be retrieved or obtained from reading the map. To capture this information, in embodiments, the RTL vocabulary may be extended to include these types of descriptions as prompt tokens. For example, as described above, the training data may include “DESCRIPTION 2 lanes 4 way intersection GEN (graph (lane el . . . ), and the LLM(s) may be queried with or without the RTL graph information. This information may also be generated from open street maps (OSM) or another map source or database, and/or from processing images or other sensor data types.

As mentioned, such a representation of an environment can be used to perform specific tasks, as may relate to simulation or testing. In at least one embodiment, representations generated using approaches presented herein can be sufficiently realistic to allow a planning control system for an autonomous vehicle to operate within the environment. Maintaining semantic information and building from understood relationships can provide for a much more accurate and thorough representation of an environment that could otherwise be built using low-level primitive representations alone—such as points, lines, segments curves, or polygons representative of the shapes and locations of objects in an environment—with additional information (e.g., semantic data) being cast aside early in the reconstruction process as in prior approaches. As mentioned, topology information obtained from such low-level primitives can also be fragmented due to occlusions and other such factors. An example representation as generated in accordance with at least one embodiment can retain this additional information and complete a fragmented representation using one or more language models. Further, a representation might be able to be further improved by using multiple perception and/or localization modules that can analyze distinct types of input and fuse those inputs to generate more accurate features and relationships. A prior map or representation information can be used as well, where available. A language model can further be used to fuse these types of information to generate a single, consistent representation.

Aspects of various approaches presented herein can be lightweight enough to execute in various locations, such as on a device, such as a client device that includes a personal computer or gaming console, in real time. Such processing can be performed on, or for, content that is generated on, or received by, that client device or received from an external source, such as streaming data or other content received over at least one network from a cloud server 620 or third party service 660, among other such options. In some instances, at least a portion of the processing, generation, compositing, and/or determination of this content may be performed by one of these other devices, systems, or entities, then provided to the client device (or another such recipient) for presentation or another such use.

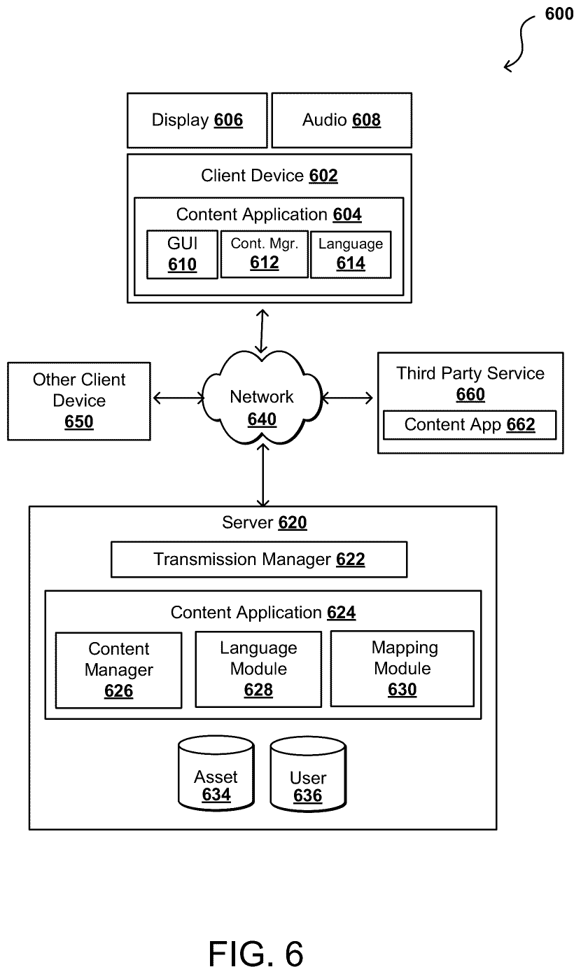

As an example, FIG. 6 illustrates an example network configuration 600 that can be used to provide, generate, modify, encode, process, and/or transmit generated data or other such content. In at least one embodiment, a client device 602 can generate or receive data for a session using components of a content application 604 on client device 602 and data stored locally on that client device. In at least one embodiment, a content application 624 executing on a cloud server 620 (e.g., a cloud server or edge server) may initiate a session associated with at least one client device 602, as may use a session manager and user data stored in a user database 636, and can cause content such as one or more digital assets (e.g., implicit and/or explicit object representations or maps) from an asset repository 634 to be determined by a content manager 626. A content manager 626 may work with a trained language module 628 to generate text-based representations of an environment based upon one or more types of input data, such as a set of map data representative of at least a portion of an environment. In at least one embodiment, these text-based representations can be provided to a mapping module 630 in generating mapping data for, or with respect to, the generated virtual environment or representation. At least a portion of the generated text-based representations can be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610 and content manager 612 for use in providing, synthesizing, rendering, compositing, modifying, or using content for presentation (or other purposes) on or by the client device 602. The content application 604 can also include a language module 614 that can perform various generating tasks, such as to update or augment a text-based representation. A decoder may also be used to decode data received over the network 640 for presentation via client device 602, such as image or video content through a display device 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from cloud server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs (Graphics Processing Unit).

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by allowing the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device or may incorporate one or more Virtual Machines (VMs). In at least one embodiment, such a system can be implemented at least partially in a data center or at least partially using cloud computing resources.

### Inference and Training Logic

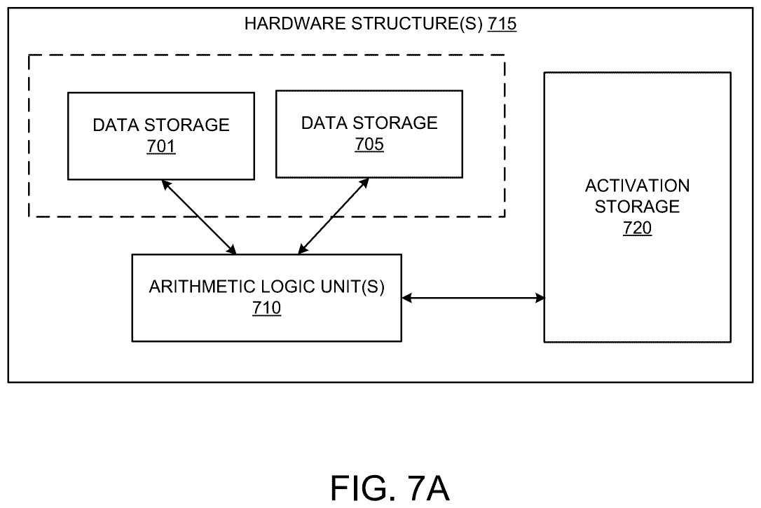

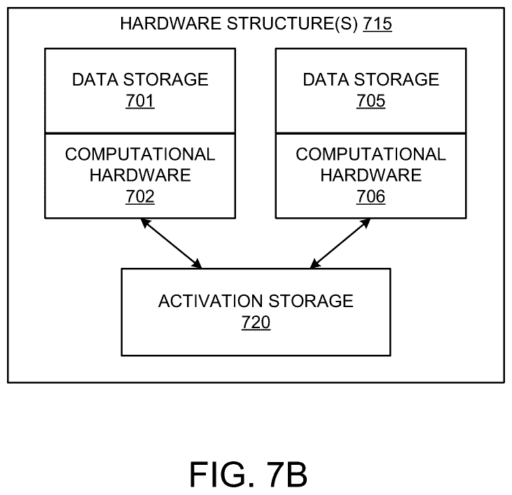

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 701 and/or code and/or data storage 705 are used as operands along with other values, such as bias values, gradient information, momentum values, or other parameters or hyperparameters, any or all of which may be stored in code and/or data storage 701 or code and/or data storage 705 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

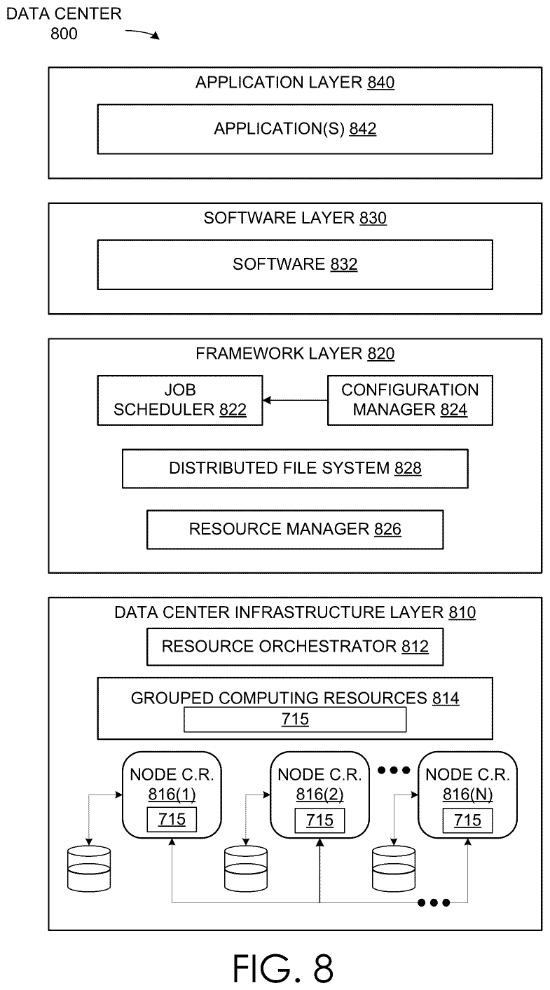

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to generate a tokenized description of input map data that includes additional detail or information useful for one or more subsequent operations.

### Computer Systems

FIG. 9 is a block diagram illustrating an exemplary computer system 900, which may be a system with interconnected devices and components, a system-on-a-chip (SOC) or some combination thereof formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium® XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution unit(s) 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word computing (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache 904 may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit(s) 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit(s) 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor data bus 910 for performing operations on packed data, which may eliminate need to transfer smaller units of data across processor data bus 910 to perform one or more operations one data element at a time.

In at least one embodiment, execution unit(s) 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interface(s) 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to generate a tokenized description of input map data that includes additional detail or information useful for one or more subsequent operations.

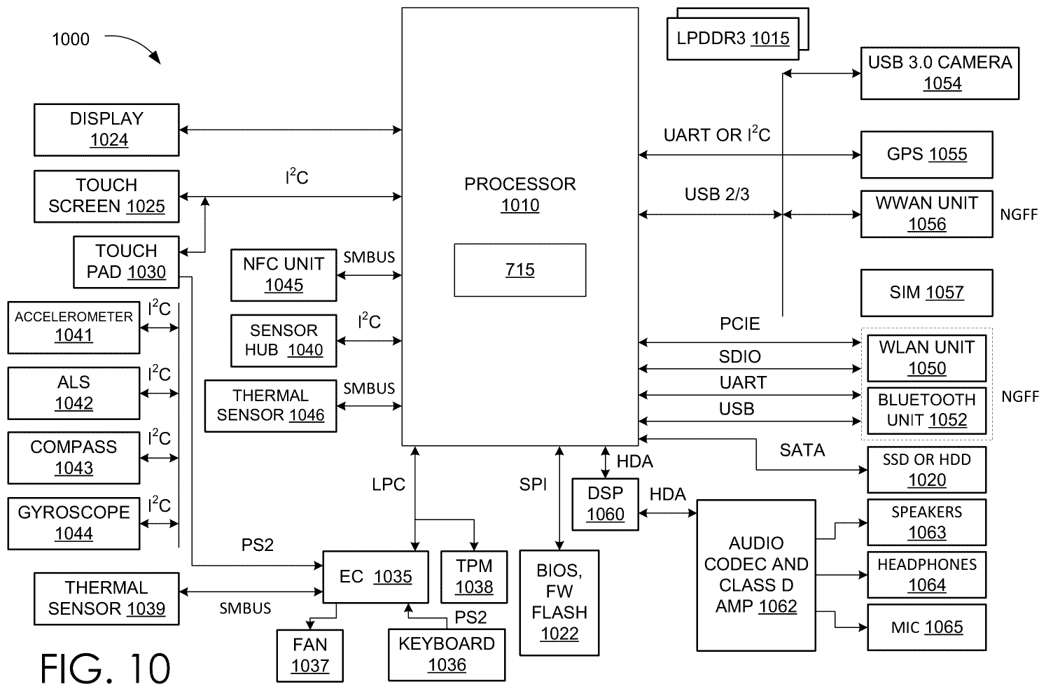

FIG. 10 is a block diagram illustrating an electronic device 1000 for using a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates an electronic device 1000, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to generate a tokenized description of input map data that includes additional detail or information useful for one or more subsequent operations.

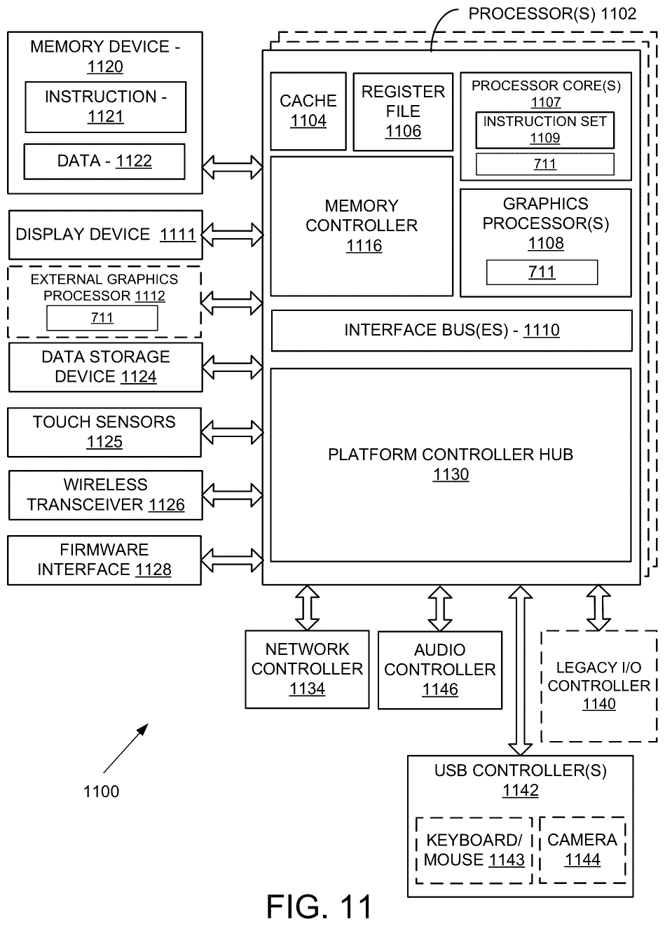

FIG. 11 is a block diagram of a processing system, according to at least one embodiment. In at least one embodiment, processing system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, processing system 1100 is a processing platform incorporated within a system-on-a-chip (SoC) integrated circuit for use in mobile, handheld, or embedded devices.

In at least one embodiment, processing system 1100 can include, or be incorporated within a server-based gaming platform, a game console, including a game and media console, a mobile gaming console, a handheld game console, or an online game console. In at least one embodiment, processing system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory (“cache”) 1104. In at least one embodiment, processor(s) 1102 can have a single internal cache or multiple levels of internal cache. In at least one embodiment, cache 1104 is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in processing system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory buses, or other types of interface buses. In at least one embodiment processor(s) 1102 include an integrated memory controller 1116 and a platform controller hub 1130. In at least one embodiment, memory controller 1116 facilitates communication between a memory device 1120 and other components of processing system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for processing system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 allows peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 allows communication with system firmware, and can be, for example, a unified extensible firmware interface (UEFI). In at least one embodiment, network controller 1134 can allow a network connection to a wired network. In at least one embodiment, a high-performance network controller (not shown) couples with interface bus(es) 1110. In at least one embodiment, audio controller 1146 is a multi-channel high definition audio controller. In at least one embodiment, processing system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, processing system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processing system 1100. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to generate a tokenized description of input map data that includes additional detail or information useful for one or more subsequent operations.

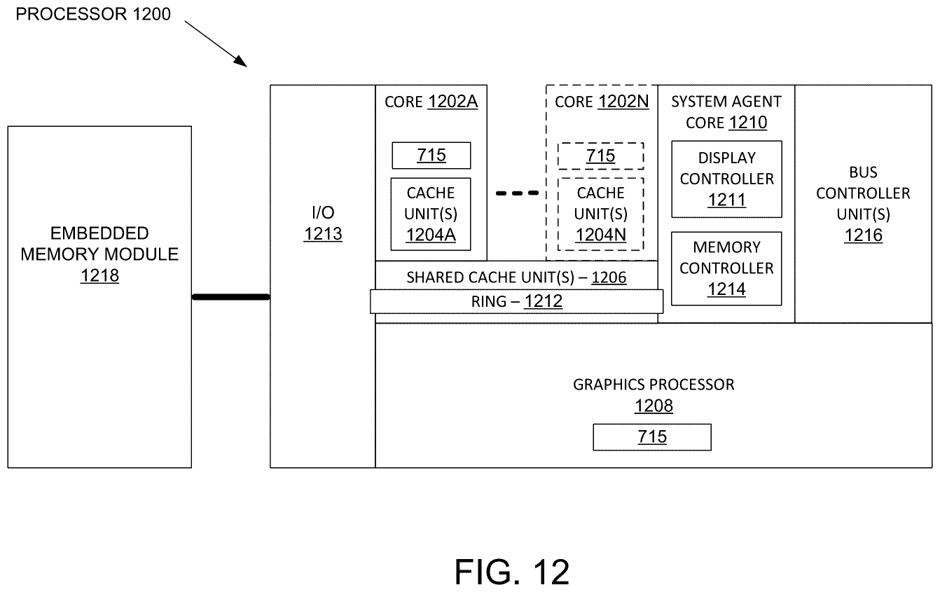

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core(s) 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache memory unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express buses. In at least one embodiment, system agent core 1210 provides management functionality for various processor components. In at least one embodiment, system agent core 1210 includes one or more integrated memory controller(s) 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controller(s) 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory module 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to generate a tokenized description of input map data that includes additional detail or information useful for one or more subsequent operations.

### Virtualized Computing Platform

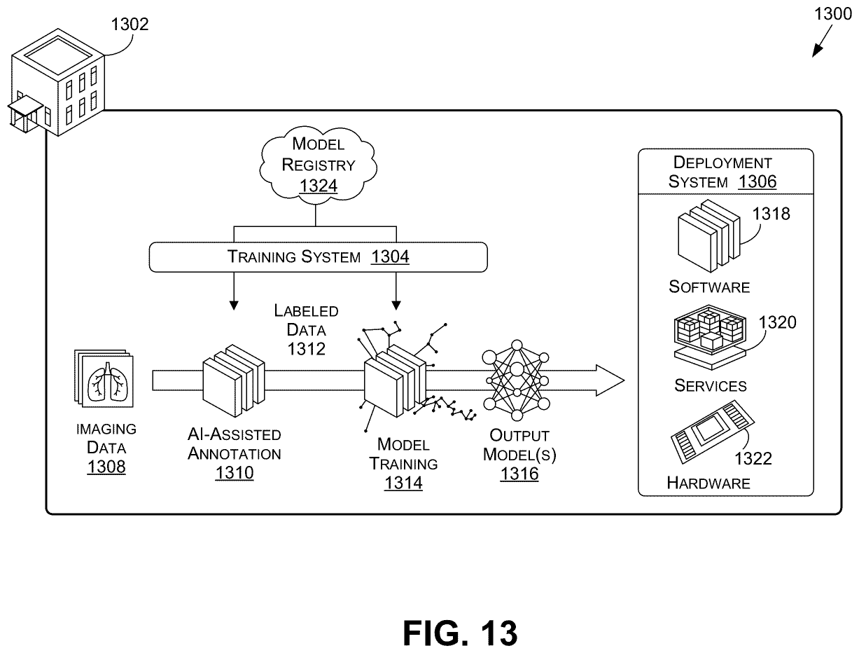

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facility(ies) 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility(ies) 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility(ies) 1302 using data 1308 (such as imaging data) generated at facility(ies) 1302 (and stored on one or more picture archiving and communication system (PACS) servers at facility(ies) 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1304 (FIG. 13) may include a scenario where facility(ies) 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility(ies) 1302 needs a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility(ies) 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility(ies) 1302 requiring a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility(ies) 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility(ies) 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., processor 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., process 1300 of FIG. 13). In at least one embodiment, completed and validated applications or containers may be stored in a container registry and associated machine learning models may be stored in model registry 1324. In at least one embodiment, a requesting entity-who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform). In at least one embodiment, rather than each application that shares a same functionality offered by services 1320 being required to have a respective instance of services 1320, services 1320 may be shared between and among various applications. In at least one embodiment, services 1320 may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects-such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility(ies) 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to allow seamless scaling and load balancing.

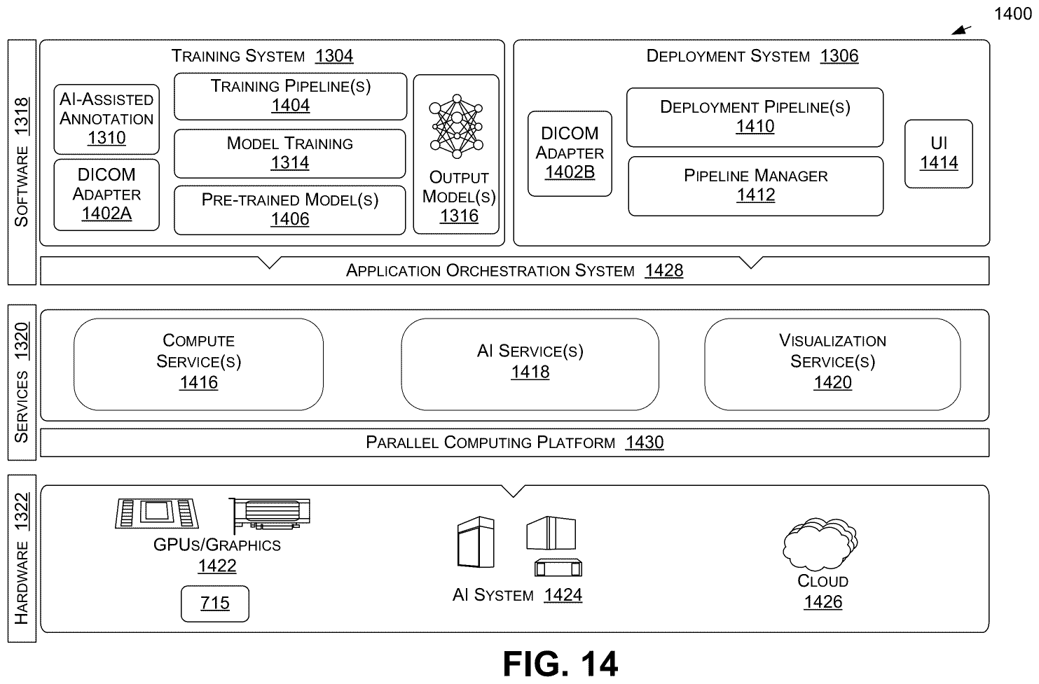

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipeline(s) 1404, similar to those described herein with respect to FIG. 13. In at least one embodiment, where one or more machine learning models are to be used in deployment pipeline(s) 1410 by deployment system 1306, training pipeline(s) 1404 may be used to train or retrain one or more (e.g. pre-trained) models, and/or implement one or more of pre-trained model(s) 1406 (e.g., without a need for retraining or updating). In at least one embodiment, as a result of training pipeline(s) 1404, output model(s) 1316 may be generated. In at least one embodiment, training pipeline(s) 1404 may include any number of processing steps, such as but not limited to imaging data (or other input data) conversion or adaption In at least one embodiment, for different machine learning models used by deployment system 1306, different training pipeline(s) 1404 may be used. In at least one embodiment, training pipeline(s) 1404 similar to a first example described with respect to FIG. 13 may be used for a first machine learning model, training pipeline(s) 1404 similar to a second example described with respect to FIG. 13 may be used for a second machine learning model, and training pipeline(s) 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipeline(s) 1404 may include AI-assisted annotation, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation 1310 may be performed as part of deployment pipelines 1410; either in addition to, or in lieu of AI-assisted annotation 1310 included in training pipeline(s) 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility(ies) 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may allow general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to allow seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

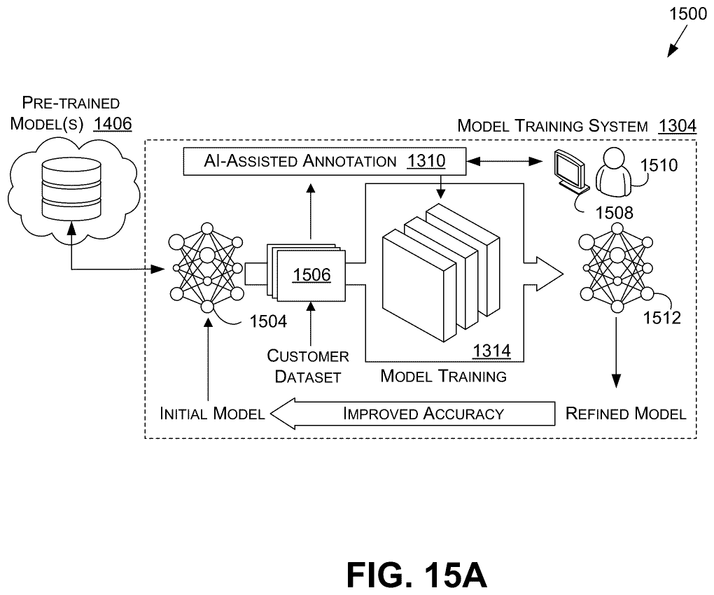

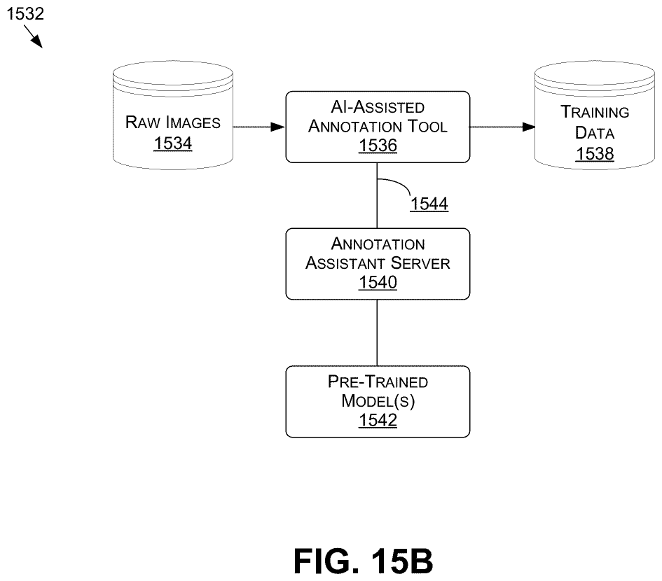

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined model 1512 generated by process 1500 may be executed by a deployment system for one or more containerized applications in deployment pipelines 1510.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained model(s) 1506 may be stored in a data store, or registry. In at least one embodiment, pre-trained model(s) 1506 may have been trained, at least in part, at one or more facilities other than a facility executing process 1500. In at least one embodiment, to protect privacy and rights of patients, subjects, or clients of different facilities, pre-trained model(s) 1506 may have been trained, on-premise, using customer or patient data generated on-premise. In at least one embodiment, pre-trained model(s) 1506 may be trained using a cloud and/or other hardware, but confidential, privacy protected patient data may not be transferred to, used by, or accessible to any components of a cloud (or other off premise hardware). In at least one embodiment, where pre-trained model(s) 1506 is trained at using patient data from more than one facility, pre-trained model(s) 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model(s) 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select pre-trained model(s) 1506 to use with an application. In at least one embodiment, pre-trained model(s) 1506 may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model(s) 1506 may be updated, retrained, and/or fine-tuned for use at a respective facility.

In at least one embodiment, a user may select pre-trained model(s) 1506 that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by model training system 1304. In at least one embodiment, ground truth data may be generated, at least in part, by clinicians, scientists, doctors, practitioners, at a facility.

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation model(s) 1542, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an annotation assistant server 1540 that may include a set of pre-trained model(s) 1542 stored in an annotation model registry, for example. In at least one embodiment, an annotation model registry may store pre-trained model(s) 1542 (e.g., machine learning models, such as deep learning models) that are pre-trained to perform AI-assisted annotation 1310 on a particular organ or abnormality. These models may be further updated by using training pipelines. In at least one embodiment, pre-installed annotation tools may be improved over time as new labeled data is added.

### Autonomous Vehicle

FIG. 16A illustrates an example of an autonomous vehicle 1600, according to at least one embodiment. In at least one embodiment, autonomous vehicle 1600 (alternatively referred to herein as “vehicle 1600”) may be, without limitation, a passenger vehicle, such as a car, a truck, a bus, and/or another type of vehicle that accommodates one or more passengers. In at least one embodiment, vehicle 1600 may be a semi-tractor-trailer truck used for hauling cargo. In at least one embodiment, vehicle 1600 may be an airplane, robotic vehicle, or other kind of vehicle.

Autonomous vehicles may be described in terms of automation levels, defined by National Highway Traffic Safety Administration (“NHTSA”), a division of US Department of Transportation, and Society of Automotive Engineers (“SAE”) “Taxonomy and Definitions for Terms Related to Driving Automation Systems for On-Road Motor Vehicles” (e.g., Standard No. J3016-201806, published on Jun. 15, 2018, Standard No. J3016-201609, published on Sep. 30, 2016, and previous and future versions of this standard). In at least one embodiment, vehicle 1600 may be capable of functionality in accordance with one or more of Level 1 through Level 5 of autonomous driving levels. For example, in at least one embodiment, vehicle 1600 may be capable of conditional automation (Level 3), high automation (Level 4), and/or full automation (Level 5), depending on embodiment.

In at least one embodiment, vehicle 1600 may include, without limitation, components such as a chassis, a vehicle body, wheels (e.g., 2, 4, 6, 8, 18, etc.), tires, axles, and other components of a vehicle. In at least one embodiment, vehicle 1600 may include, without limitation, a propulsion system 1650, such as an internal combustion engine, hybrid electric power plant, an all-electric engine, and/or another propulsion system type. In at least one embodiment, propulsion system 1650 may be connected to a drive train of vehicle 1600, which may include, without limitation, a transmission, to enable propulsion of vehicle 1600. In at least one embodiment, propulsion system 1650 may be controlled in response to receiving signals from a throttle/accelerator(s) 1652.

In at least one embodiment, a steering system 1654, which may include, without limitation, a steering wheel, is used to steer vehicle 1600 (e.g., along a desired path or route) when propulsion system 1650 is operating (e.g., when vehicle 1600 is in motion). In at least one embodiment, steering system 1654 may receive signals from steering actuator(s) 1656. In at least one embodiment, a steering wheel may be optional for full automation (Level 5) functionality. In at least one embodiment, a brake sensor system 1646 may be used to operate vehicle brakes in response to receiving signals from brake actuator(s) 1648 and/or brake sensors.

In at least one embodiment, controller(s) 1636, which may include, without limitation, one or more system on chips (“SoCs”) (not shown in FIG. 16A) and/or graphics processing unit(s) (“GPU(s)”), provide signals (e.g., representative of commands) to one or more components and/or systems of vehicle 1600. For instance, in at least one embodiment, controller(s) 1636 may send signals to operate vehicle brakes via brake actuator(s) 1648, to operate steering system 1654 via steering actuator(s) 1656, to operate propulsion system 1650 via throttle/accelerator(s) 1652. In at least one embodiment, controller(s) 1636 may include one or more onboard (e.g., integrated) computing devices that process sensor signals, and output operation commands (e.g., signals representing commands) to enable autonomous driving and/or to assist a human driver in driving vehicle 1600. In at least one embodiment, controller(s) 1636 may include a first controller for autonomous driving functions, a second controller for functional safety functions, a third controller for artificial intelligence functionality (e.g., computer vision), a fourth controller for infotainment functionality, a fifth controller for redundancy in emergency conditions, and/or other controllers. In at least one embodiment, a single controller may handle two or more of above functionalities, two or more controllers may handle a single functionality, and/or any combination thereof.

In at least one embodiment, controller(s) 1636 provide signals for controlling one or more components and/or systems of vehicle 1600 in response to sensor data received from one or more sensors (e.g., sensor inputs). In at least one embodiment, sensor data may be received from, for example and without limitation, global navigation satellite systems (“GNSS”) sensor(s) 1658 (e.g., Global Positioning System sensor(s)), RADAR sensor(s) 1660, ultrasonic sensor(s) 1662, LIDAR sensor(s) 1664, inertial measurement unit (“IMU”) sensor(s) 1666 (e.g., accelerometer(s), gyroscope(s), a magnetic compass or magnetic compasses, magnetometer(s), etc.), microphone(s) 1696, stereo camera(s) 1668, wide-view camera(s) 1670 (e.g., fisheye cameras), infrared camera(s) 1672, surround camera(s) 1674 (e.g., 360 degree cameras), long-range cameras (not shown in FIG. 16A), mid-range camera(s) (not shown in FIG. 16A), speed sensor(s) 1644 (e.g., for measuring speed of vehicle 1600), vibration sensor(s) 1642, steering sensor(s) 1640, brake sensor(s) (e.g., as part of brake sensor system 1646), and/or other sensor types.

In at least one embodiment, one or more of controller(s) 1636 may receive inputs (e.g., represented by input data) from an instrument cluster 1632 of vehicle 1600 and provide outputs (e.g., represented by output data, display data, etc.) via a human-machine interface (“HMI”) display 1634, an audible annunciator, a loudspeaker, and/or via other components of vehicle 1600. In at least one embodiment, outputs may include information such as vehicle velocity, speed, time, map data (e.g., a High Definition map (not shown in FIG. 16A)), location data (e.g., vehicle's 1600 location, such as on a map), direction, location of other vehicles (e.g., an occupancy grid), information about objects and status of objects as perceived by controller(s) 1636, etc. For example, in at least one embodiment, HMI display 1634 may display information about presence of one or more objects (e.g., a street sign, caution sign, traffic light changing, etc.), and/or information about driving maneuvers vehicle has made, is making, or will make (e.g., changing lanes now, taking exit 34B in two miles, etc.).

In at least one embodiment, vehicle 1600 further includes a network interface 1624 which may use wireless antenna(s) 1626 and/or modem(s) to communicate over one or more networks. For example, in at least one embodiment, network interface 1624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”) networks, etc. In at least one embodiment, wireless antenna(s) 1626 may also enable communication between objects in environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc. protocols.

Inference and/or training logic 715 are used to perform inferencing and/or training operations associated with one or more embodiments. Details regarding inference and/or training logic 715 are provided herein in conjunction with FIGS. 7A and/or 7B. In at least one embodiment, inference and/or training logic 715 may be used in system FIG. 16A for inferencing or predicting operations based, at least in part, on weight parameters calculated using neural network training operations, neural network functions and/or architectures, or neural network use cases described herein.

Such components can be used to generate a tokenized description of input map data that includes additional detail or information useful for one or more subsequent operations.

FIG. 16B illustrates an example of camera locations and fields of view for autonomous vehicle 1600 of FIG. 16A, according to at least one embodiment. In at least one embodiment, cameras and respective fields of view are one example embodiment and are not intended to be limiting. For instance, in at least one embodiment, additional and/or alternative cameras may be included and/or cameras may be located at different locations on vehicle 1600.

In at least one embodiment, camera types for cameras may include, but are not limited to, digital cameras that may be adapted for use with components and/or systems of vehicle 1600. In at least one embodiment, camera(s) may operate at automotive safety integrity level (“ASIL”) B and/or at another ASIL. In at least one embodiment, camera types may be capable of any image capture rate, such as 60 frames per second (fps), 1220 fps, 240 fps, etc., depending on embodiment. In at least one embodiment, cameras may be capable of using rolling shutters, global shutters, another type of shutter, or a combination thereof. In at least one embodiment, color filter array may include a red clear clear clear (“RCCC”) color filter array, a red clear clear blue (“RCCB”) color filter array, a red blue green clear (“RBGC”) color filter array, a Foveon X3 color filter array, a Bayer sensors (“RGGB”) color filter array, a monochrome sensor color filter array, and/or another type of color filter array. In at least one embodiment, clear pixel cameras, such as cameras with an RCCC, an RCCB, and/or an RBGC color filter array, may be used in an effort to increase light sensitivity.

In at least one embodiment, one or more of camera(s) may be used to perform advanced driver assistance systems (“ADAS”) functions (e.g., as part of a redundant or fail-safe design). For example, in at least one embodiment, a Multi-Function Mono Camera may be installed to provide functions including lane departure warning, traffic sign assist and intelligent headlamp control. In at least one embodiment, one or more of camera(s) (e.g., all cameras) may record and provide image data (e.g., video) simultaneously.

In at least one embodiment, one or more camera may be mounted in a mounting assembly, such as a custom designed (three-dimensional (“3D”) printed) assembly, in order to cut out stray light and reflections from within vehicle 1600 (e.g., reflections from dashboard reflected in windshield mirrors) which may interfere with camera image data capture abilities. With reference to wing-mirror mounting assemblies, in at least one embodiment, wing-mirror assemblies may be custom 3D printed so that a camera mounting plate matches a shape of a wing-mirror. In at least one embodiment, camera(s) may be integrated into wing-mirrors. In at least one embodiment, for side-view cameras, camera(s) may also be integrated within four pillars at each corner of a cabin.

In at least one embodiment, cameras with a field of view that include portions of an environment in front of vehicle 1600 (e.g., front-facing cameras) may be used for surround view, to help identify forward facing paths and obstacles, as well as aid in, with help of one or more of controller(s) 1636 and/or control SoCs, providing information critical to generating an occupancy grid and/or determining preferred vehicle paths. In at least one embodiment, front-facing cameras may be used to perform many similar ADAS functions as LIDAR, including, without limitation, emergency braking, pedestrian detection, and collision avoidance. In at least one embodiment, front-facing cameras may also be used for ADAS functions and systems including, without limitation, Lane Departure Warnings (“LDW”), Autonomous Cruise Control (“ACC”), and/or other functions such as traffic sign recognition.

In at least one embodiment, a variety of cameras may be used in a front-facing configuration, including, for example, a monocular camera platform that includes a CMOS (“complementary metal oxide semiconductor”) color imager. In at least one embodiment, a wide-view camera 1670 may be used to perceive objects coming into view from a periphery (e.g., pedestrians, crossing traffic or bicycles). Although only one wide-view camera 1670 is illustrated in FIG. 16B, in other embodiments, there may be any number (including zero) wide-view cameras on vehicle 1600. In at least one embodiment, any number of long-range camera(s) 1698 (e.g., a long-view stereo camera pair) may be used for depth-based object detection, especially for objects for which a neural network has not yet been trained. In at least one embodiment, long-range camera(s) 1698 may also be used for object detection and classification, as well as basic object tracking.

In at least one embodiment, any number of stereo camera(s) 1668 may also be included in a front-facing configuration. In at least one embodiment, one or more of stereo camera(s) 1668 may include an integrated control unit comprising a scalable processing unit, which may provide a programmable logic (“FPGA”) and a multi-core micro-processor with an integrated Controller Area Network (“CAN”) or Ethernet interface on a single chip. In at least one embodiment, such a unit may be used to generate a 3D map of an environment of vehicle 1600, including a distance estimate for all points in an image. In at least one embodiment, one or more of stereo camera(s) 1668 may include, without limitation, compact stereo vision sensor(s) that may include, without limitation, two camera lenses (one each on left and right) and an image processing chip that may measure distance from vehicle 1600 to target object and use generated information (e.g., metadata) to activate autonomous emergency braking and lane departure warning functions. In at least one embodiment, other types of stereo camera(s) 1668 may be used in addition to, or alternatively from, those described herein.

In at least one embodiment, cameras with a field of view that include portions of environment to sides of vehicle 1600 (e.g., side-view cameras) may be used for surround view, providing information used to create and update an occupancy grid, as well as to generate side impact collision warnings. For example, in at least one embodiment, surround camera(s) 1674 (e.g., four surround cameras as illustrated in FIG. 16B) could be positioned on vehicle 1600. In at least one embodiment, surround camera(s) 1674 may include, without limitation, any number and combination of wide-view cameras, fisheye camera(s), 360 degree camera(s), and/or similar cameras. For instance, in at least one embodiment, four fisheye cameras may be positioned on a front, a rear, and sides of vehicle 1600. In at least one embodiment, vehicle 1600 may use three surround camera(s) 1674 (e.g., left, right, and rear), and may leverage one or more other camera(s) (e.g., a forward-facing camera) as a fourth surround-view camera.

In at least one embodiment, cameras with a field of view that include portions of an environment behind vehicle 1600 (e.g., rear-view cameras) may be used for parking assistance, surround view, rear collision warnings, and creating and updating an occupancy grid. In at least one embodiment, a wide variety of cameras may be used including, but not limited to, cameras that are also suitable as a front-facing camera(s) (e.g., long-range camera(s) 1698 and/or mid-range camera(s) 1676, stereo camera(s) 1668, infrared camera(s) 1672, etc.,) as described herein.

Inference and/or training logic 715 are used to perform inferencing and/or training operations associated with one or more embodiments. Details regarding inference and/or training logic 715 are provided herein in conjunction with FIGS. 7A and/or 7B. In at least one embodiment, inference and/or training logic 715 may be used in system FIG. 16B for inferencing or predicting operations based, at least in part, on weight parameters calculated using neural network training operations, neural network functions and/or architectures, or neural network use cases described herein.

Such components can be used to generate a tokenized description of input map data that includes additional detail or information useful for one or more subsequent operations.

FIG. 16C is a block diagram illustrating an example system architecture for autonomous vehicle 1600 of FIG. 16A, according to at least one embodiment. In at least one embodiment, each of components, features, and systems of vehicle 1600 in FIG. 16C is illustrated as being connected via a bus 1602. In at least one embodiment, bus 1602 may include, without limitation, a CAN data interface (alternatively referred to herein as a “CAN bus”). In at least one embodiment, a CAN may be a network inside vehicle 1600 used to aid in control of various features and functionality of vehicle 1600, such as actuation of brakes, acceleration, braking, steering, windshield wipers, etc. In at least one embodiment, bus 1602 may be configured to have dozens or even hundreds of nodes, each with its own unique identifier (e.g., a CAN ID). In at least one embodiment, bus 1602 may be read to find steering wheel angle, ground speed, engine revolutions per minute (“RPMs”), button positions, and/or other vehicle status indicators. In at least one embodiment, bus 1602 may be a CAN bus that is ASIL B compliant.

In at least one embodiment, in addition to, or alternatively from CAN, FlexRay and/or Ethernet protocols may be used. In at least one embodiment, there may be any number of busses forming bus 1602, which may include, without limitation, zero or more CAN busses, zero or more FlexRay busses, zero or more Ethernet busses, and/or zero or more other types of busses using different protocols. In at least one embodiment, two or more busses may be used to perform different functions, and/or may be used for redundancy. For example, a first bus may be used for collision avoidance functionality and a second bus may be used for actuation control. In at least one embodiment, each bus of bus 1602 may communicate with any of components of vehicle 1600, and two or more busses of bus 1602 may communicate with corresponding components. In at least one embodiment, each of any number of system(s) on chip(s) (“SoC(s)”) 1604 (such as SoC 1604(A) and SoC 1604(B)), each of controller(s) 1636, and/or each computer within vehicle may have access to same input data (e.g., inputs from sensors of vehicle 1600), and may be connected to a common bus, such CAN bus.

In at least one embodiment, vehicle 1600 may include one or more controller(s) 1636, such as those described herein with respect to FIG. 16A. In at least one embodiment, controller(s) 1636 may be used for a variety of functions. In at least one embodiment, controller(s) 1636 may be coupled to any of various other components and systems of vehicle 1600, and may be used for control of vehicle 1600, artificial intelligence of vehicle 1600, infotainment for vehicle 1600, and/or other functions.

In at least one embodiment, vehicle 1600 may include any number of SoCs 1604. In at least one embodiment, each of SoCs 1604 may include, without limitation, central processing units (“CPU(s)”) 1606, graphics processing units (“GPU(s)”) 1608, processor(s) 1610, cache(s) 1612, accelerator(s) 1614, data store(s) 1616, and/or other components and features not illustrated. In at least one embodiment, SoC(s) 1604 may be used to control vehicle 1600 in a variety of platforms and systems. For example, in at least one embodiment, SoC(s) 1604 may be combined in a system (e.g., system of vehicle 1600) with a High Definition (“HD”) map 1622 which may obtain map refreshes and/or updates via network interface 1624 from one or more servers (not shown in FIG. 16C).

In at least one embodiment, CPU(s) 1606 may include a CPU cluster or CPU complex (alternatively referred to herein as a “CCPLEX”). In at least one embodiment, CPU(s) 1606 may include multiple cores and/or level two (“L2”) caches. For instance, in at least one embodiment, CPU(s) 1606 may include eight cores in a coherent multi-processor configuration. In at least one embodiment, CPU(s) 1606 may include four dual-core clusters where each cluster has a dedicated L2 cache (e.g., a 2 megabyte (MB) L2 cache). In at least one embodiment, CPU(s) 1606 (e.g., CCPLEX) may be configured to support simultaneous cluster operations enabling any combination of clusters of CPU(s) 1606 to be active at any given time.

In at least one embodiment, one or more of CPU(s) 1606 may implement power management capabilities that include, without limitation, one or more of following features: individual hardware blocks may be clock-gated automatically when idle to save dynamic power; each core clock may be gated when such core is not actively executing instructions due to execution of Wait for Interrupt (“WFI”)/Wait for Event (“WFE”) instructions; each core may be independently power-gated; each core cluster may be independently clock-gated when all cores are clock-gated or power-gated; and/or each core cluster may be independently power-gated when all cores are power-gated. In at least one embodiment, CPU(s) 1606 may further implement an enhanced algorithm for managing power states, where allowed power states and expected wakeup times are specified, and hardware/microcode determines which best power state to enter for core, cluster, and CCPLEX. In at least one embodiment, processing cores may support simplified power state entry sequences in software with work offloaded to microcode.

In at least one embodiment, GPU(s) 1608 may include an integrated GPU (alternatively referred to herein as an “iGPU”). In at least one embodiment, GPU(s) 1608 may be programmable and may be efficient for parallel workloads. In at least one embodiment, GPU(s) 1608 may use an enhanced tensor instruction set. In at least one embodiment, GPU(s) 1608 may include one or more streaming microprocessors, where each streaming microprocessor may include a level one (“L1”) cache (e.g., an L1 cache with at least 96 KB storage capacity), and two or more streaming microprocessors may share an L2 cache (e.g., an L2 cache with a 512 KB storage capacity). In at least one embodiment, GPU(s) 1608 may include at least eight streaming microprocessors. In at least one embodiment, GPU(s) 1608 may use compute application programming interface(s) (API(s)). In at least one embodiment, GPU(s) 1608 may use one or more parallel computing platforms and/or programming models (e.g., NVIDIA's CUDA model).

In at least one embodiment, one or more of GPU(s) 1608 may be power-optimized for best performance in automotive and embedded use cases. For example, in at least one embodiment, GPU(s) 1608 could be fabricated on Fin field-effect transistor (“FinFET”) circuitry. In at least one embodiment, each streaming microprocessor may incorporate a number of mixed-precision processing cores partitioned into multiple blocks. For example, and without limitation, 64 PF32 cores and 32 PF64 cores could be partitioned into four processing blocks. In at least one embodiment, each processing block could be allocated 16 FP32 cores, 8 FP64 cores, 16 INT32 cores, two mixed-precision NVIDIA Tensor cores for deep learning matrix arithmetic, a level zero (“L0”) instruction cache, a scheduler (e.g., warp scheduler) or sequencer, a dispatch unit, and/or a 64 KB register file. In at least one embodiment, streaming microprocessors may include independent parallel integer and floating-point data paths to provide for efficient execution of workloads with a mix of computation and addressing calculations. In at least one embodiment, streaming microprocessors may include independent thread scheduling capability to enable finer-grain synchronization and cooperation between parallel threads. In at least one embodiment, streaming microprocessors may include a combined L1 data cache and shared memory unit in order to improve performance while simplifying programming.

In at least one embodiment, one or more of GPU(s) 1608 may include a high bandwidth memory (“HBM”) and/or a 16 GB HBM2 memory subsystem to provide, in some examples, about 900 GB/second peak memory bandwidth. In at least one embodiment, in addition to, or alternatively from, HBM memory, a synchronous graphics random-access memory (“SGRAM”) may be used, such as a graphics double data rate type five synchronous random-access memory (“GDDR5”).

In at least one embodiment, GPU(s) 1608 may include unified memory technology. In at least one embodiment, address translation services (“ATS”) support may be used to allow GPU(s) 1608 to access CPU(s) 1606 page tables directly. In at least one embodiment, embodiment, when a GPU of GPU(s) 1608 memory management unit (“MMU”) experiences a miss, an address translation request may be transmitted to CPU(s) 1606. In response, 2 CPU of CPU(s) 1606 may look in its page tables for a virtual-to-physical mapping for an address and transmit translation back to GPU(s) 1608, in at least one embodiment. In at least one embodiment, unified memory technology may allow a single unified virtual address space for memory of both CPU(s) 1606 and GPU(s) 1608, thereby simplifying GPU(s) 1608 programming and porting of applications to GPU(s) 1608.

In at least one embodiment, GPU(s) 1608 may include any number of access counters that may keep track of frequency of access of GPU(s) 1608 to memory of other processors. In at least one embodiment, access counter(s) may help ensure that memory pages are moved to physical memory of a processor that is accessing pages most frequently, thereby improving efficiency for memory ranges shared between processors.

In at least one embodiment, one or more of SoC(s) 1604 may include any number of cache(s) 1612, including those described herein. For example, in at least one embodiment, cache(s) 1612 could include a level three (“L3”) cache that is available to both CPU(s) 1606 and GPU(s) 1608 (e.g., that is connected to CPU(s) 1606 and GPU(s) 1608). In at least one embodiment, cache(s) 1612 may include a write-back cache that may keep track of states of lines, such as by using a cache coherence protocol (e.g., MEI, MESI, MSI, etc.). In at least one embodiment, a L3 cache may include 4 MB of memory or more, depending on embodiment, although smaller cache sizes may be used.

In at least one embodiment, one or more of SoC(s) 1604 may include one or more accelerator(s) 1614 (e.g., hardware accelerators, software accelerators, or a combination thereof). In at least one embodiment, SoC(s) 1604 may include a hardware acceleration cluster that may include optimized hardware accelerators and/or large on-chip memory. In at least one embodiment, large on-chip memory (e.g., 4 MB of SRAM), may enable a hardware acceleration cluster to accelerate neural networks and other calculations. In at least one embodiment, a hardware acceleration cluster may be used to complement GPU(s) 1608 and to off-load some of tasks of GPU(s) 1608 (e.g., to free up more cycles of GPU(s) 1608 for performing other tasks). In at least one embodiment, accelerator(s) 1614 could be used for targeted workloads (e.g., perception, convolutional neural networks (“CNNs”), recurrent neural networks (“RNNs”), etc.) that are stable enough to be amenable to acceleration. In at least one embodiment, a CNN may include a region-based or regional convolutional neural networks (“RCNNs”) and Fast RCNNs (e.g., as used for object detection) or other type of CNN.

In at least one embodiment, accelerator(s) 1614 (e.g., hardware acceleration cluster) may include one or more deep learning accelerator (“DLA”). In at least one embodiment, DLA(s) may include, without limitation, one or more Tensor processing units (“TPUs”) that may be configured to provide an additional ten trillion operations per second for deep learning applications and inferencing. In at least one embodiment, TPUs may be accelerators configured to, and optimized for, performing image processing functions (e.g., for CNNs, RCNNs, etc.). In at least one embodiment, DLA(s) may further be optimized for a specific set of neural network types and floating point operations, as well as inferencing. In at least one embodiment, design of DLA(s) may provide more performance per millimeter than a typical general-purpose GPU, and typically vastly exceeds performance of a CPU. In at least one embodiment, TPU(s) may perform several functions, including a single-instance convolution function, supporting, for example, INT8, INT16, and FP16 data types for both features and weights, as well as post-processor functions. In at least one embodiment, DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

In at least one embodiment, DLA(s) may perform any function of GPU(s) 1608, and by using an inference accelerator, for example, a designer may target either DLA(s) or GPU(s) 1608 for any function. For example, in at least one embodiment, a designer may focus processing of CNNs and floating point operations on DLA(s) and leave other functions to GPU(s) 1608 and/or accelerator(s) 1614.

In at least one embodiment, accelerator(s) 1614 may include programmable vision accelerator (“PVA”), which may alternatively be referred to herein as a computer vision accelerator. In at least one embodiment, PVA may be designed and configured to accelerate computer vision algorithms for advanced driver assistance system (“ADAS”) 1638, autonomous driving, augmented reality (“AR”) applications, and/or virtual reality (“VR”) applications. In at least one embodiment, PVA may provide a balance between performance and flexibility. For example, in at least one embodiment, each PVA may include, for example and without limitation, any number of reduced instruction set computer (“RISC”) cores, direct memory access (“DMA”), and/or any number of vector processors.

In at least one embodiment, RISC cores may interact with image sensors (e.g., image sensors of any cameras described herein), image signal processor(s), etc. In at least one embodiment, each RISC core may include any amount of memory. In at least one embodiment, RISC cores may use any of a number of protocols, depending on embodiment. In at least one embodiment, RISC cores may execute a real-time operating system (“RTOS”). In at least one embodiment, RISC cores may be implemented using one or more integrated circuit devices, application specific integrated circuits (“ASICs”), and/or memory devices. For example, in at least one embodiment, RISC cores could include an instruction cache and/or a tightly coupled RAM.

In at least one embodiment, DMA may enable components of PVA to access system memory independently of CPU(s) 1606. In at least one embodiment, DMA may support any number of features used to provide optimization to a PVA including, but not limited to, supporting multi-dimensional addressing and/or circular addressing. In at least one embodiment, DMA may support up to six or more dimensions of addressing, which may include, without limitation, block width, block height, block depth, horizontal block stepping, vertical block stepping, and/or depth stepping.

In at least one embodiment, vector processors may be programmable processors that may be designed to efficiently and flexibly execute programming for computer vision algorithms and provide signal processing capabilities. In at least one embodiment, a PVA may include a PVA core and two vector processing subsystem partitions. In at least one embodiment, a PVA core may include a processor subsystem, DMA engine(s) (e.g., two DMA engines), and/or other peripherals. In at least one embodiment, a vector processing subsystem may operate as a primary processing engine of a PVA, and may include a vector processing unit (“VPU”), an instruction cache, and/or vector memory (e.g., “VMEM”). In at least one embodiment, VPU core may include a digital signal processor such as, for example, a single instruction, multiple data (“SIMD”), very long instruction word (“VLIW”) digital signal processor. In at least one embodiment, a combination of SIMD and VLIW may enhance throughput and speed.

In at least one embodiment, each of vector processors may include an instruction cache and may be coupled to dedicated memory. As a result, in at least one embodiment, each of vector processors may be configured to execute independently of other vector processors. In at least one embodiment, vector processors that are included in a particular PVA may be configured to employ data parallelism. For instance, in at least one embodiment, plurality of vector processors included in a single PVA may execute a common computer vision algorithm, but on different regions of an image. In at least one embodiment, vector processors included in a particular PVA may simultaneously execute different computer vision algorithms, on one image, or even execute different algorithms on sequential images or portions of an image. In at least one embodiment, among other things, any number of PVAs may be included in hardware acceleration cluster and any number of vector processors may be included in each PVA. In at least one embodiment, PVA may include additional error correcting code (“ECC”) memory, to enhance overall system safety.

In at least one embodiment, accelerator(s) 1614 may include a computer vision network on-chip and static random-access memory (“SRAM”), for providing a high-bandwidth, low latency SRAM for accelerator(s) 1614. In at least one embodiment, on-chip memory may include at least 4 MB SRAM, comprising, for example and without limitation, eight field-configurable memory blocks, that may be accessible by both a PVA and a DLA. In at least one embodiment, each pair of memory blocks may include an advanced peripheral bus (“APB”) interface, configuration circuitry, a controller, and a multiplexer. In at least one embodiment, any type of memory may be used. In at least one embodiment, a PVA and a DLA may access memory via a backbone that provides a PVA and a DLA with high-speed access to memory. In at least one embodiment, a backbone may include a computer vision network on-chip that interconnects a PVA and a DLA to memory (e.g., using APB).

In at least one embodiment, a computer vision network on-chip may include an interface that determines, before transmission of any control signal/address/data, that both a PVA and a DLA provide ready and valid signals. In at least one embodiment, an interface may provide for separate phases and separate channels for transmitting control signals/addresses/data, as well as burst-type communications for continuous data transfer. In at least one embodiment, an interface may comply with International Organization for Standardization (“ISO”) 26262 or International Electrotechnical Commission (“IEC”) 61508 standards, although other standards and protocols may be used.

In at least one embodiment, one or more of SoC(s) 1604 may include a real-time ray-tracing hardware accelerator. In at least one embodiment, real-time ray-tracing hardware accelerator may be used to quickly and efficiently determine positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses.

In at least one embodiment, accelerator(s) 1614 can have a wide array of uses for autonomous driving. In at least one embodiment, a PVA may be used for key processing stages in ADAS and autonomous vehicles. In at least one embodiment, a PVA's capabilities are a good match for algorithmic domains needing predictable processing, at low power and low latency. In other words, a PVA performs well on semi-dense or dense regular computation, even on small data sets, which might require predictable run-times with low latency and low power. In at least one embodiment, such as in vehicle 1600, PVAs might be designed to run classic computer vision algorithms, as they can be efficient at object detection and operating on integer math.

For example, according to at least one embodiment of technology, a PVA is used to perform computer stereo vision. In at least one embodiment, a semi-global matching-based algorithm may be used in some examples, although this is not intended to be limiting. In at least one embodiment, applications for Level 3-5 autonomous driving use motion estimation/stereo matching on-the-fly (e.g., structure from motion, pedestrian recognition, lane detection, etc.). In at least one embodiment, a PVA may perform computer stereo vision functions on inputs from two monocular cameras.

In at least one embodiment, a PVA may be used to perform dense optical flow. For example, in at least one embodiment, a PVA could process raw RADAR data (e.g., using a 4D Fast Fourier Transform) to provide processed RADAR data. In at least one embodiment, a PVA is used for time of flight depth processing, by processing raw time of flight data to provide processed time of flight data, for example.

In at least one embodiment, a DLA may be used to run any type of network to enhance control and driving safety, including for example and without limitation, a neural network that outputs a measure of confidence for each object detection. In at least one embodiment, confidence may be represented or interpreted as a probability, or as providing a relative “weight” of each detection compared to other detections. In at least one embodiment, a confidence measure enables a system to make further decisions regarding which detections should be considered as true positive detections rather than false positive detections. In at least one embodiment, a system may set a threshold value for confidence and consider only detections exceeding threshold value as true positive detections. In an embodiment in which an automatic emergency braking (“AEB”) system is used, false positive detections would cause vehicle to automatically perform emergency braking, which is obviously undesirable. In at least one embodiment, highly confident detections may be considered as triggers for AEB. In at least one embodiment, a DLA may run a neural network for regressing confidence value. In at least one embodiment, neural network may take as its input at least some subset of parameters, such as bounding box dimensions, ground plane estimate obtained (e.g., from another subsystem), output from IMU sensor(s) 1666 that correlates with vehicle 1600 orientation, distance, 3D location estimates of object obtained from neural network and/or other sensors (e.g., LIDAR sensor(s) 1664 or RADAR sensor(s) 1660), among others.

In at least one embodiment, one or more of SoC(s) 1604 may include data store(s) 1616 (e.g., memory). In at least one embodiment, data store(s) 1616 may be on-chip memory of SoC(s) 1604, which may store neural networks to be executed on GPU(s) 1608 and/or a DLA. In at least one embodiment, data store(s) 1616 may be large enough in capacity to store multiple instances of neural networks for redundancy and safety. In at least one embodiment, data store(s) 1616 may comprise L2 or L3 cache(s).

In at least one embodiment, one or more of SoC(s) 1604 may include any number of processor(s) 1610 (e.g., embedded processors). In at least one embodiment, processor(s) 1610 may include a boot and power management processor that may be a dedicated processor and subsystem to handle boot power and management functions and related security enforcement. In at least one embodiment, a boot and power management processor may be a part of a boot sequence of SoC(s) 1604 and may provide runtime power management services. In at least one embodiment, a boot power and management processor may provide clock and voltage programming, assistance in system low power state transitions, management of SoC(s) 1604 thermals and temperature sensors, and/or management of SoC(s) 1604 power states. In at least one embodiment, each temperature sensor may be implemented as a ring-oscillator whose output frequency is proportional to temperature, and SoC(s) 1604 may use ring-oscillators to detect temperatures of CPU(s) 1606, GPU(s) 1608, and/or accelerator(s) 1614. In at least one embodiment, if temperatures are determined to exceed a threshold, then a boot and power management processor may enter a temperature fault routine and put SoC(s) 1604 into a lower power state and/or put vehicle 1600 into a chauffeur to safe stop mode (e.g., bring vehicle 1600 to a safe stop).

In at least one embodiment, processor(s) 1610 may further include a set of embedded processors that may serve as an audio processing engine which may be an audio subsystem that enables full hardware support for multi-channel audio over multiple interfaces, and a broad and flexible range of audio I/O interfaces. In at least one embodiment, an audio processing engine is a dedicated processor core with a digital signal processor with dedicated RAM.

In at least one embodiment, processor(s) 1610 may further include an always on processor engine that may provide necessary hardware features to support low power sensor management and wake use cases. In at least one embodiment, an always on processor engine may include, without limitation, a processor core, a tightly coupled RAM, supporting peripherals (e.g., timers and interrupt controllers), various I/O controller peripherals, and routing logic.

In at least one embodiment, processor(s) 1610 may further include a safety cluster engine that includes, without limitation, a dedicated processor subsystem to handle safety management for automotive applications. In at least one embodiment, a safety cluster engine may include, without limitation, two or more processor cores, a tightly coupled RAM, support peripherals (e.g., timers, an interrupt controller, etc.), and/or routing logic. In a safety mode, two or more cores may operate, in at least one embodiment, in a lockstep mode and function as a single core with comparison logic to detect any differences between their operations. In at least one embodiment, processor(s) 1610 may further include a real-time camera engine that may include, without limitation, a dedicated processor subsystem for handling real-time camera management. In at least one embodiment, processor(s) 1610 may further include a high-dynamic range signal processor that may include, without limitation, an image signal processor that is a hardware engine that is part of a camera processing pipeline.

In at least one embodiment, processor(s) 1610 may include a video image compositor that may be a processing block (e.g., implemented on a microprocessor) that implements video post-processing functions needed by a video playback application to produce a final image for a player window. In at least one embodiment, a video image compositor may perform lens distortion correction on wide-view camera(s) 1670, surround camera(s) 1674, and/or on in-cabin monitoring camera sensor(s). In at least one embodiment, in-cabin monitoring camera sensor(s) are preferably monitored by a neural network running on another instance of SoC 1604, configured to identify in cabin events and respond accordingly. In at least one embodiment, an in-cabin system may perform, without limitation, lip reading to activate cellular service and place a phone call, dictate emails, change a vehicle's destination, activate or change a vehicle's infotainment system and settings, or provide voice-activated web surfing. In at least one embodiment, certain functions are available to a driver when a vehicle is operating in an autonomous mode and are disabled otherwise.

In at least one embodiment, a video image compositor may include enhanced temporal noise reduction for both spatial and temporal noise reduction. For example, in at least one embodiment, where motion occurs in a video, noise reduction weights spatial information appropriately, decreasing weights of information provided by adjacent frames. In at least one embodiment, where an image or portion of an image does not include motion, temporal noise reduction performed by video image compositor may use information from a previous image to reduce noise in a current image.

In at least one embodiment, a video image compositor may also be configured to perform stereo rectification on input stereo lens frames. In at least one embodiment, a video image compositor may further be used for user interface composition when an operating system desktop is in use, and GPU(s) 1608 are not required to continuously render new surfaces. In at least one embodiment, when GPU(s) 1608 are powered on and active doing 3D rendering, a video image compositor may be used to offload GPU(s) 1608 to improve performance and responsiveness.

In at least one embodiment, one or more SoC of SoC(s) 1604 may further include a mobile industry processor interface (“MIPI”) camera serial interface for receiving video and input from cameras, a high-speed interface, and/or a video input block that may be used for a camera and related pixel input functions. In at least one embodiment, one or more of SoC(s) 1604 may further include an input/output controller(s) that may be controlled by software and may be used for receiving I/O signals that are uncommitted to a specific role.

In at least one embodiment, one or more Soc of SoC(s) 1604 may further include a broad range of peripheral interfaces to enable communication with peripherals, audio encoders/decoders (“codecs”), power management, and/or other devices. In at least one embodiment, SoC(s) 1604 may be used to process data from cameras (e.g., connected over Gigabit Multimedia Serial Link and Ethernet channels), sensors (e.g., LIDAR sensor(s) 1664, RADAR sensor(s) 1660, etc. that may be connected over Ethernet channels), data from bus 1602 (e.g., speed of vehicle 1600, steering wheel position, etc.), data from GNSS sensor(s) 1658 (e.g., connected over a Ethernet bus or a CAN bus), etc. In at least one embodiment, one or more SoC of SoC(s) 1604 may further include dedicated high-performance mass storage controllers that may include their own DMA engines, and that may be used to free CPU(s) 1606 from routine data management tasks.

In at least one embodiment, SoC(s) 1604 may be an end-to-end platform with a flexible architecture that spans automation Levels 3-5, thereby providing a comprehensive functional safety architecture that leverages and makes efficient use of computer vision and ADAS techniques for diversity and redundancy, and provides a platform for a flexible, reliable driving software stack, along with deep learning tools. In at least one embodiment, SoC(s) 1604 may be faster, more reliable, and even more energy-efficient and space-efficient than conventional systems. For example, in at least one embodiment, accelerator(s) 1614, when combined with CPU(s) 1606, GPU(s) 1608, and data store(s) 1616, may provide for a fast, efficient platform for Level 3-5 autonomous vehicles.

In at least one embodiment, computer vision algorithms may be executed on CPUs, which may be configured using a high-level programming language, such as C, to execute a wide variety of processing algorithms across a wide variety of visual data. However, in at least one embodiment, CPUs are oftentimes unable to meet performance requirements of many computer vision applications, such as those related to execution time and power consumption, for example. In at least one embodiment, many CPUs are unable to execute complex object detection algorithms in real-time, which is used in in-vehicle ADAS applications and in practical Level 3-5 autonomous vehicles.

Embodiments described herein allow for multiple neural networks to be performed simultaneously and/or sequentially, and for results to be combined together to enable Level 3-5 autonomous driving functionality. For example, in at least one embodiment, a CNN executing on a DLA or a discrete GPU (e.g., GPU(s) 1620) may include text and word recognition, allowing reading and understanding of traffic signs, including signs for which a neural network has not been specifically trained. In at least one embodiment, a DLA may further include a neural network that is able to identify, interpret, and provide semantic understanding of a sign, and to pass that semantic understanding to path planning modules running on a CPU Complex.

In at least one embodiment, multiple neural networks may be run simultaneously, as for Level 3, 4, or 5 driving. For example, in at least one embodiment, a warning sign stating “Caution: flashing lights indicate icy conditions,” along with an electric light, may be independently or collectively interpreted by several neural networks. In at least one embodiment, such warning sign itself may be identified as a traffic sign by a first deployed neural network (e.g., a neural network that has been trained), text “flashing lights indicate icy conditions” may be interpreted by a second deployed neural network, which informs a vehicle's path planning software (preferably executing on a CPU Complex) that when flashing lights are detected, icy conditions exist. In at least one embodiment, a flashing light may be identified by operating a third deployed neural network over multiple frames, informing a vehicle's path-planning software of a presence (or an absence) of flashing lights. In at least one embodiment, all three neural networks may run simultaneously, such as within a DLA and/or on GPU(s) 1608.

In at least one embodiment, a CNN for facial recognition and vehicle owner identification may use data from camera sensors to identify presence of an authorized driver and/or owner of vehicle 1600. In at least one embodiment, an always on sensor processing engine may be used to unlock a vehicle when an owner approaches a driver door and turns on lights, and, in a security mode, to disable such vehicle when an owner leaves such vehicle. In this way, SoC(s) 1604 provide for security against theft and/or carjacking.

In at least one embodiment, a CNN for emergency vehicle detection and identification may use data from microphones 1696 to detect and identify emergency vehicle sirens. In at least one embodiment, SoC(s) 1604 use a CNN for classifying environmental and urban sounds, as well as classifying visual data. In at least one embodiment, a CNN running on a DLA is trained to identify a relative closing speed of an emergency vehicle (e.g., by using a Doppler effect). In at least one embodiment, a CNN may also be trained to identify emergency vehicles specific to a local area in which a vehicle is operating, as identified by GNSS sensor(s) 1658. In at least one embodiment, when operating in Europe, a CNN will seek to detect European sirens, and when in North America, a CNN will seek to identify only North American sirens. In at least one embodiment, once an emergency vehicle is detected, a control program may be used to execute an emergency vehicle safety routine, slowing a vehicle, pulling over to a side of a road, parking a vehicle, and/or idling a vehicle, with assistance of ultrasonic sensor(s) 1662, until emergency vehicles pass.

In at least one embodiment, vehicle 1600 may include CPU(s) 1618 (e.g., discrete CPU(s), or dCPU(s)), that may be coupled to SoC(s) 1604 via a high-speed interconnect (e.g., PCIe). In at least one embodiment, CPU(s) 1618 may include an X86 processor, for example. CPU(s) 1618 may be used to perform any of a variety of functions, including arbitrating potentially inconsistent results between ADAS sensors and SoC(s) 1604, and/or monitoring status and health of controller(s) 1636 and/or an infotainment system on a chip (“infotainment SoC”) 1630, for example. In at least one embodiment, SoC(s) 1604 includes one or more interconnects, and an interconnect can include a peripheral component interconnect express (PCIe).

In at least one embodiment, vehicle 1600 may include GPU(s) 1620 (e.g., discrete GPU(s), or dGPU(s)), that may be coupled to SoC(s) 1604 via a high-speed interconnect (e.g., NVIDIA's NVLINK channel). In at least one embodiment, GPU(s) 1620 may provide additional artificial intelligence functionality, such as by executing redundant and/or different neural networks, and may be used to train and/or update neural networks based at least in part on input (e.g., sensor data) from sensors of a vehicle 1600.

In at least one embodiment, vehicle 1600 may further include network interface 1624 which may include, without limitation, wireless antenna(s) 1626 (e.g., one or more wireless antennas for different communication protocols, such as a cellular antenna, a Bluetooth antenna, etc.). In at least one embodiment, network interface 1624 may be used to enable wireless connectivity to Internet cloud services (e.g., with server(s) and/or other network devices), with other vehicles, and/or with computing devices (e.g., client devices of passengers). In at least one embodiment, to communicate with other vehicles, a direct link may be established between vehicle 160 and another vehicle and/or an indirect link may be established (e.g., across networks and over the Internet). In at least one embodiment, direct links may be provided using a vehicle-to-vehicle communication link. In at least one embodiment, a vehicle-to-vehicle communication link may provide vehicle 1600 information about vehicles in proximity to vehicle 1600 (e.g., vehicles in front of, on a side of, and/or behind vehicle 1600). In at least one embodiment, such aforementioned functionality may be part of a cooperative adaptive cruise control functionality of vehicle 1600.

In at least one embodiment, network interface 1624 may include an SoC that provides modulation and demodulation functionality and enables controller(s) 1636 to communicate over wireless networks. In at least one embodiment, network interface 1624 may include a radio frequency front-end for up-conversion from baseband to radio frequency, and down conversion from radio frequency to baseband. In at least one embodiment, frequency conversions may be performed in any technically feasible fashion. For example, frequency conversions could be performed through well-known processes, and/or using super-heterodyne processes. In at least one embodiment, radio frequency front end functionality may be provided by a separate chip. In at least one embodiment, network interfaces may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

In at least one embodiment, vehicle 1600 may further include data store(s) 1628 which may include, without limitation, off-chip (e.g., off SoC(s) 1604) storage. In at least one embodiment, data store(s) 1628 may include, without limitation, one or more storage elements including RAM, SRAM, dynamic random-access memory (“DRAM”), video random-access memory (“VRAM”), flash memory, hard disks, and/or other components and/or devices that may store at least one bit of data.

In at least one embodiment, vehicle 1600 may further include GNSS sensor(s) 1658 (e.g., GPS and/or assisted GPS sensors), to assist in mapping, perception, occupancy grid generation, and/or path planning functions. In at least one embodiment, any number of GNSS sensor(s) 1658 may be used, including, for example and without limitation, a GPS using a USB connector with an Ethernet-to-Serial (e.g., RS-232) bridge.

In at least one embodiment, vehicle 1600 may further include RADAR sensor(s) 1660. In at least one embodiment, RADAR sensor(s) 1660 may be used by vehicle 1600 for long-range vehicle detection, even in darkness and/or severe weather conditions. In at least one embodiment, RADAR functional safety levels may be ASIL B. In at least one embodiment, RADAR sensor(s) 1660 may use a CAN bus and/or bus 1602 (e.g., to transmit data generated by RADAR sensor(s) 1660) for control and to access object tracking data, with access to Ethernet channels to access raw data in some examples. In at least one embodiment, a wide variety of RADAR sensor types may be used. For example, and without limitation, RADAR sensor(s) 1660 may be suitable for front, rear, and side RADAR use. In at least one embodiment, one or more sensor of RADAR sensors(s) 1660 is a Pulse Doppler RADAR sensor.

In at least one embodiment, RADAR sensor(s) 1660 may include different configurations, such as long-range with narrow field of view, short-range with wide field of view, short-range side coverage, etc. In at least one embodiment, long-range RADAR may be used for adaptive cruise control functionality. In at least one embodiment, long-range RADAR systems may provide a broad field of view realized by two or more independent scans, such as within a 250 m (meter) range. In at least one embodiment, RADAR sensor(s) 1660 may help in distinguishing between static and moving objects, and may be used by ADAS system 1638 for emergency brake assist and forward collision warning. In at least one embodiment, sensors 1660 (s) included in a long-range RADAR system may include, without limitation, monostatic multimodal RADAR with multiple (e.g., six or more) fixed RADAR antennae and a high-speed CAN and FlexRay interface. In at least one embodiment, with six antennae, a central four antennae may create a focused beam pattern, designed to record vehicle's 1600 surroundings at higher speeds with minimal interference from traffic in adjacent lanes. In at least one embodiment, another two antennae may expand field of view, making it possible to quickly detect vehicles entering or leaving a lane of vehicle 1600.

In at least one embodiment, mid-range RADAR systems may include, as an example, a range of up to 160 m (front) or 80 m (rear), and a field of view of up to 42 degrees (front) or 150 degrees (rear). In at least one embodiment, short-range RADAR systems may include, without limitation, any number of RADAR sensor(s) 1660 designed to be installed at both ends of a rear bumper. When installed at both ends of a rear bumper, in at least one embodiment, a RADAR sensor system may create two beams that constantly monitor blind spots in a rear direction and next to a vehicle. In at least one embodiment, short-range RADAR systems may be used in ADAS system 1638 for blind spot detection and/or lane change assist.

In at least one embodiment, vehicle 1600 may further include ultrasonic sensor(s) 1662. In at least one embodiment, ultrasonic sensor(s) 1662, which may be positioned at a front, a back, and/or side location of vehicle 1600, may be used for parking assist and/or to create and update an occupancy grid. In at least one embodiment, a wide variety of ultrasonic sensor(s) 1662 may be used, and different ultrasonic sensor(s) 1662 may be used for different ranges of detection (e.g., 2.5 m, 4 m). In at least one embodiment, ultrasonic sensor(s) 1662 may operate at functional safety levels of ASIL B.

In at least one embodiment, vehicle 1600 may include LIDAR sensor(s) 1664. In at least one embodiment, LIDAR sensor(s) 1664 may be used for object and pedestrian detection, emergency braking, collision avoidance, and/or other functions. In at least one embodiment, LIDAR sensor(s) 1664 may operate at functional safety level ASIL B. In at least one embodiment, vehicle 1600 may include multiple LIDAR sensors 1664 (e.g., two, four, six, etc.) that may use an Ethernet channel (e.g., to provide data to a Gigabit Ethernet switch).

In at least one embodiment, LIDAR sensor(s) 1664 may be capable of providing a list of objects and their distances for a 360-degree field of view. In at least one embodiment, commercially available LIDAR sensor(s) 1664 may have an advertised range of approximately 100 m, with an accuracy of 2 cm to 3 cm, and with support for a 100 Mbps Ethernet connection, for example. In at least one embodiment, one or more non-protruding LIDAR sensors may be used. In such an embodiment, LIDAR sensor(s) 1664 may include a small device that may be embedded into a front, a rear, a side, and/or a corner location of vehicle 1600. In at least one embodiment, LIDAR sensor(s) 1664, in such an embodiment, may provide up to a 120-degree horizontal and 35-degree vertical field-of-view, with a 200 m range even for low-reflectivity objects. In at least one embodiment, front-mounted LIDAR sensor(s) 1664 may be configured for a horizontal field of view between 45 degrees and 135 degrees.

In at least one embodiment, LIDAR technologies, such as 3D flash LIDAR, may also be used. In at least one embodiment, 3D flash LIDAR uses a flash of a laser as a transmission source, to illuminate surroundings of vehicle 1600 up to approximately 200 m. In at least one embodiment, a flash LIDAR unit includes, without limitation, a receptor, which records laser pulse transit time and reflected light on each pixel, which in turn corresponds to a range from vehicle 1600 to objects. In at least one embodiment, flash LIDAR may allow for highly accurate and distortion-free images of surroundings to be generated with every laser flash. In at least one embodiment, four flash LIDAR sensors may be deployed, one at each side of vehicle 1600. In at least one embodiment, 3D flash LIDAR systems include, without limitation, a solid-state 3D staring array LIDAR camera with no moving parts other than a fan (e.g., a non-scanning LIDAR device). In at least one embodiment, flash LIDAR device may use a 5 nanosecond class I (eye-safe) laser pulse per frame and may capture reflected laser light as a 3D range point cloud and co-registered intensity data.

In at least one embodiment, vehicle 1600 may further include IMU sensor(s) 1666. In at least one embodiment, IMU sensor(s) 1666 may be located at a center of a rear axle of vehicle 1600. In at least one embodiment, IMU sensor(s) 1666 may include, for example and without limitation, accelerometer(s), magnetometer(s), gyroscope(s), a magnetic compass, magnetic compasses, and/or other sensor types. In at least one embodiment, such as in six-axis applications, IMU sensor(s) 1666 may include, without limitation, accelerometers and gyroscopes. In at least one embodiment, such as in nine-axis applications, IMU sensor(s) 1666 may include, without limitation, accelerometers, gyroscopes, and magnetometers.

In at least one embodiment, IMU sensor(s) 1666 may be implemented as a miniature, high performance GPS-Aided Inertial Navigation System (“GPS/INS”) that combines micro-electro-mechanical systems (“MEMS”) inertial sensors, a high-sensitivity GPS receiver, and advanced Kalman filtering algorithms to provide estimates of position, velocity, and attitude. In at least one embodiment, IMU sensor(s) 1666 may enable vehicle 1600 to estimate its heading without requiring input from a magnetic sensor by directly observing and correlating changes in velocity from a GPS to IMU sensor(s) 1666. In at least one embodiment, IMU sensor(s) 1666 and GNSS sensor(s) 1658 may be combined in a single integrated unit.

In at least one embodiment, vehicle 1600 may include microphone(s) 1696 placed in and/or around vehicle 1600. In at least one embodiment, microphone(s) 1696 may be used for emergency vehicle detection and identification, among other things.

In at least one embodiment, vehicle 1600 may further include any number of camera types, including stereo camera(s) 1668, wide-view camera(s) 1670, infrared camera(s) 1672, surround camera(s) 1674, long-range camera(s) 1698, mid-range camera(s) 1676, and/or other camera types. In at least one embodiment, cameras may be used to capture image data around an entire periphery of vehicle 1600. In at least one embodiment, which types of cameras used depends on vehicle 1600. In at least one embodiment, any combination of camera types may be used to provide necessary coverage around vehicle 1600. In at least one embodiment, a number of cameras deployed may differ depending on embodiment. For example, in at least one embodiment, vehicle 1600 could include six cameras, seven cameras, ten cameras, twelve cameras, or another number of cameras. In at least one embodiment, cameras may support, as an example and without limitation, Gigabit Multimedia Serial Link (“GMSL”) and/or Gigabit Ethernet communications. In at least one embodiment, each camera might be as described with more detail previously herein with respect to FIG. 16A and FIG. 16B.

In at least one embodiment, vehicle 1600 may further include vibration sensor(s) 1642. In at least one embodiment, vibration sensor(s) 1642 may measure vibrations of components of vehicle 1600, such as axle(s). For example, in at least one embodiment, changes in vibrations may indicate a change in road surfaces. In at least one embodiment, when two or more vibration sensors 1642 are used, differences between vibrations may be used to determine friction or slippage of road surface (e.g., when a difference in vibration is between a power-driven axle and a freely rotating axle).

In at least one embodiment, vehicle 1600 may include ADAS system 1638. In at least one embodiment, ADAS system 1638 may include, without limitation, an SoC, in some examples. In at least one embodiment, ADAS system 1638 may include, without limitation, any number and combination of an autonomous/adaptive/automatic cruise control (“ACC”) system, a cooperative adaptive cruise control (“CACC”) system, a forward crash warning (“FCW”) system, an automatic emergency braking (“AEB”) system, a lane departure warning (“LDW)” system, a lane keep assist (“LKA”) system, a blind spot warning (“BSW”) system, a rear cross-traffic warning (“RCTW”) system, a collision warning (“CW”) system, a lane centering (“LC”) system, and/or other systems, features, and/or functionality.

In at least one embodiment, ACC system may use RADAR sensor(s) 1660, LIDAR sensor(s) 1664, and/or any number of camera(s). In at least one embodiment, ACC system may include a longitudinal ACC system and/or a lateral ACC system. In at least one embodiment, a longitudinal ACC system monitors and controls distance to another vehicle immediately ahead of vehicle 1600 and automatically adjusts speed of vehicle 1600 to maintain a safe distance from vehicles ahead. In at least one embodiment, a lateral ACC system performs distance keeping, and advises vehicle 1600 to change lanes when necessary. In at least one embodiment, a lateral ACC is related to other ADAS applications, such as LC and CW.

In at least one embodiment, a CACC system uses information from other vehicles that may be received via network interface 1624 and/or wireless antenna(s) 1626 from other vehicles via a wireless link, or indirectly, over a network connection (e.g., over the Internet). In at least one embodiment, direct links may be provided by a vehicle-to-vehicle (“V2V”) communication link, while indirect links may be provided by an infrastructure-to-vehicle (“I2V”) communication link. In general, V2V communication provides information about immediately preceding vehicles (e.g., vehicles immediately ahead of and in same lane as vehicle 1600), while I2V communication provides information about traffic further ahead. In at least one embodiment, a CACC system may include either or both I2V and V2V information sources. In at least one embodiment, given information of vehicles ahead of vehicle 1600, a CACC system may be more reliable and it has potential to improve traffic flow smoothness and reduce congestion on road.

In at least one embodiment, an FCW system is designed to alert a driver to a hazard, so that such driver may take corrective action. In at least one embodiment, an FCW system uses a front-facing camera and/or RADAR sensor(s) 1660, coupled to a dedicated processor, DSP, FPGA, and/or ASIC, that is electrically coupled to provide driver feedback, such as a display, speaker, and/or vibrating component. In at least one embodiment, an FCW system may provide a warning, such as in form of a sound, visual warning, vibration and/or a quick brake pulse.

In at least one embodiment, an AEB system detects an impending forward collision with another vehicle or other object, and may automatically apply brakes if a driver does not take corrective action within a specified time or distance parameter. In at least one embodiment, AEB system may use front-facing camera(s) and/or RADAR sensor(s) 1660, coupled to a dedicated processor, DSP, FPGA, and/or ASIC. In at least one embodiment, when an AEB system detects a hazard, it will typically first alert a driver to take corrective action to avoid collision and, if that driver does not take corrective action, that AEB system may automatically apply brakes in an effort to prevent, or at least mitigate, an impact of a predicted collision. In at least one embodiment, an AEB system may include techniques such as dynamic brake support and/or crash imminent braking.

In at least one embodiment, an LDW system provides visual, audible, and/or tactile warnings, such as steering wheel or seat vibrations, to alert driver when vehicle 1600 crosses lane markings. In at least one embodiment, an LDW system does not activate when a driver indicates an intentional lane departure, such as by activating a turn signal. In at least one embodiment, an LDW system may use front-side facing cameras, coupled to a dedicated processor, DSP, FPGA, and/or ASIC, that is electrically coupled to provide driver feedback, such as a display, speaker, and/or vibrating component. In at least one embodiment, an LKA system is a variation of an LDW system. In at least one embodiment, an LKA system provides steering input or braking to correct vehicle 1600 if vehicle 1600 starts to exit its lane.

In at least one embodiment, a BSW system detects and warns a driver of vehicles in an automobile's blind spot. In at least one embodiment, a BSW system may provide a visual, audible, and/or tactile alert to indicate that merging or changing lanes is unsafe. In at least one embodiment, a BSW system may provide an additional warning when a driver uses a turn signal. In at least one embodiment, a BSW system may use rear-side facing camera(s) and/or RADAR sensor(s) 1660, coupled to a dedicated processor, DSP, FPGA, and/or ASIC, that is electrically coupled to driver feedback, such as a display, speaker, and/or vibrating component.

In at least one embodiment, an RCTW system may provide visual, audible, and/or tactile notification when an object is detected outside a rear-camera range when vehicle 1600 is backing up. In at least one embodiment, an RCTW system includes an AEB system to ensure that vehicle brakes are applied to avoid a crash. In at least one embodiment, an RCTW system may use one or more rear-facing RADAR sensor(s) 1660, coupled to a dedicated processor, DSP, FPGA, and/or ASIC, that is electrically coupled to provide driver feedback, such as a display, speaker, and/or vibrating component.

In at least one embodiment, conventional ADAS systems may be prone to false positive results which may be annoying and distracting to a driver, but typically are not catastrophic, because conventional ADAS systems alert a driver and allow that driver to decide whether a safety condition truly exists and act accordingly. In at least one embodiment, vehicle 1600 itself decides, in case of conflicting results, whether to heed result from a primary computer or a secondary computer (e.g., a first controller or a second controller of controllers 1636). For example, in at least one embodiment, ADAS system 1638 may be a backup and/or secondary computer for providing perception information to a backup computer rationality module. In at least one embodiment, a backup computer rationality monitor may run redundant diverse software on hardware components to detect faults in perception and dynamic driving tasks. In at least one embodiment, outputs from ADAS system 1638 may be provided to a supervisory MCU. In at least one embodiment, if outputs from a primary computer and outputs from a secondary computer conflict, a supervisory MCU determines how to reconcile conflict to ensure safe operation.

In at least one embodiment, a primary computer may be configured to provide a supervisory MCU with a confidence score, indicating that primary computer's confidence in a chosen result. In at least one embodiment, if that confidence score exceeds a threshold, that supervisory MCU may follow that primary computer's direction, regardless of whether that secondary computer provides a conflicting or inconsistent result. In at least one embodiment, where a confidence score does not meet a threshold, and where primary and secondary computers indicate different results (e.g., a conflict), a supervisory MCU may arbitrate between computers to determine an appropriate outcome.

In at least one embodiment, a supervisory MCU may be configured to run a neural network(s) that is trained and configured to determine, based at least in part on outputs from a primary computer and outputs from a secondary computer, conditions under which that secondary computer provides false alarms. In at least one embodiment, neural network(s) in a supervisory MCU may learn when a secondary computer's output may be trusted, and when it cannot. For example, in at least one embodiment, when that secondary computer is a RADAR-based FCW system, a neural network(s) in that supervisory MCU may learn when an FCW system is identifying metallic objects that are not, in fact, hazards, such as a drainage grate or manhole cover that triggers an alarm. In at least one embodiment, when a secondary computer is a camera-based LDW system, a neural network in a supervisory MCU may learn to override LDW when bicyclists or pedestrians are present and a lane departure is, in fact, a safest maneuver. In at least one embodiment, a supervisory MCU may include at least one of a DLA or a GPU suitable for running neural network(s) with associated memory. In at least one embodiment, a supervisory MCU may comprise and/or be included as a component of SoC(s) 1604.

In at least one embodiment, ADAS system 1638 may include a secondary computer that performs ADAS functionality using traditional rules of computer vision. In at least one embodiment, that secondary computer may use classic computer vision rules (if-then), and presence of a neural network(s) in a supervisory MCU may improve reliability, safety and performance. For example, in at least one embodiment, diverse implementation and intentional non-identity makes an overall system more fault-tolerant, especially to faults caused by software (or software-hardware interface) functionality. For example, in at least one embodiment, if there is a software bug or error in software running on a primary computer, and non-identical software code running on a secondary computer provides a consistent overall result, then a supervisory MCU may have greater confidence that an overall result is correct, and a bug in software or hardware on that primary computer is not causing a material error.

In at least one embodiment, an output of ADAS system 1638 may be fed into a primary computer's perception block and/or a primary computer's dynamic driving task block. For example, in at least one embodiment, if ADAS system 1638 indicates a forward crash warning due to an object immediately ahead, a perception block may use this information when identifying objects. In at least one embodiment, a secondary computer may have its own neural network that is trained and thus reduces a risk of false positives, as described herein.

In at least one embodiment, vehicle 1600 may further include infotainment SoC 1630 (e.g., an in-vehicle infotainment system (IVI)). Although illustrated and described as an SoC, infotainment system SoC 1630, in at least one embodiment, may not be an SoC, and may include, without limitation, two or more discrete components. In at least one embodiment, infotainment SoC 1630 may include, without limitation, a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, WiFi, etc.), and/or information services (e.g., navigation systems, rear-parking assistance, a radio data system, vehicle related information such as fuel level, total distance covered, brake fuel level, oil level, door open/close, air filter information, etc.) to vehicle 1600. For example, infotainment SoC 1630 could include radios, disk players, navigation systems, video players, USB and Bluetooth connectivity, carputers, in-car entertainment, WiFi, steering wheel audio controls, hands free voice control, a heads-up display (“HUD”), HMI display 1634, a telematics device, a control panel (e.g., for controlling and/or interacting with various components, features, and/or systems), and/or other components. In at least one embodiment, infotainment SoC 1630 may further be used to provide information (e.g., visual and/or audible) to user(s) of vehicle 1600, such as information from ADAS system 1638, autonomous driving information such as planned vehicle maneuvers, trajectories, surrounding environment information (e.g., intersection information, vehicle information, road information, etc.), and/or other information.

In at least one embodiment, infotainment SoC 1630 may include any amount and type of GPU functionality. In at least one embodiment, infotainment SoC 1630 may communicate over bus 1602 with other devices, systems, and/or components of vehicle 1600. In at least one embodiment, infotainment SoC 1630 may be coupled to a supervisory MCU such that a GPU of an infotainment system may perform some self-driving functions in event that primary controller(s) 1636 (e.g., primary and/or backup computers of vehicle 1600) fail. In at least one embodiment, infotainment SoC 1630 may put vehicle 1600 into a chauffeur to safe stop mode, as described herein.

In at least one embodiment, vehicle 1600 may further include instrument cluster 1632 (e.g., a digital dash, an electronic instrument cluster, a digital instrument panel, etc.). In at least one embodiment, instrument cluster 1632 may include, without limitation, a controller and/or supercomputer (e.g., a discrete controller or supercomputer). In at least one embodiment, instrument cluster 1632 may include, without limitation, any number and combination of a set of instrumentation such as a speedometer, fuel level, oil pressure, tachometer, odometer, turn indicators, gearshift position indicator, seat belt warning light(s), parking-brake warning light(s), engine-malfunction light(s), supplemental restraint system (e.g., airbag) information, lighting controls, safety system controls, navigation information, etc. In some examples, information may be displayed and/or shared among infotainment SoC 1630 and instrument cluster 1632. In at least one embodiment, instrument cluster 1632 may be included as part of infotainment SoC 1630, or vice versa.

Inference and/or training logic 715 are used to perform inferencing and/or training operations associated with one or more embodiments. Details regarding inference and/or training logic 715 are provided herein in conjunction with FIGS. 7A and/or 7B. In at least one embodiment, inference and/or training logic 715 may be used in system FIG. 16C for inferencing or predicting operations based, at least in part, on weight parameters calculated using neural network training operations, neural network functions and/or architectures, or neural network use cases described herein.

Such components can be used to generate a tokenized description of input map data that includes additional detail or information useful for one or more subsequent operations.

FIG. 16D is a diagram of a system for communication between cloud-based server(s) and autonomous vehicle 1600 of FIG. 16A, according to at least one embodiment. In at least one embodiment, system may include, without limitation, server(s) 1678, network(s) 1690, and any number and type of vehicles, including vehicle 1600. In at least one embodiment, server(s) 1678 may include, without limitation, a plurality of GPUs 1684(A)-1684(H) (collectively referred to herein as GPUs 1684), PCIe switches 1682(A)-1682(D) (collectively referred to herein as PCIe switches 1682), and/or CPUs 1680(A)-1680(B) (collectively referred to herein as CPUs 1680). In at least one embodiment, GPUs 1684, CPUs 1680, and PCIe switches 1682 may be interconnected with high-speed interconnects such as, for example and without limitation, NVLink interfaces 1688 developed by NVIDIA and/or PCIe connections 1686. In at least one embodiment, GPUs 1684 are connected via an NVLink and/or NVSwitch SoC and GPUs 1684 and PCIe switches 1682 are connected via PCIe interconnects. Although eight GPUs 1684, two CPUs 1680, and four PCIe switches 1682 are illustrated, this is not intended to be limiting. In at least one embodiment, each of server(s) 1678 may include, without limitation, any number of GPUs 1684, CPUs 1680, and/or PCIe switches 1682, in any combination. For example, in at least one embodiment, server(s) 1678 could each include eight, sixteen, thirty-two, and/or more GPUs 1684.

In at least one embodiment, server(s) 1678 may receive, over network(s) 1690 and from vehicles, image data representative of images showing unexpected or changed road conditions, such as recently commenced road-work. In at least one embodiment, server(s) 1678 may transmit, over network(s) 1690 and to vehicles, neural networks 1692, updated or otherwise, and/or map information 1694, including, without limitation, information regarding traffic and road conditions. In at least one embodiment, updates to map information 1694 may include, without limitation, updates for HD map 1622, such as information regarding construction sites, potholes, detours, flooding, and/or other obstructions. In at least one embodiment, neural networks 1692, and/or map information 1694 may have resulted from new training and/or experiences represented in data received from any number of vehicles in an environment, and/or based at least in part on training performed at a data center (e.g., using server(s) 1678 and/or other servers).

In at least one embodiment, server(s) 1678 may be used to train machine learning models (e.g., neural networks) based at least in part on training data. In at least one embodiment, training data may be generated by vehicles, and/or may be generated in a simulation (e.g., using a game engine). In at least one embodiment, any amount of training data is tagged (e.g., where associated neural network benefits from supervised learning) and/or undergoes other pre-processing. In at least one embodiment, any amount of training data is not tagged and/or pre-processed (e.g., where associated neural network does not require supervised learning). In at least one embodiment, once machine learning models are trained, machine learning models may be used by vehicles (e.g., transmitted to vehicles over network(s) 1690), and/or machine learning models may be used by server(s) 1678 to remotely monitor vehicles.

In at least one embodiment, server(s) 1678 may receive data from vehicles and apply data to up-to-date real-time neural networks for real-time intelligent inferencing. In at least one embodiment, server(s) 1678 may include deep-learning supercomputers and/or dedicated AI computers powered by GPU(s) 1684, such as a DGX and DGX Station machines developed by NVIDIA. However, in at least one embodiment, server(s) 1678 may include deep learning infrastructure that uses CPU-powered data centers.

In at least one embodiment, deep-learning infrastructure of server(s) 1678 may be capable of fast, real-time inferencing, and may use that capability to evaluate and verify health of processors, software, and/or associated hardware in vehicle 1600. For example, in at least one embodiment, deep-learning infrastructure may receive periodic updates from vehicle 1600, such as a sequence of images and/or objects that vehicle 1600 has located in that sequence of images (e.g., via computer vision and/or other machine learning object classification techniques). In at least one embodiment, deep-learning infrastructure may run its own neural network to identify objects and compare them with objects identified by vehicle 1600 and, if results do not match and deep-learning infrastructure concludes that AI in vehicle 1600 is malfunctioning, then server(s) 1678 may transmit a signal to vehicle 1600 instructing a fail-safe computer of vehicle 1600 to assume control, notify passengers, and complete a safe parking maneuver.

In at least one embodiment, server(s) 1678 may include GPU(s) 1684 and one or more programmable inference accelerators (e.g., NVIDIA's TensorRT 3 devices). In at least one embodiment, a combination of GPU-powered servers and inference acceleration may make real-time responsiveness possible. In at least one embodiment, such as where performance is less critical, servers powered by CPUs, FPGAs, and other processors may be used for inferencing.

Various embodiments can be described by the following clauses:
1. A computer-implemented method, comprising:
generating, using a language model and map data for at least a portion of an environment, a first tokenized description of the environment; and
generating, using the first language model and the first tokenized description, a second tokenized description for at least the portion of the environment, the second tokenized description including additional detail, with respect to the environment, inferred in part using at least one of semantic, topological, geometric, kinematic, or relational information in the first tokenized description.
2. The computer-implemented method of clause 1, wherein the additional detail relates to at least one gap or omission in the map data.
3. The computer-implemented method of clause 1, wherein the additional detail relates to one or more lanes or complex topographies inferred from the first tokenized description.
4. The computer-implemented method of clause 1, wherein the additional detail relates to one or more objects identified for inclusion in the environment based at least on the first tokenized description and one or more real-world relationships learned by the second language model.
5. The computer-implemented method of clause 1, wherein the map data corresponds to a standard definition (SD) map representation of at least the portion of the environment, and wherein the second tokenized description contains information corresponding to a high definition (HD) map version of at least the portion of the environment.
6. The computer-implemented method of clause 1, further comprising:
extracting a set of features from the map data; and
providing the set of features as input to the first language model to generate the first tokenized description.
7. The computer-implemented method of clause 1, further comprising:
providing, as additional input to the language model, at least one of geographic location information or contextual information to be used to determine the additional detail.
8 The computer-implemented method of clause 1, wherein the first tokenized description and the second tokenized description are each a tokenized text string representative of at least the portion of the environment, the tokenized text string including a sequence of tokens associated with objects in the environment.
9. The computer-implemented method of clause 8, wherein the tokenized text string is written in a road topology language (RTL) or a domain specific language (DSL).
10. A processor, comprising:
one or more circuits to:
   process, using a first language model, map data for at least a portion of an environment to generate a first tokenized description of the environment; and
   process, using a second language model, the first tokenized description to generate a second tokenized description for at least the portion of the environment, the second tokenized description including additional detail, with respect to the environment, inferred in part using at least one of semantic, topological, geometric, kinematic, or relational information in the first tokenized description.
11. The processor of clause 10, wherein first language model and the second language model correspond to different portions or different instances of a single language model.
12. The processor of clause 10, wherein the additional detail relates to one or more objects identified for inclusion in the environment based at least on the first tokenized description and one or more real-world relationships learned by the second language model.
13. The processor of clause 10, wherein the one or more circuits are further to:
extract a set of features from the map data; and
provide the set of features as input to the first language model to generate the first tokenized description.
14. The processor of clause 10, wherein the first tokenized description and the second tokenized description are each a tokenized text string representative of at least the portion of the environment, the tokenized text string including a sequence of tokens associated with objects in the environment.
15. The processor of clause 10, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or a system implemented at least partially using cloud computing resources
16. A system comprising:
one or more processors to generate, using a large language model (LLM), an output corresponding to a map at a first level of detail, the output generated based at least on the LLM processing a representation corresponding to the map at a second level of detail less than the first level of detail.
17. The system of clause 16, wherein the one or more processors are further to:
extract a set of features from the map at the second level of detail; and
provide the set of features as input to the LLM to generate the output.
18. The system of clause 16, wherein a difference between the first level of detail and the second level of detail corresponds to at least one of a lane or complex topography inferred from the map at the second level of detail, one or more gaps or omissions inferred from the map at the second level of detail, or at least one additional object identified for inclusion in the environment based at least on the map at the second level of detail and one or more real-world relationships learned by the LLM.
19. The system of clause 16, wherein the representation of the map at the first level of detail and the representation of the map at the second level of detail both correspond to tokenized descriptions of at least a portion of an environment.
20. The system of clause 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably as far as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although the discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
generating, using a language model and map data for at least a portion of an environment, a first tokenized description of the environment; and
generating, using the first language model and the first tokenized description, a second tokenized description for at least the portion of the environment, the second tokenized description including additional detail, with respect to the environment, inferred in part using at least one of semantic, topological, geometric, kinematic, or relational information in the first tokenized description.

2. The computer-implemented method of claim 1, wherein the additional detail relates to at least one gap or omission in the map data.

3. The computer-implemented method of claim 1, wherein the additional detail relates to one or more lanes or complex topographies inferred from the first tokenized description.

4. The computer-implemented method of claim 1, wherein the additional detail relates to one or more objects identified for inclusion in the environment based at least on the first tokenized description and one or more real-world relationships learned by the second language model.

5. The computer-implemented method of claim 1, wherein the map data corresponds to a standard definition (SD) map representation of at least the portion of the environment, and wherein the second tokenized description contains information corresponding to a high definition (HD) map version of at least the portion of the environment.

6. The computer-implemented method of claim 1, further comprising:
extracting a set of features from the map data; and
providing the set of features as input to the first language model to generate the first tokenized description.

7. The computer-implemented method of claim 1, further comprising:
providing, as additional input to the language model, at least one of geographic location information or contextual information to be used to determine the additional detail.

8. The computer-implemented method of claim 1, wherein the first tokenized description and the second tokenized description are each a tokenized text string representative of at least the portion of the environment, the tokenized text string including a sequence of tokens associated with objects in the environment.

9. The computer-implemented method of claim 8, wherein the tokenized text string is written in a road topology language (RTL) or a domain specific language (DSL).

10. A processor, comprising:
one or more circuits to:
process, using a first language model, map data for at least a portion of an environment to generate a first tokenized description of the environment; and
process, using a second language model, the first tokenized description to generate a second tokenized description for at least the portion of the environment, the second tokenized description including additional detail, with respect to the environment, inferred in part using at least one of semantic, topological, geometric, kinematic, or relational information in the first tokenized description.

11. The processor of claim 10, wherein first language model and the second language model correspond to different portions or different instances of a single language model.

12. The processor of claim 10, wherein the additional detail relates to one or more objects identified for inclusion in the environment based at least on the first tokenized description and one or more real-world relationships learned by the second language model.

13. The processor of claim 10, wherein the one or more circuits are further to:
extract a set of features from the map data; and
provide the set of features as input to the first language model to generate the first tokenized description.

14. The processor of claim 10, wherein the first tokenized description and the second tokenized description are each a tokenized text string representative of at least the portion of the environment, the tokenized text string including a sequence of tokens associated with objects in the environment.

15. The processor of claim 10, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources

16. A system comprising:
one or more processors to generate, using a large language model (LLM), an output corresponding to a map at a first level of detail, the output generated based at least on the LLM processing a representation corresponding to the map at a second level of detail less than the first level of detail.

17. The system of claim 16, wherein the one or more processors are further to:
extract a set of features from the map at the second level of detail; and
provide the set of features as input to the LLM to generate the output.

18. The system of claim 16, wherein a difference between the first level of detail and the second level of detail corresponds to at least one of a lane or complex topography inferred from the map at the second level of detail, one or more gaps or omissions inferred from the map at the second level of detail, or at least one additional object identified for inclusion in the environment based at least on the map at the second level of detail and one or more real-world relationships learned by the LLM.

19. The system of claim 16, wherein the representation of the map at the first level of detail and the representation of the map at the second level of detail both correspond to tokenized descriptions of at least a portion of an environment.

20. The system of claim 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.
